(19) United States
(12) Patent Application Publication
(10) Pub. No.: US 2025/0093566 A1
(43) Pub. Date: Mar. 20, 2025

(54) LIGHT ENERGY EXCITER

(71) Applicant: Illumina, Inc., San Diego, CA (US)

(72) Inventors: Alexa HUDNUT, San Diego, CA (US); Sibi SUTTY, San Diego, CA (US); Jacob RUDEN, San Diego, CA (US); Leroy KUKAS, San Diego, CA (US); David GIANDUZZO, San Diego, CA (US); Kirkpatrick NORTON, San Diego, CA (US); Simon PRINCE, San Diego, CA (US); Krysada PHOUNSIRI, San Diego, CA (US); Joseph PINTO, San Diego, CA (US)

(21) Appl. No.: 18/852,957

(22) PCT Filed: Oct. 26, 2023
(86) PCT No.: PCT/US2023/077934

§ 371 Date: Sep. 30, 2024

Related U.S. Application Data
(60) Provisional application No. 63/381,225, filed on Oct. 27, 2022.

(51) Int. Cl. F21V 8/00; G01N 21/64

(52) U.S. Cl. CPC G02B 6/0008; G01N 21/64; G01N 2201/062; G01N 2201/0631; G01N 2201/0806

(57) ABSTRACT

Embodiments herein relate to combinations for use in light energy excitation. Light energy, according to one example, can be directed toward a detector surface that can support biological or chemical samples.

### CROSS-REFERENCE TO RELATED APPLICATIONS

This application claims priority to U.S. Patent Application No. 63/381,225 filed Oct. 27, 2022, entitled “Light Energy Exciter” which is incorporated herein by reference in its entirety.

### BACKGROUND

Embodiments herein relate to light energy, and particularly to combinations for use in light energy excitation.

Various protocols in biological or chemical research involve performing controlled reactions. The designated reactions can then be observed or detected and subsequent analysis can help identify or reveal properties of chemicals involved in the reaction.

In some multiplex assays, an unknown analyte having an identifiable label (e.g., fluorescent label) can be exposed to thousands of known probes under controlled conditions. Each known probe can be deposited into a corresponding well of a microplate. Observing any chemical reactions that occur between the known probes and the unknown analyte within the wells can help identify or reveal properties of the analyte. Other examples of such protocols include known DNA sequencing processes, such as sequencing-by-synthesis (SBS) or cyclic-array sequencing.

In some fluorescent-detection protocols, an optical system is used to direct excitation light onto fluorophores, e.g. fluorescently-labeled analytes and to also detect the fluorescent emissions signal light that can benefit from the analytes having attached fluorophores. However, such optical systems can be relatively expensive and may involve a larger benchtop footprint. For example, the optical system can include an arrangement of lenses, filters, and light sources.

In other proposed detection systems, the controlled reactions in a flow cell define by a solid-state light sensor array (e.g. a complementary metal oxide semiconductor (CMOS) detector or a charge coupled device (CCD) detector). These systems do not involve a large optical assembly to detect the fluorescent emissions.

### BRIEF DESCRIPTION

Embodiments herein relate to combinations for use in light energy excitation. Light energy, according to one example, can be directed toward a detector surface that can support biological or chemical samples.

There is set forth herein a light energy exciter that can include one or more light sources. A light energy exciter can emit excitation light directed toward a detector surface that can support biological or chemical samples.

There is set forth herein a system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source; a detector comprising a detector surface for supporting biological or chemical samples and a sensor array comprising light sensors spaced apart from the detector surface, wherein the detector receives excitation light from the light energy exciter and emissions signal light; a mounting assembly for mounting the light pipe and the second light pipe, wherein the mounting assembly aligns the light pipe to the light source, and aligns the second light pipe to the second light source.

There is set forth herein a light energy exciter comprising: a light source bank to emit excitation light rays; and a light pipe homogenizing the excitation light rays and directing the excitation light rays toward a distal end of the light energy exciter, the light pipe comprising a light entrance surface and a light exit surface, the light pipe receiving the excitation light rays from the light source bank.

There is set forth herein a system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source, a third light pipe to homogenize excitation light rays from a third light source of the plurality of light sources and to direct the excitation light rays from the second light source, the third light pipe comprising a light entrance surface to receive the excitation light rays from the third light source, a fourth light pipe to homogenize excitation light rays from a fourth light source of the plurality of light sources and to direct the excitation light rays from the fourth light source, the fourth light pipe comprising a light entrance surface to receive the excitation light rays from the fourth light source; a lens receiving excitation light rays from the light pipe and the second light pipe and imaging a light exit surface of the light pipe and the second light pipe, respectively, onto a detector surface of a detector and a second detector surface of a second detector; and a lens receiving excitation light rays from the third light pipe and the fourth light pipe and imaging a light exit surface of the third light pipe and the fourth light pipe, respectively, onto a third detector surface of a third detector and a fourth detector surface of a fourth detector.

There is set forth herein a method comprising: emitting with a light energy exciter excitation light, wherein the light energy exciter comprises a set of light sources and a second set of light sources, the set of light sources to emit excitation light rays in a first wavelength emission band, the second set of light source to emit excitation light rays in a second wavelength emission band; receiving with a detector the excitation light and emissions signal light resulting from excitation by the excitation light, the detector comprising a detector surface for supporting biological or chemical samples and a sensor array spaced apart from the detector surface, the detector blocking the excitation light and permitting the emissions signal light to propagate toward light sensors of the sensor array; and transmitting with circuitry of the detector data signals in dependence on photons sensed by the light sensors of the sensor array.

There is set forth herein a system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank; and a detector comprising a detector surface for supporting biological or chemical samples and a sensor array comprising light sensors spaced apart from the detector surface, wherein the detector receives excitation light from the light energy exciter and emissions signal light.

There is set forth herein a system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank, wherein the light source bank is mounted on a region of a printed circuit board, and wherein the second light source bank is mounted on a second region of the printed circuit board, the second region spaced apart from the region, wherein the second region and the region are surface modified regions of the printed circuit board having surface modifications characterized by one or more layer of the printed circuit board being removed; and a detector comprising a detector surface for supporting biological or chemical samples and a sensor array comprising light sensors spaced apart from the detector surface, wherein the detector receives excitation light from the light energy exciter and emissions signal light, wherein exit light rays of the light pipe and the second light pipe are commonly received by a lens that shapes the exit light rays to project a light pattern and a second light pattern onto a camera integrated circuit having a detector and a second detector, wherein the light pattern is projected by the lens onto a detector surface of the detector, and wherein the second light pattern is projected by the lens onto a second detector surface of the second detector.

There is set forth herein a mounting assembly comprising: a light pipe mount for mounting a light pipe with respect to a light source; and a second light pipe mount for mounting a second light pipe with respect to a second light source.

There is set forth herein a mounting assembly-comprising: a structural member carrying a light pipe; and a second structural member carrying a second light pipe.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### DRAWINGS

These and other features, aspects, benefits, and advantages set forth herein will become better understood when the following detailed description is read with reference to the accompanying drawings in which like characters represent like parts throughout the drawings, wherein:

FIG. 1A is a schematic side view block diagram of a system for performance of biological or chemical tests, the system having a light energy exciter and a detector assembly having a detector according to one example;

FIG. 1B is a schematic top view of a detector as shown in FIG. 1A according to one example;

FIG. 1C is a schematic side view of a detector having multiple light sensor arrays according to one example;

FIG. 1D is a schematic top view of the detector of FIG. 1C according to one example;

FIG. 2 is a cutaway side view of a light energy exciter according to one example;

FIG. 3 is a ray trace diagram illustrating light ray propagation in the light energy exciter of FIG. 2 according to one example;

FIG. 4 depicts a light source bank including light sources provided by a plurality of LEDs disposed on a printed circuit board according to one example;

FIG. 5A is a side view of light sources provided by a plurality of LEDs surface coupled onto a light entry surface of a light pipe according to one example;

FIG. 5B depicts light sources connected in parallel according to one example;

FIG. 5C depicts light sources connected in series according to one example;

FIG. 5D is a side schematic view of LEDs having anodes connected to a metal core layer of an printed circuit board according to one example;

FIG. 5E is a side schematic view of flip chip LEDs connected to a printed circuit board according to one example;

FIG. 5F is a top view of LEDs mounted to a printed circuit board according to one example;

FIG. 5G is a top schematic view of flip chip LEDs mounted to a printed circuit board;

FIG. 5H are side top and bottom views of an LED according to one example;

FIG. 5I are top and bottom views of an LED according to one example;

FIG. 5J is a heat sinking diagram for a vertical LED according to one example;

FIG. 5K is a heat sinking diagram for a flip chip LED according to one example;

FIG. 5L depicts a light source bank attached to a light pipe according to one example;

FIG. 6 is a perspective schematic view of a light energy exciter according to one example;

FIG. 7 is a schematic diagram of a light energy exciter according to one example;

FIG. 8A is an assembly view of a light energy exciter according to one example;

FIG. 8B is an assembly view of a light energy exciter according to one example;

FIG. 8C is an assembly view of a light energy exciter according to one example;

FIG. 8D is an assembly view of a light energy exciter according to one example;

FIG. 8E is an assembly view of a light energy exciter according to one example;

FIG. 8F is an assembly view of a light energy exciter according to one example;

FIG. 8G is an assembly view of a light energy exciter according to one example;

FIG. 8H is an assembly view of a light energy exciter according to one example;

FIG. 8I is a ray trace diagram illustrating operation of a light energy exciter having first and second light pipes according to one example;

FIG. 9A is an assembly view of a light pipe mount according to one example;

FIG. 9B is an assembly view of a light pipe mount according to one example;

FIG. 9C is an assembly view of a light pipe mount according to one example;

FIG. 9D is an assembly view of a light pipe mount according to one example;

FIG. 9E is an assembly view of a light pipe mount according to one example;

FIG. 9F is an assembly view of a light pipe mount according to one example;

FIG. 9G is an assembly view of a light pipe mount according to one example;

FIG. 9H is an assembly view of a light pipe mounting assembly according to one example;

FIG. 9I is an assembly view of a light pipe mounting assembly according to one example;

FIG. 9J is an assembly view of a light pipe mounting assembly according to one example;

FIG. 9K is an assembly view of a light pipe mounting assembly according to one example;

FIG. 10 is an assembly perspective view of a flow cell frame housing a flow cell according to one example;

FIG. 11 is an internal view of a detector assembly cartridge defining registration features for alignment of a light energy exciter that can be coupled and aligned thereon according to one example;

FIG. 12 is a top view of the flow cell defined with respect to a detector provided by an integrated circuit according to one example;

FIG. 13 is a cutaway side view of a portion of a detector provided by an integrated circuit having a light sensor array and an aligned light guide array according to one example;

FIG. 14 is a cutaway side view of a portion of a detector provided by an integrated circuit having a light sensor and an aligned light guide according to one example;

FIG. 15 is a schematic diagram of a process control system according to one example;

FIG. 16 is a spectral profile coordination diagram depicting spectral profiles of a plurality of light energy exciter light sources and a plurality of fluorophores that may be excited with use of the excitation light sources according to one example;

FIG. 17 is a flowchart depicting process that can be used in support of a DNA sequencing process for DNA sequence reconstruction according to one example;

FIG. 18 is a timing diagram illustrating timing between light source banks according to one example;

FIG. 19 is a timing diagram illustrating heat removal from an LED according to one example;

FIG. 20 is a flowchart depicting method that can be used in support of a DNA sequencing process for DNA sequence reconstruction according to one example.

### DETAILED DESCRIPTION

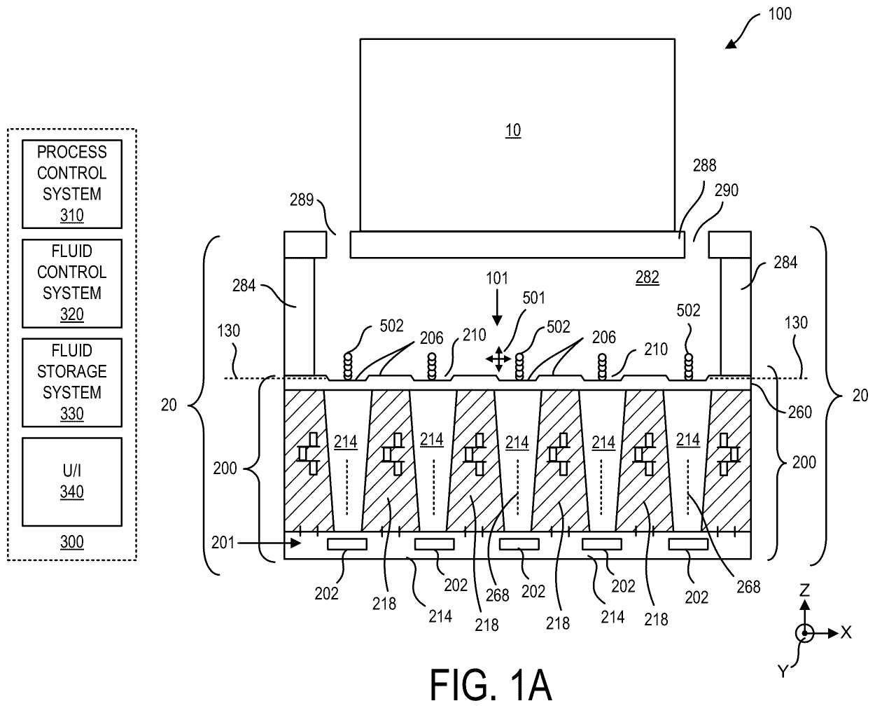

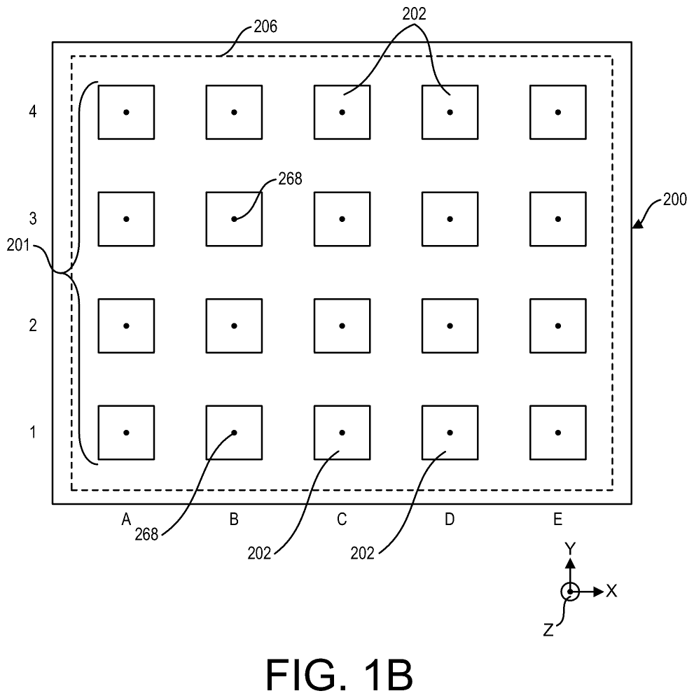

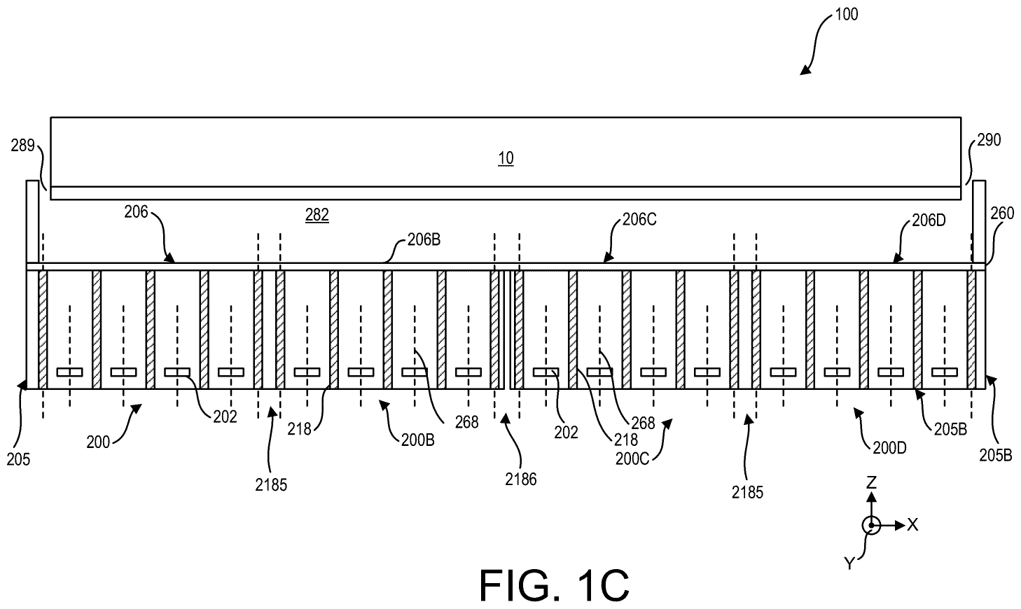

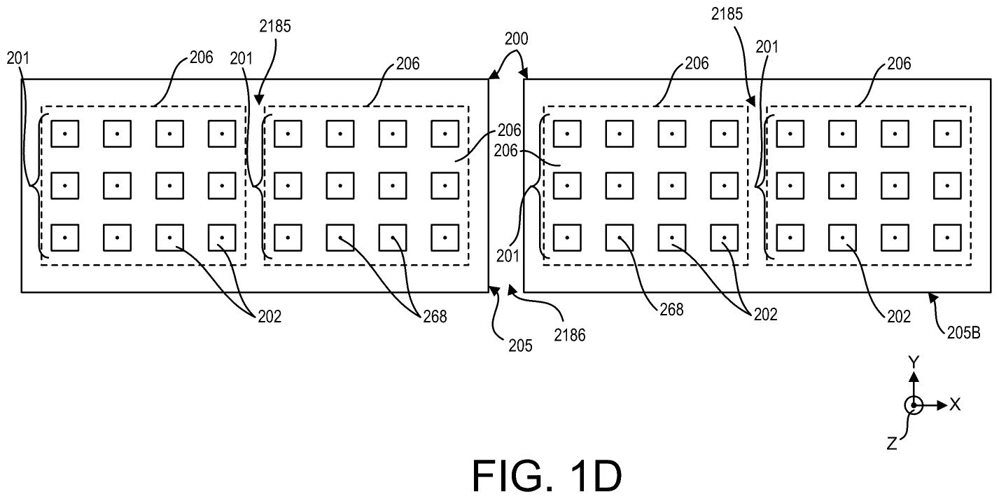

In. FIG. 1A there is shown a system 100 for use in analysis, such as biological or chemical analysis. System 100 can include light energy exciter 10 and a detector assembly 20.

Detector assembly 20, sometimes referred to as a flow cell, can include detector 200 and a flow channel 282 which flow channel 282 can be at least partially bounded by detector 200. Detector 200 can include a plurality of light sensors 202, which light sensors 202 can be provided by sensing photodiodes, and detector surface 206 for supporting samples 502 such as biological or chemical samples subject to test. Sidewalls 284, and flow cover 288, as well as detector 200 having detector surface 206 can define and delimit flow channel 282. Detector surface 206 can have an associated detector surface plane 130.

Detector 200 can include a plurality of light guides 214 that receive excitation light and emissions signal light from detector surface 206 resulting from excitation by the excitation light. The light guides 214 can guide light from detector surface 206. The light guides 214 extend toward respective light sensors 202 and can include filter material that substantially blocks the excitation light and substantially permits the emissions signal light to propagate toward the respective light sensors.

Light energy exciter 10 can be activated to emit excitation light 101 to excite fluorophores that have attached to samples 502. On being excited by excitation light 101 fluorophores attached to samples 502 can fluoresce to radiate emissions signal light 501 at a wavelength range having different wavelengths than a wavelength range of excitation light 101, for example, longer wavelengths that a wavelength range of excitation light 101. The presence or absence of emissions signal light 501 can indicate a characteristic of a sample 502. Light guides 214 according to one example can filter light in the wavelength range of excitation light 101 transmitted by light energy exciter 10 so that light sensors 202 do not appreciably detect excitation light 101 as emissions signal light 501.

Examples herein set forth to improve irradiance (radiant flux received by a surface per unit area) of detector surface 206 under various configurations of light energy exciter 10. In one example, light energy exciter 10 can feature light sources connected in parallel, wherein anodes of the light sources are commonly connected to a metal core layer of a printed circuit board. Such an example can feature improved heat removal owing to the reduced thermal resistance of the printed circuit board. Examples herein recognize that, to the extent heat can be removed from light sources, the light sources can be overdriven for improved irradiance, i.e., driven with current above the rated maximum current of the light source.

In another example, light energy exciter 10 can feature light sources connected in series. Where light sources are series connected, they are energized by a common current resulting improved uniformity of irradiance. In one example, light energy exciter 10 can feature flip chip LEDs. Flip chip LEDs can facilitate surface coupling of a light pipe to the LEDs to reduce light losses. In some examples, use of flip chips can facilitate improved LED density per unit area. In a flip chip LED configuration, thermal resistance can be reduced with use of a ceramic insulator, which can improve the ability to overdrive the LEDs for improved irradiance.

Features for improved irradiance can include features for improved alignment of optical components. In one example, a mounting assembly for mounting light pipes can be provided. The mounting assembly can facilitate independent mounting of a first light pipe and a second light pipe. The mounting assembly can feature removable mounting of a first light pipe and a second light pipe. The mounting assembly can feature a standoff distance between a light source bank and a light pipe so that alignment can be independent of light source height manufacturing tolerances. The mounting assembly can feature reduced points of contact to a light pipe for reduction of light losses. In one example, the mounting assembly contacts a light pipe only on a single side and in some cases only at a single point of contact on a single side.

Features for improved irradiance can include features for heat removal that employ timing coordination between light sources. In one example, common wavelength light sources of different light sources banks can have differentiated on times.

According to one example, detector 200 can be provided by a solid-state integrated circuit detector such as a complementary metal oxide semiconductor (CMOS) integrated circuit detector or a charge coupled device (CCD) integrated circuit detector.

According to one example, each light sensor 202 can be aligned to a respective light guide 214 and a respective reaction recess 210 so that longitudinal axis 268 extends through a cross sectional geometric center of a light sensor 202, light guide 214 and reaction recess 210. Flow channel 282 can be defined by detector surface 206, sidewalls 284, and flow cover 288. Flow cover 288 can be a light transmissive cover to transmit excitation light provided by light energy exciter 10.

In another aspect, detector 200 can include dielectric stack areas 218, intermediate of the light guides 214. Dielectric stack areas 218 can have formed therein circuitry, e.g. for read out of signals from light sensors 202, digitization, storage, and/or processing.

System 100 can include inlet portal 289 through which fluid can enter flow channel 282 and outlet portal 290 through which fluid can exit flow channel 282. Inlet portal 289 and outlet portal 290 can be defined by flow cover 288.

According to one example, system 100 can be used for performance of biological or chemical testing with use of fluorophores. For example, a fluid having one or more fluorophore can be caused to flow into and out of flow channel 282 through inlet port using inlet portal 289 and outlet portal 290. Fluorophores can attract to various samples 502 and thus, by their detection fluorophores can act as markers for the samples 502 e.g. biological or chemical analytes to which they attract.

To detect the presence of a fluorophore within flow channel 282, light energy exciter 10 can be energized so that excitation light 101 in an excitation wavelength range is emitted by light energy exciter 10. On receipt of excitation light fluorophores attached to samples 502 can radiate emissions signal light 501 which is the signal of interest for detection by light sensors 202. Emissions signal light 501 owing to fluorescence of a fluorophore attached to a sample 502 may have a wavelength range red shifted relative to a wavelength range of excitation light 101.

System 100 in test support systems area 300 can include process control system 310, fluid control system 320, fluid storage system 330, and user interface 340 which permits an operator to enter inputs for control of system 100. Process control system 310 according to one example can be provided by processor based system. Process control system 310 can run various biological or chemical processes such as DNA sequence reconstruction processes. According to one example, for running of a biological or chemical process, process control system 310 can send coordinated control signals e.g. to light energy exciter 10, detector 200 and/or fluid control system 320. Fluid storage system 330 can store fluids that flow through flow channel 282.

According to one example, light energy exciter 10 can include one or more light sources. According to one example, light energy exciter 10 can include one or more light shaping element. Light energy exciter 10 can include one or more optical component for shaping light emissions directing light emitted from the one or more light sources. The one or more optical component can include, e.g., one or more light pipe, lens, wedge, prism, reflector, filter, grating, collimator, or any combination of the above.

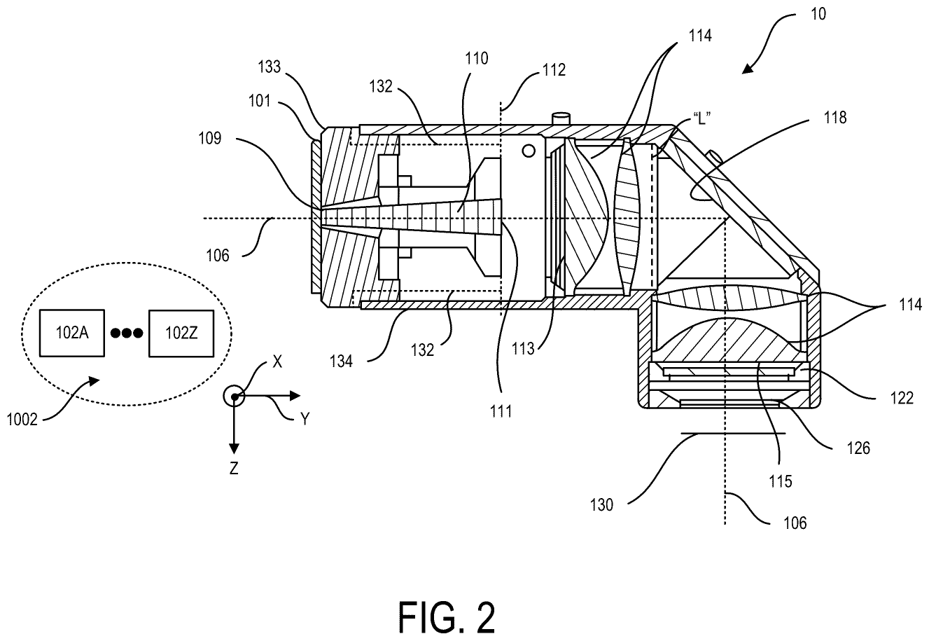

FIG. 2 illustrates a light energy exciter 10 according to one example. Light energy exciter 10 can include a light source bank 1002 having one or more light sources, e.g. light source 102A-102Z and various optical elements for directing light along optical axis 106, which in the example shown is a folded axis.

Light energy exciter 10 can include light pipe 110 and lens 114 for shaping excitation light rays transmitted through light pipe 110. Light pipe 110 and lens 114 can have cross sectional geometric centers centered on optical axis 106.

Light pipe 110 can include light entry surface 109 and light exit surface 111.

Excitation light 101 emitted from light source bank 1002 can enter light entry surface 109 and can exit light exit surface 111 of light pipe 110. Light pipe 110 by having an index of refraction selected for providing internal reflections can reflect received light rays received from light source bank 1002 in various directions to homogenize light so that exit light rays transmitted through light pipe 110 are homogenous. Thus, even where a light source of light source bank 1002 may have “hot spots” or is asymmetrically disposed with respect to light pipe 110 or have other irregularities, homogenous light can be produced at the light exit surface 111 of light pipe 110.

Light pipe 110 by having an index of refraction selected for providing internal reflections can confine excitation light rays that it receives and transmits to the volumetric area delimited by sidewall surfaces defining light pipe 110. Light pipe 110 can be formed of homogenous light transmissive material, e.g. polycarbonate or silica glass.

According to one example, light pipe 110 can be of tapered construction defined by an increasing diameter throughout its length in a direction from the light entry surface 109 to the light exit surface 111 of light pipe 110. According to one example, light pipe 110 can be of tapered construction defined by a linearly increasing diameter throughout its length in a direction from the light entry surface 109 to the light exit surface 111 of light pipe 110.

According to one example, light energy exciter 10 can be configured so that lens 114 images light exit surface 111 of light pipe 110 onto image plane 130 and according to one example system 100 can be configured so that image plane 130 coincides with detector surface 206 which can be configured to support a sample 502 such as a DNA fragment. Lens 114 by imaging an object plane onto an image plane can project an image of homogenized light present at light exit surface 111 of light pipe 110 onto sample supporting detector surface 206 of detector 200 (FIG. 1A).

Examples herein recognize that while light source bank 1002 can be selected so that excitation light rays emitted from light source bank 1002 do not include fluorescence range light rays, fluorescence range light rays can nevertheless radiate within light energy exciter 10 as a result of autofluorescence. In another aspect, light energy exciter 10 can include a short pass filter 122 to filter fluorescence range wavelengths radiating as a result of autofluorescence from within light energy exciter 10, e.g. radiating from lens 114, light pipe 110, and reflector 118 as well as other surfaces of light energy exciter 10.

Light energy exciter 10 can include light reflector 118 for folding optical axis 106 so that optical axis 106 changes direction from a first direction in which optical axis 106 extends parallel to the reference Y axis shown to a second direction in which optical axis 106 extends parallel to the reference Z axis shown. Light energy exciter 10 can include window 126 having a cross sectional center centered on optical axis 106 as well as housing 134 and other supporting components for supporting the various optical components in certain spatial relation such as the certain spatial relation depicted in FIG. 1A.

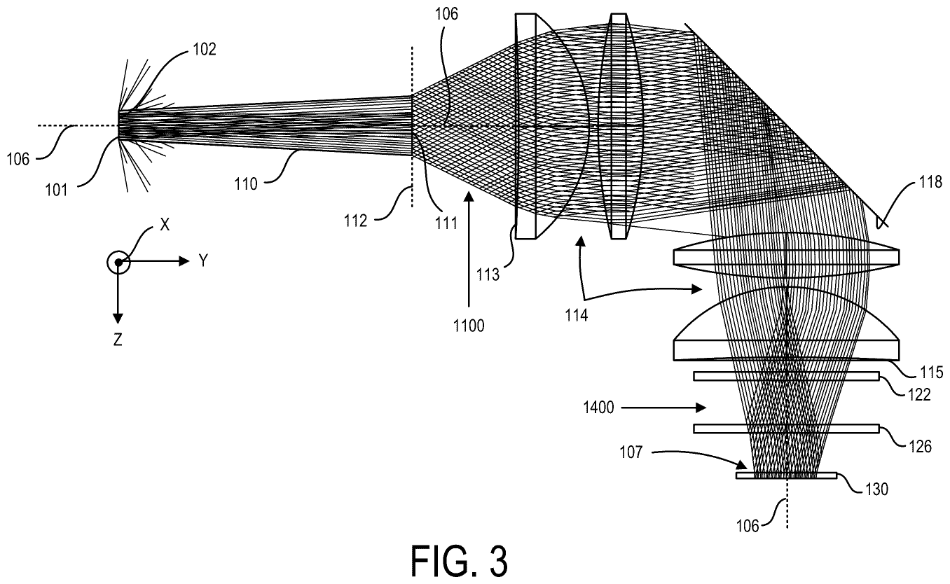

A ray trace diagram for light energy exciter 10 in the example of FIG. 2 is shown in FIG. 3. Referring to the ray trace diagram of FIG. 3, lens 114 can image an object plane 112 which can be defined at the light exit surface 111 of light pipe 110 onto an image plane 130 which can be located at detector surface 206 that can be adapted to support biological or chemical samples. As seen from the ray trace diagram of FIG. 3, light rays exiting light exit surface 111 of light pipe 110 can be diverging light rays that diverge at a divergence angle that is sufficiently restricted so that a majority of light rays exiting light exit surface 111 of light pipe 110 are received by light entry surface of lens 114. Examples herein recognize that while light pipes are useful for purposes of homogenizing light, they are capable of transmitting exit light rays that exit at large maximum divergence angles, e.g. approaching 90°.

Examples herein recognize for example that in the case that light pipe 110 is constructed alternatively to have a uniform diameter, i.e. a non-tapered diameter, a substantial percentage of exit light rays exiting light pipe 110 may exit light exit surface 111 at a divergence angle that is sufficiently large that a light entry surface 113 of lens 114 may not collect the exit light rays. Examples herein recognize that providing light pipe 110 to be of tapered construction, tapered along its length and having a geometric cross sectional center centered on optical axis 106 and including an appropriate index of refraction provides reflections within light pipe 110 so that light exiting light rays exiting light exit surface 111 of light pipe 110 exit light exit surface 111 of light pipe 110 at an angle that is reduced relative to a 90° angle of maximum divergence.

In the example described in reference to FIGS. 2 and 3, exit light rays exiting light exit surface 111 of light pipe 110 can define a diverging cone of light 1100 having light rays that diverge at angles ranging from zero degrees to a maximum divergence angle in respect to a reference light ray extending from the light exit surface in a direction parallel to optical axis 106. The defined diverging cone of light 1100 can diverge at the maximum divergence angle with respect to optical axis 106. According to one example, the maximum divergence angle is a divergence angle designed so that the majority of exit light rays exiting light exit surface 111 are collected by a light entry surface of lens 114. According to one example, the light energy exciter 10 is configured so that light excitation light rays exiting exit surface 111 diverge at a maximum divergence angle respect to a reference light ray extending from the light exit surface in a direction parallel to optical axis 106 that is sufficiently small so as to ensure collection by light entry surface 113 of lens 114.

According to one example, light energy exciter 10 can be configured so that exit light rays exiting light exit surface 111 of light pipe 110 define a diverging cone of light 1100 having light rays that diverge at angles ranging from zero degrees to a maximum divergence angle in respect to a reference light ray extending from the light exit surface in a direction parallel to optical axis 106, wherein the light pipe 110 is configured so that the maximum divergence angle is about 60 degrees or less. According to one example, light energy exciter 10 is configured so that exit light rays exiting light exit surface 111 of light pipe 110 define a diverging cone of light 1100 having light rays that diverge at angles ranging from zero degrees to a maximum divergence angle in respect to a reference light ray extending from the light exit surface in a direction parallel to optical axis 106, wherein the light pipe 110 is configured so that the maximum divergence angle is about 50 degrees or less. According to one example, light energy exciter 10 is configured so that exit light rays exiting light exit surface 111 of light pipe 110 define a diverging cone of light 1100 having light rays that diverge at angles ranging from zero degrees to a maximum divergence angle in respect to a reference light ray extending from the light exit surface in a direction parallel to optical axis 106, wherein the light pipe 110 is configured so that the maximum divergence angle is about 40 degrees or less. According to one example, light energy exciter 10 is configured so that exit light rays exiting light exit surface 111 of light pipe 110 define a diverging cone of light 1100 having light rays that diverge at angles ranging from zero degrees to a maximum divergence angle in respect to a reference light ray extending from the light exit surface in a direction parallel to optical axis 106, wherein the light pipe 110 is configured so that the maximum divergence angle is about 35 degrees or less. According to one example, light energy exciter 10 is configured so that exit light rays exiting light exit surface 111 of light pipe 110 define a diverging cone of light 1100 having light rays that diverge at angles ranging from zero degrees to a maximum divergence angle in respect to a reference light ray extending from the light exit surface in a direction parallel to optical axis 106, wherein the light pipe 110 is configured so that the maximum divergence angle is about 30 degrees or less.

For providing imaging functionality, lens 114 can converge received excitation light rays transmitted through light pipe 110. In the example described in reference to FIGS. 2 and 3, exit light rays exiting light exit surface 115 of lens 114 can define a converging cone of light 1400 having light rays that converge at angles ranging from zero degrees to a maximum convergence angle in respect to a reference light ray extending from the light exit surface in a direction parallel to optical axis 106, wherein the lens 114 is configured so that the maximum convergence angle is about 60 degrees or less. The defined converging cone of light 1400 can converge at the maximum convergence angle with respect to optical axis 106. In the example described in reference to FIGS. 2 and 3, exit light rays exiting light exit surface 115 of lens 114 can define a converging cone of light 1400 having light rays that converge at angles ranging from zero degrees to a maximum convergence angle in respect to a reference light ray extending from the light exit surface in a direction parallel to optical axis 106, wherein the lens 114 is configured so that the maximum convergence angle is about 50 degrees or less. In the example described in reference to FIGS. 2 and 3, exit light rays exiting light exit surface 115 of lens 114 can define a converging cone of light 1400 having light rays that converge at angles ranging from zero degrees to a maximum convergence angle in respect to a reference light ray extending from the light exit surface in a direction parallel to optical axis 106, wherein the lens 114 is configured so that the maximum convergence angle is about 40 degrees or less. In the example described in reference to FIGS. 2 and 3, exit light rays exiting light exit surface 115 of lens 114 can define a converging cone of light 1400 having light rays that converge at angles ranging from zero degrees to a maximum convergence angle in respect to a reference light ray extending from the light exit surface in a direction parallel to optical axis 106, wherein the lens 114 is configured so that the maximum convergence angle is about 35 degrees or less. In the example described in reference to FIGS. 2 and 3, exit light rays exiting light exit surface 115 of lens 114 can define a converging cone of light 1400 having light rays that converge at angles ranging from zero degrees to a maximum convergence angle in respect to a reference light ray extending from the light exit surface in a direction parallel to optical axis 106, wherein the lens 114 is configured so that the maximum convergence angle is about 30 degrees or less.

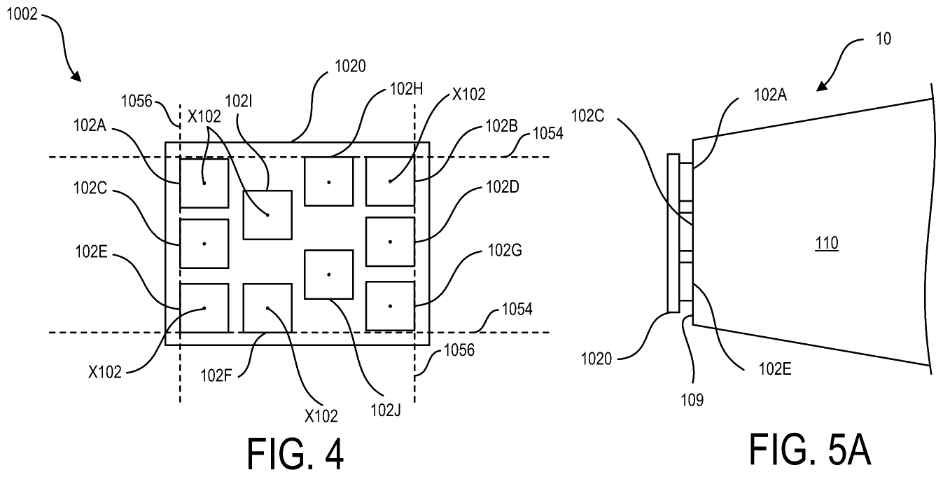

FIG. 4 illustrates light source bank 1002 according to one example. Light source bank 1002 can include one or more light sources. According to one example, one or more light sources can be provided by one or more electroluminescence based light sources, e.g. a light emitting diode, a light emitting electrochemical cell, an electroluminescent wire, or a laser, or any combination of the above. In the example described in FIG. 4, light source bank 1002 can include a plurality of light sources 102A-102J provided by a plurality of light emitting diodes (LEDs). Light sources 102A-102G in the example described can be green LEDs emitting excitation light rays in the green wavelength band and light sources 102H-102J can be blue LEDs emitting excitation light rays in the blue wavelength band. Light sources 102A-102J provided by LEDs can be disposed on printed circuit board 1020 according to one example. In operation of system 100, process control system 310 can control energization of light sources 102A-102J provided by LEDs so that one or more LEDs of a certain emission band is selectively activated at a certain time. Light sources 102A-102J according to one example can be provided by surface emitting LEDs. LEDs such as surface emitting LEDs can have emissions patterns that correlate ray angles with light intensity. LED emissions patterns can be a function of such parameters as a die geometry, a die window, indices of and refraction of light shaping materials. Emissions patterns can be Lambertian according to one example i.e. specifying that intensity is proportional to the cosine of the emission angle relative to the normal. Printed circuit board 1020 can extend in a plane as shown throughout the views.

Process control system 310 for example can energize only light sources 102A-102G provided by green LEDs during a first exposure period of detector 200 in which light sensors 202 are exposed and can energize only light sources 102H-102J provided by blue LEDs during a second exposure period of detector 200 in which light sensors 202 are exposed. Providing light source bank 1002 to emit at two independently selectable peak wavelengths facilities a dye chemistry process that can use both green (532 nm) and blue (470 nm) excitation. According to one example, light source bank 1002 can include a light source e.g. a red LED disposed on printed circuit board 1020 that emits at a red band center wavelength (e.g. red: 630 nm). Providing red illumination facilitates additional test and calibration procedures according to one example.

It is seen in reference to FIG. 4 that light sources defining light source bank 1002 need not be arranged symmetrically uniformly or according to any ordered configuration. For example, it is seen that according to the particular configuration shown in FIG. 4, wherein light sources 102A-102G provided by green LEDs are selectively energized with light sources 102H-102J provided by blue LEDs maintained in a deenergized state, a larger percentage of excitation light rays will enter light pipe 110 through a left side of light entry surface 109 of light pipe 110, and when light sources 102H-102J provided by blue LEDs are selectively energized with green LEDs maintained in a deenergized state, a larger percentage of excitation light rays will enter light pipe through a right side of light entry surface 109 of light pipe 110. Notwithstanding, light pipe 110 by its light reflective properties homogenizes the imbalanced incoming received light to produce homogenized light at the light exit surface 111 of light pipe 110 irrespective of the arrangement of light sources of light source bank 1002. The refractive index of light pipe 110 can be chosen such that the light rays from light source bank 1002 exhibit total internal reflection (TIR) within light pipe 110 such that at light exit surface 111 of light pipe 110, homogeneous (uniform) illumination is achieved.

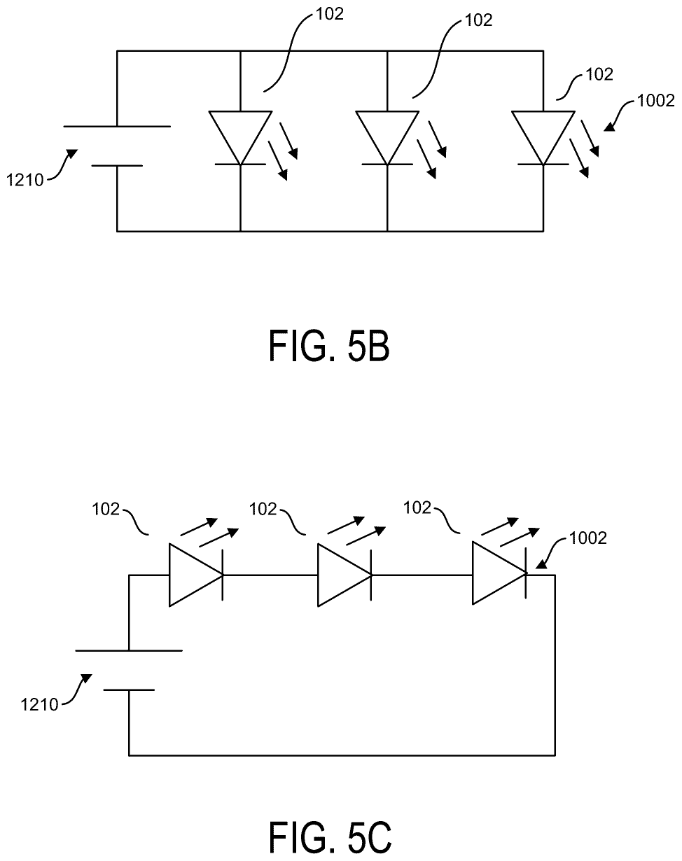

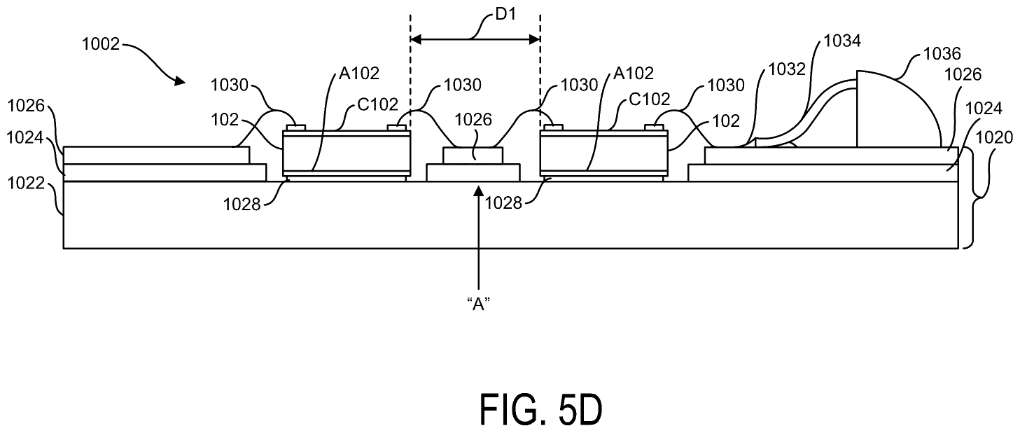

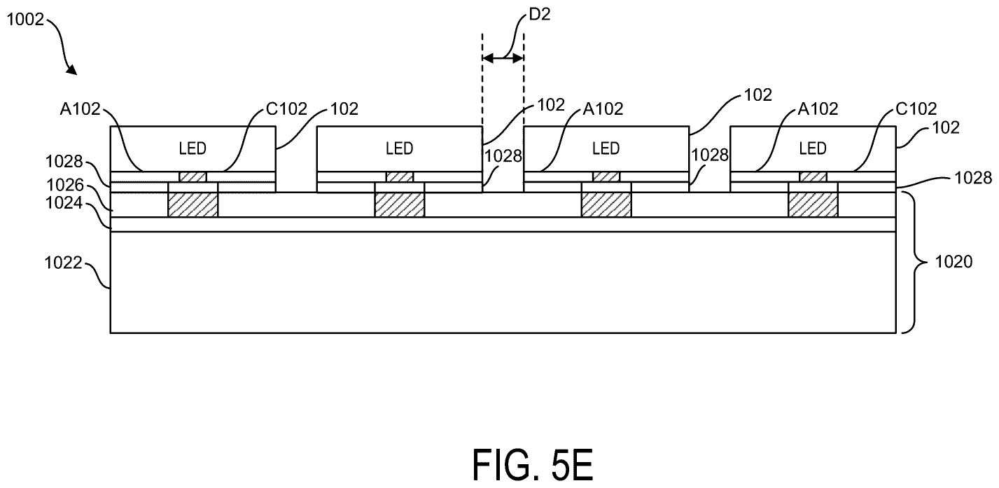

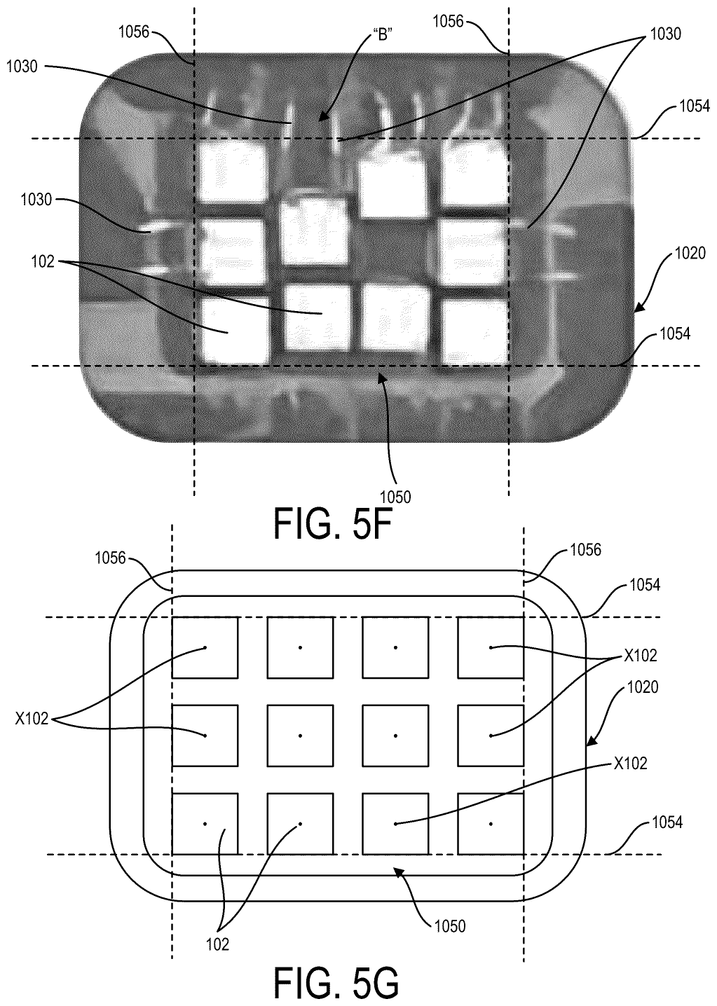

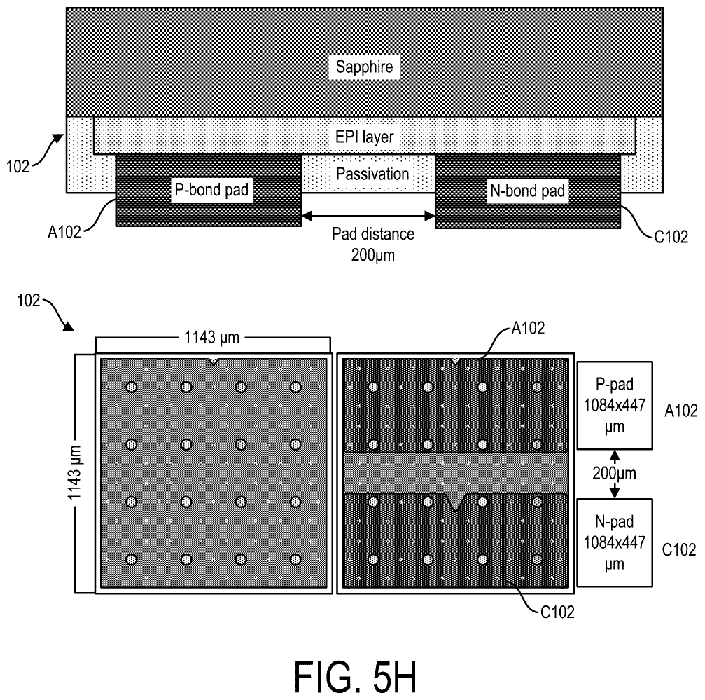

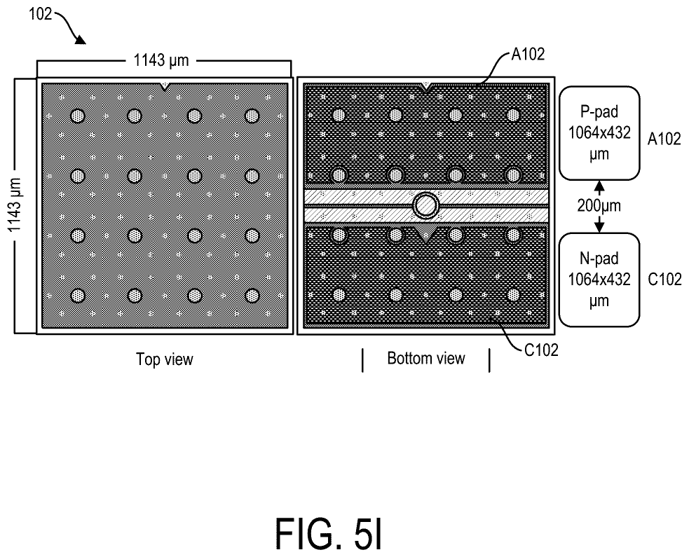

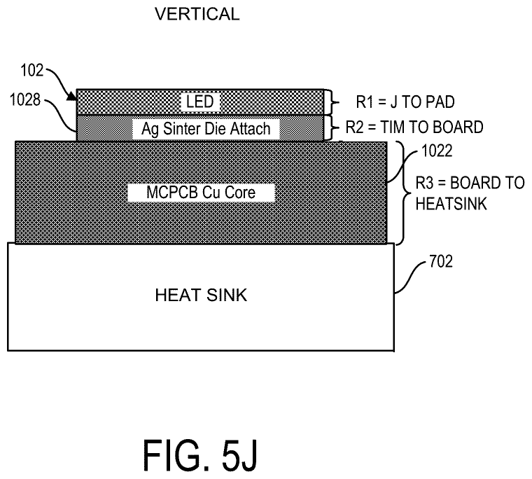

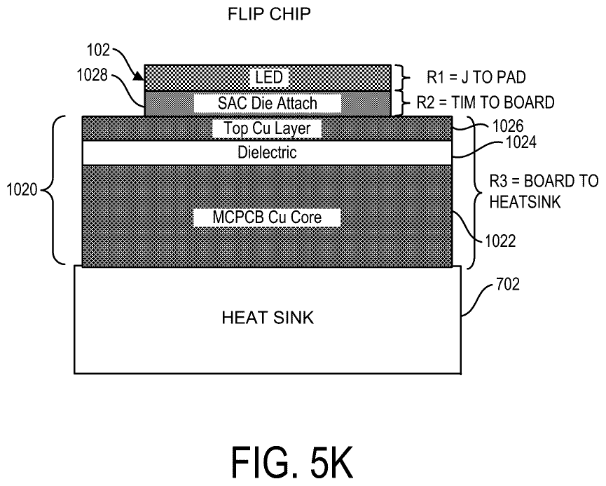

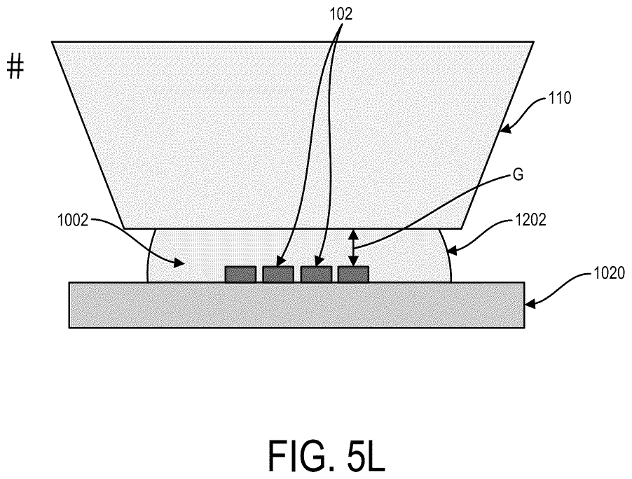

As shown in FIG. 5A, light source bank 1002 can be coupled to light pipe 110 in a manner to assure reduced light loss. In the arrangement depicted in FIG. 5A, there is a side view of the LEDs shown as being disposed on printed circuit board 1020 in FIG. 4. In the side view depicted in FIG. 5A, light sources 102A, 102C, and 102E provided by LEDs are shown to correspond to light sources 102A, 102C, and 102E, as depicted in FIG. 4. Light sources 102A-102J can be provided by LEDs having flat planar light emission faces depicted as depicted in in FIG. 5A. Referring to FIG. 5A the flat planar light emission faces of light sources 102A-102J provided by LEDs (of which light sources 102A, 102C, and 102E are shown in the side view) are surface coupled (butt coupled) onto light entry surface 109 of light pipe 110. Light entry surface 109 like the emission surfaces of light sources 102A-102J provided by LEDs, can be flat and planar to assure low light loss when light sources 102A-102J provided by LEDs are surface coupled onto light entry surface 109. With use of the surface coupling depicted in FIG. 5A, coupling efficiency specifying the efficiency of LED light transmission through light pipe 110 of 90 percent or greater can be achieved, and according to one example 98 percent or higher, which compares favorably to coupling efficiency of light sources into a lens where coupling efficiency is in dependence on the numerical aperture of the lens.

Further in reference to FIG. 5A, it is seen that an entirety of the front face of each respective light source 102A-102J provided by LEDs is opposed by light entry surface 109 of light pipe 110, thus assuring that a majority of excitation light rays emitted by light sources 102A-102J provided by LEDs are received by light entry surface 109 of light pipe 110.

Light source bank 1002 can be connected in various configurations. FIG. 5B illustrates light source bank 1002 connected in a parallel electrical connection configuration and FIG. 5C illustrates light source bank 1002 connected in a series electrical connection configuration. In FIG. 5B, the light sources defining light source bank 1002 are labeled generically as light sources 102. In FIG. 5C, the light sources defining light source bank 1002 are also labeled generically as light sources 102. Light sources 102 in FIG. 5B and FIG. 5C can be provided by LEDs.

In the parallel electrical connection configuration of FIG. 5B, the anode of each respective light source 102 can be connected to a positive voltage terminal power supply 1210 and the cathode of each respective light source 102 is connected to a negative terminal voltage of power supply 1210. Power supply 1210 can be configured as a current regulator. In the series connection configuration of FIG. 5C, the anode of a first light source 102 defining the series connection of light sources can be connected to the positive terminal voltage of power supply 1210, and the cathode of the last series connected light source 102 can be connected to the negative terminal voltage of power supply 1210. Power supply 1210 can be configured as a current regulator. Where power supply 1210 drives LEDs, power supply 1210 can be regarded to be an LED driver.

Each of the parallel electrical connection configuration of FIG. 5B in the series electrical connection configuration of FIG. 5C can provide various advantages, and each can be preferred depending on the particular application and design goals.

In one aspect, examples herein recognize that with the parallel electrical connection configuration shown in FIG. 5B, printed circuit board 1020 can be provided by a metal core printed circuit board (MCPCB). An MCPCB is a printed circuit board that comprises a metal core as a main supporting substrate. The core can be configured to direct heat away from circuit components which produce heat.

Examples herein recognize that for improved heat removal, printed circuit board 1020 can be provided by metal core printed circuit board (MCPCB) having a core substrate provided by metal core layer 1022, insulator layer 1024, and conductive metal routing layer 1026 as shown in FIG. 5D. In the example of FIG. 5D, metal core layer 1022 can be provided by a copper substrate. In the example of FIG. 5D, metal core layer 1022 can be connected to a positive terminal of power supply 1210 (FIG. 5B) and conductive metal routing layer 1026 can be connected to negative terminal of power supply 1210 as shown in FIG. 5B.

Examples herein recognize that use of a parallel electrical connection for a light source bank can facilitate the common connection of anodes A102 of respective LEDs defining light source bank 1002. For example, metal core layer 1022 can be connected to a positive voltage terminal of power supply 1210 (FIG. 5B), and the anodes A102 of respective LEDs can be commonly connected to the metal core layer 1022 defining a positive voltage terminal of power supply 1210. In the example of FIG. 5D, the anodes A102 of respective light sources 102 provided by LEDs can be commonly connected to metal core layer 1022, and the cathodes C102, which can be defined at the top elevation of respective light sources 102 provided by LEDs can be connected to conductive metal routing layer 1026 (which conductive metal routing layer 1026 can be connected to negative voltage terminal power supply 1210 of FIG. 5B) via bond wires 1030 as shown in FIG. 5D. Commonly connecting all light sources 102 provided by LEDs defining a light source bank 1002 to metal core layer 1022 can reduce thermal resistance and in some examples can improve heat removal relative to an alternate configuration in which light sources 102 are not commonly connected to a metal core layer 1022.

Conductive metal routing layer 1026 can be connected to a negative voltage terminal of power supply 1210 (FIG. 5B) as shown in FIG. 5D by way of bond wire which can be connected to conductive metal routing layer 1026 with use of solder connection 1032. Bond wire 1034 can be connected to surface mount termination (SMT) connector 1036 which can connect to negative voltage terminal of power supply 1210 as shown in FIG. 5B. By the connection of anode A102 directly to metal core layer 1022, the arrangement shown in FIG. 5D can provide reduced thermal resistance (RTH) relative to an alternate configuration in which anodes A102 are not connected to metal core layer 1022. The respective anodes A102 of light sources 102 provided by LEDs can be connected to metal core layer 1022 by way of conductive material formation 1028 which can be provided by a sinter paste connection according to one example. Still referring to the example of FIG. 5D, anodes A102 can be fabricated as shown according to the example of FIG. 5D. Anodes A102 can be formed on a first side of respective light sources 102 provided by LEDs and cathodes C102 can be formed on a second side of respective LEDs.

Another example of an LED arrangement for a light source bank 1002 defined by light sources 102 is shown in FIG. 5E. In the example of FIG. 5E, light sources 102 provided by LEDs can be connected in series as shown in FIG. 5C can be provided by flip chips.

Flip chips herein can refer to a semiconductor device having solder bumps that are deposited on the chip pads. Solder bumps can be deposited on chip pads on the top side of the wafer during a wafer processing stage in order to facilitate the mounting of the semiconductor device onto external circuitry, e.g., a circuit board such as printed circuit board 1020. The semiconductor device can be flipped over so that its top side faces down and can be aligned to pads on an external circuit, e.g., the light source printed circuit board 1020 as shown in FIG. 5E.

Referring to FIG. 5E, the anodes A102 and cathodes C102 can be defined by contact pads or contact pads in combination with solder bumps depending on the patterning of conductive metal routing layer 1026. The light source bank 1002 described in reference to FIG. 5E can define a parallel connection of LEDs shown in FIG. 5B, or a series connection of LEDs as shown in FIG. 5C. Referring to FIG. 5E, anodes A102 and cathodes C102 of respective light sources 102 can be connected to conductive metal routing layer 1026 by way of conductive material formation 1028, which can be provided by an SAC die attach, according to one example.

For the parallel connection shown in FIG. 5B, anodes A102 of each respective light source 102 provided by an LED can be commonly connected to a positive voltage terminal power supply 1210 as shown in FIG. 5B, and the respective cathodes C102 of each respective light source 102 as shown in FIG. 5B can be commonly connected to a negative voltage terminal power supply 1210 as shown in FIG. 5B. The light source bank 1002 as shown in FIG. 5E can also be connected in series as shown in FIG. 5C. For a series connection as shown in FIG. 5C, the segment of conductive metal routing layer 1026 between each respective LED can define a conductor that connects a cathode of a first light source 102 to an anode of the second light source 102 as shown in FIG. 5C.

Referring again to the arrangement for light source bank 1002 as shown in FIG. 5D, conductive metal routing layer 1026 can include intermediate sections such as the intermediate section at “A” intermediate of first and second light sources 102, such as the LEDs adjacently right and adjacently left of the intermediate section at “A”. The insulator layer 1024 and conductive metal routing layer 1026 can have intermediate sections at “A”. Referring to FIG. 5D, respective cathodes C102, can be electrically connected to the intermediate section of conductive metal routing layer 1026 at “A”. The arrangement light source bank 1002 as shown in FIG. 5D facilitates connection of light sources 102 in parallel as shown in FIG. 5B. The arrangement as shown in FIG. 5D can also be configured to support a series connection of light sources 102 as shown in FIG. 5C, by appropriate patterning of metal core layer 1022.

Referring to FIG. 5E, the flip chip LEDs defining light source bank 1002 can be mounted so that an anode A102 and cathode C102 of each respective light source 102 is connected to a section of conductive metal routing layer 1026 by way of conductive material formation 1028. The arrangement shown in FIG. 5E, avoids the use of intermediate sections such as intermediate section at “A” in the example of FIG. 5D. and can be absent of intermediate sections at “A” of FIG. 5D defined by an intermediate section of insulator layer 1024 in an intermediate section of conductive metal routing layer 1026. Because the intermediate section at “A” can be absent in the example of FIG. 5E, the light sources 102 provided by LEDs of FIG. 5E can be placed closer together.

The spacing distance between light sources 102 provided by LEDs in the example of FIG. 5D can be the spacing distance D1, whereas in the example of FIG. 5E, the spacing distance between light sources 102 can be the spacing distance D2, wherein D2<D1. The reduced spacing distance can be facilitated by the use of flip chips and removal of intermediate section at “A” between light sources 102 as shown in FIG. 5D, wherein intermediate section “A” is defined by an intermediate section of conductive metal routing layer 1026 and an intermediate section of insulator layer 1024. Because light sources 102 can be spaced closer together in the example of FIG. 5E more light sources 102 can be placed per unit area on a surface of printed circuit board 1020.

The arrangement as shown in FIG. 5E facilitates the placement of additional light sources 102 per unit area on a surface of printed circuit board 1020 and provides additional example advantages. Because anodes A102 and cathodes C102 in the example of FIG. 5E can be soldered directly to conductive metal routing layer 1026 electrodes (anodes or cathodes) may not be wire bonded to conductive metal routing layer 1026 as shown in FIG. 5D. As such, it may be recognized that implementations with wires 1030 as shown in FIG. 5D conceivably restrict the spacing between light sources 102 provided by LEDs and a surface of light pipe 110 as shown throughout the views.

However, examples herein recognize that the arrangement of FIG. 5E can be absent of wires 1030 defining a top elevation of the arrangement of FIG. 5E as shown in FIG. 5D. Light sources 102 provided by flip chip LEDs as shown in FIG. 5E that can have anodes A102 and cathodes C102 soldered directly to conductive metal routing layer 1026 and can be absent of top surface extending wires 1030 can be spaced more closely to a light entry surface of light pipe 110, thus facilitating surface coupling (butt coupling) of light sources 102 provided by LEDs to light pipe 110.

FIG. 5F depicts an alternative to the arrangement depicted in FIG. 5D. In the example of FIG. 5F, use of intermediate sections at “A” of FIG. 5D can be avoided with use of lengthened wire bonds 1030 as shown at “B” of FIG. 5F. However, it can be observed that lengthened wire bonds 1030 at “B” can restrict the density with which light sources 102 provided by LEDs can be packed per unit area onto a surface of printed circuit board 1020. Use of flip chip LEDs can facilitate dense packing of light sources 102 provided by LEDs as shown in FIG. 5G, wherein light sources 102 are packed into a 4×3 matrix.

In the example of FIG. 5G comprising light sources 102 provided by flip chip LEDs, twelve LEDs can be packed into the same two dimensional area where there are only ten LEDs in the example of FIG. 5F. An arrangement as shown in FIG. 5G with wire bonds 1030 as shown in FIG. 5F, while feasible and advantageous in some examples, may involve at “B” of FIG. 5F lengthened wire bonds 1030 for center LEDs “jumping over” outer LEDs to restrict excitation light rays of the outer LEDs. The flip chip layout of FIG. 5G can feature a J×K array of LEDS arranged in evenly spaced rows and columns of LEDs.

FIG. 5H illustrates side, top and bottom views of light sources 102 provided by a blue light-emitting LEDs. FIG. 5I illustrates top and bottom views of light source 102 provided by a green light-emitting LED. As shown in FIG. 5H and FIG. 5G, light sources 102, according to one example, can have top view dimensions of about 1 mm×1 mm. Contact pads defining anode A102 and cathode C102, can have area dimensions of about 1 mm×450 microns and can have a separation distance of about 200 microns.

FIG. 5J and FIG. 5K are heat sinking diagrams illustrating heat sinking performance in the arrangements of FIGS. 5D and 5E, respectively. FIG. 5J illustrates heat sinking performance in the arrangement of FIG. 5D, whereas FIG. 5K illustrates heat sinking performance in the example of FIG. 5E. Examples herein recognize that heat sinking performance can be expressed as a function of a variety of heat sinking parameter values. Examples herein recognize that heat sinking performance referring to the thermal heat sinking diagrams of FIGS. 5H and 5I, thermal performance can be a function of R1, R2 and R3, where R1 is the “J to pad” thermal resistance, R2 is the “thermal interface material (TIM) to board” thermal resistance, and R3 is the “board to heat sink” thermal resistance.

Regarding R1, the “J to pad” thermal resistance can be dependent on the point at which the diode connects to the base, i.e., junction temperature. R1, “J to pad” thermal resistance can be substantially similar for both the flip chip configuration as shown in FIG. 5K, and for the vertical configuration as shown in FIG. 5J.

Reference is now made to R2 in the examples of FIG. 5J (vertical) and FIG. 5k (flip chip LED). Regarding FIG. 5J (vertical LED example), light source 102 can be connected to metal core layer 1022 directly with use of Ag sinter paste whereas in the flip chip configuration illustrated in FIG. 5K, light source 102 can be connected to conductive metal routing layer 1026 with use of an SAC die attach, for example. In one aspect, R2 can be significantly less in the case of the vertical LED is shown in FIG. 5J. Examples herein recognize that Ag sinter paste can have greater than about two times the thermal conductivity of SAC die attach. SAC herein refers to a solder paste alloy which can be about 96.5% Sn, about 3.0% Ag, and about 0.5% Cu.

Regarding R3, R3 can be the PCB to heat sink 702 thermal resistance. The parameter value R3 can be significantly less in the case of FIG. 5J (vertical LED) relative to FIG. 5K (flip chip LED). In the case of FIG. 5J (vertical LED), light source 102 can be directly attached to metal core layer 1022 of printed circuit board 1020. In the flip chip design of FIG. 5K, there are two additional PCB layers between light source 102 and heat sink 702, namely insulator layer 1024, which can be provided by a dielectric and conductive metal routing layer 1026 which can be provided by a copper layer. The thermal resistance parameter R3 can refer to the thermal resistance provided by printed circuit board 1020. In the case of the arrangement of FIG. 5J (vertical), the thermal resistance provided by printed circuit board 1020 can be provided solely by metal core layer 1022. However, in the example of FIG. 5K, the thermal resistance R3 provided by printed circuit board 1020 can comprise the stacked up layers of metal core layer 1022, insulator layer 1024 and conductive metal routing layer 1026.

Regarding R1, the J2 pad thermal resistance the J2 pad thermal resistance R1 can be about the same for both the vertical LED configuration of Fig. J, and the flip chip configuration of FIG. 5K. Regarding the thermal resistance R2, i.e., the “TIM to board” thermal resistance, R2 can be greater for the flip chip design of FIG. 5K than for the vertical LED configuration as shown in FIG. 5J, wherein light source 102 provided by an LED can be connected to metal core layer 1022 by way of an Ag sinter die attach, whereas in the flip chip LED design of FIG. 5K, light source 102 provided by an LED can be connected to conductive metal routing layer 1026 by way of an SAC die attach, for example.

Regarding the thermal resistance R3, light source 102 provided by an LED as shown in FIG. 5J (vertical LED) can be attached directly to metal core layer 1022, whereas in the flip chip design of FIG. 5K insulator layer 1024 of printed circuit board 1020 can be included in the thermal path defined by printed circuit board 1020.

As explained in reference to the thermal heat sinking diagram of FIG. 5K (flip chip design) heat removal in the implementation of FIG. 5K can be restricted by the presence of insulator layer 1024 that forms the thermal heat removal path in the example of FIG. 5C and FIG. 5E and FIG. 5K (flip chip design with series connection). Examples herein recognize that heat removal in the example of FIG. 5C and FIG. 5E and FIG. 5K (flip chip design with series connection) can be improved with the selection of material for insulator layer 1024. In one example, insulator layer 1024 can be provided by ceramic material.

Improvement in thermal conduction is illustrated in reference to the Table A, which shows thermal resistance for various arrangements for supporting light source bank 1002 as set forth in reference to Table A.

TABLE A

| | 1D Thermal Resistance |
|---|---|
| Architecture - PCB | (C/W) |
| Flip Chip - MCPCB with | 23.9 |
| dielectric | |
| Flip Chip - Ceramic | 7.22 |

The flip chip series connected design of FIG. 5C and FIG. 5E and FIG. 5K (flip chip design with series connection) can exhibit a thermal resistance of about 23.9 C/W. The vertical LED design of FIG. 5B and FIG. 5D and FIG. 5J (vertical LED design with parallel connection) can exhibit thermal resistance of about 3.75 C/W. The flip chip example according to FIG. 5C and FIG. 5E and FIG. 5K (flip chip design with series connection) where insulator layer 1024 is provided by ceramic material can feature thermal resistance of about 7.22 C/W which is on the same order of magnitude as in the design of FIG. 5B and FIG. 5D and FIG. 5J (vertical LED design with parallel connection in which light source 102 is directly connected to metal core layer 1022 of printed circuit board 1020). In one example, where insulator layer 1024 is provided by ceramic material, the ceramic material can be provided by beryllium oxide (BeO). In one example, where insulator layer 1024 is provided by ceramic material, the ceramic material can be provided by aluminum nitride.

Referring to FIG. 5L, light pipe 110 can be connected to and mounted to printed circuit board 1020 with use of material formation 1202. Material formation 1202, in one example, can be provided by a gel formation and in one example material formation 1202 can be provided by a silicone gel formation. Material formation 1202 can be optically clear and can include an index of refraction that matches an index of refraction of the material defining light pipe 110.

Providing material formation 1202 to include an index of refraction that matches an index of refraction of light pipe 110 can improve irradiance of a detector surface resulting from energization of light energy exciter 10. In one aspect, material formation 1202 can include an index of refraction greater than an index of refraction than air for improved optical coupling, and increased irradiance of a detector surface resulting from energization of light energy exciter 10. In one example, the use of material formation 1202 as set forth in FIG. 5J can improve detector surface irradiance by about 15% to about 20%. In the example of FIG. 5L, light sources 102 provided by LEDs can be separated from light pipe 110 by a gap distance, G. In some examples, light sources 102 provided by LEDs can be surface coupled (butt coupled) to a light entrance surface of light pipe 110.

Light energy exciter 10 can emit excitation light 101 (FIG. 1A) at a first lower wavelength range, e.g. below about 560 nm to excite fluorophores which, in response to the excitation light fluoresce to radiate emissions signal light 501 second wavelength range having longer wavelengths, e.g. including wavelengths longer than about 560 nm. Detector 200 can be configured so that these wavelength range emissions at longer wavelengths are detected by light sensors 202. Detector 200 can include light guides 214 that can be formed of filtering material to block light in the wavelength range of excitation light 101 so that that emissions signal light 501 attributable to fluorescing fluorophores is selectively received by light sensors 202.

Examples herein recognize that if light energy exciter 10 emits light in a fluorescence emission band (fluorescence range) such emitted light can be undesirably sensed as emissions signal light by light sensors 202. Examples herein include features to reduce the emission of fluorescence range wavelengths by light energy exciter 10.

As noted, light energy exciter 10 can include short pass filter 122. Short pass filter 122 permits transmission of excitation light rays in the emission energy band of light source bank 1002 but which blocks light at a fluorescence range within flow channel 282 attributable to autofluorescing components within light energy exciter 10. Short pass filter 122 can be disposed at a distal end of light energy exciter 10 so that-short pass filter 122 can reject autofluorescence range wavelengths attributable to autofluorescing materials within light energy exciter 10. To facilitate filtering of autofluorescence range radiation radiating from lens 114 and from components disposed before lens 114 in the direction of light propagation, short pass filter 122 can be disposed after lens 114 in a light propagation direction at a distal end of light energy exciter 10. Short pass filter 122 according to one example can include a substrate having deposited thereon alternating layers of materials having higher and lower indices of refraction. Higher index of refraction material can include e.g. titanium dioxide (TiO₂) or tantalum pentoxide (Ta₂O₅) and lower index of refraction material can include e.g. silicon dioxide (SiO₂). Material layers can be hard coated e.g. using ion beam sputtering, according to one example.

To further reduce fluorescence range light, materials of light energy exciter 10 can be selected for reduced autofluorescence. Examples herein recognize that silicate glass autofluoresces less than polycarbonate materials commonly used in optical systems. According to one example one or more optical components of light energy exciter 10 can be selected to be formed of silicate glass. Examples herein recognize that silicate glass can produce reduced autofluorescence relative to an alternative material for optical components and accordingly in accordance with one example one or more of light pipe 110, lens 114, short pass filter 122 (substrate thereof), and window 126 can be selected to be formed of silicate glass for reduction of autofluorescence. According to one example one or more of light pipe 110, lens 114, short pass filter 122 (substrate thereof), and window 126 is selected to be formed of homogeneous silicate glass for reduction of autofluorescence. According to one example each of light pipe 110, lens 114, short pass filter 122 (substrate thereof), and window 126 is selected to be formed of homogeneous silicate glass for reduction of autofluorescence. Short pass filter 122, in one example, can be disposed at location “L” as depicted in FIG. 2 between the first and second lens pairs defining lens 114. The positioning of short pass filter 122 at location “L” between the depicted lens pairs defining lens 114 can be facilitated in one example by the use of silicate glass for lens 114.

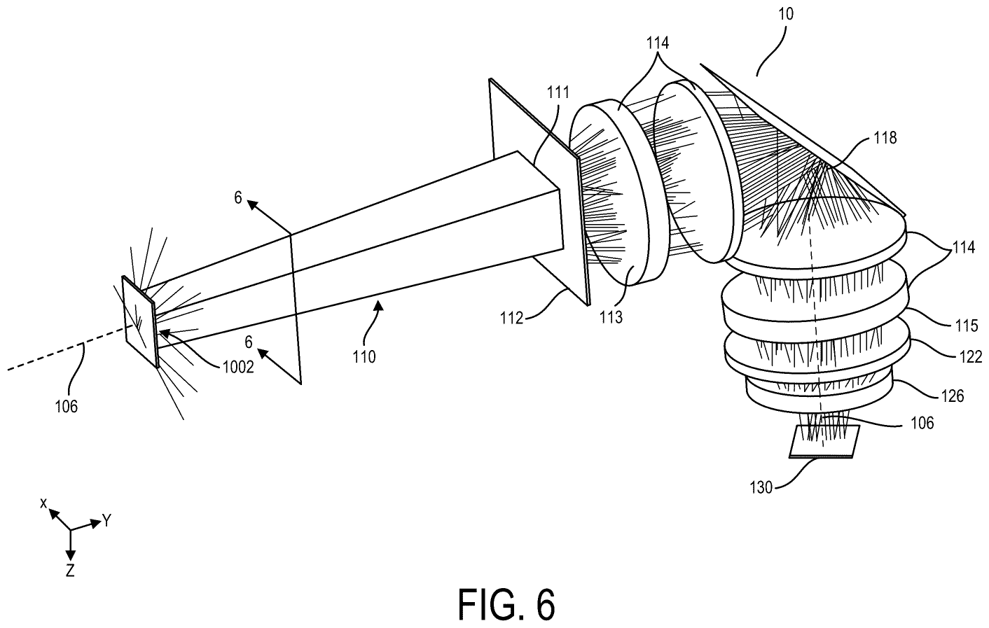

In FIG. 6 a three-dimensional schematic diagram of light energy exciter 10 is shown. As shown in FIG. 6, object plane 112 can be imaged by lens 114 onto image plane 130. As set forth herein, object plane 112 can be defined at light exit surface 111 of light pipe 110, so that the image of the light at light exit surface 111 is projected onto image plane 130, which as noted can be located at detector surface 206 (FIG. 1A) of detector 200 for supporting a sample. It will be understood that because lens 114 can image the light exit surface 111 of light pipe 110, the shape of the light exit surface 111 can be imaged onto and accordingly projected onto image plane 130. According to one example, the shape of light exit surface 111 is selected to correspond to the shape and size of detector surface 206, and light energy exciter 10 is configured to image the shape of light exit surface 111 onto image plane 130 so that lens 114 projects an illumination pattern 107 (FIG. 3) onto detector surface 206 that matches a shape and size of detector surface 206.

Configuring light energy exciter 10 to project a light pattern 107 (FIG. 3) onto detector surface 206 that matches a shape and size of detector surface 206 provides various advantages. By such configuring the projected illumination pattern does not illuminate areas outside of a perimeter of detector 200 which is wasteful of light energy and also does not under-illuminate areas that are areas of interest.

In the example described with reference to FIG. 6, both light exit surface 111 and detector surface 206 for supporting a sample can be rectilinear in shape. As seen in FIG. 6, light pipe 110 can include a rectilinear cross section (taken along 6-6 transverse to optical axis 106) throughout its length. Further, as noted, light pipe 110 can be of tapered construction and can have an increasing diameter throughout its length from light entry surface 109 to light exit surface 111 thereof. Where light pipe 110 has a rectilinear cross section, it will be understood that diverging cone of light 1100 defined by excitation light rays exiting light exit surface 111 of light pipe 110 can have a rectilinear cross section with corners becoming softer and more diffuse in the direction of light propagation toward light entry surface 113 of lens 114.

According to one example, light energy exciter 10 can be configured so that light pipe 110 has a rectilinear light exit surface 111, an image of which can be projected by lens 114 onto detector surface 206 for supporting a sample which can have a rectilinear shaped perimeter corresponding to a shape of light exit surface 111.

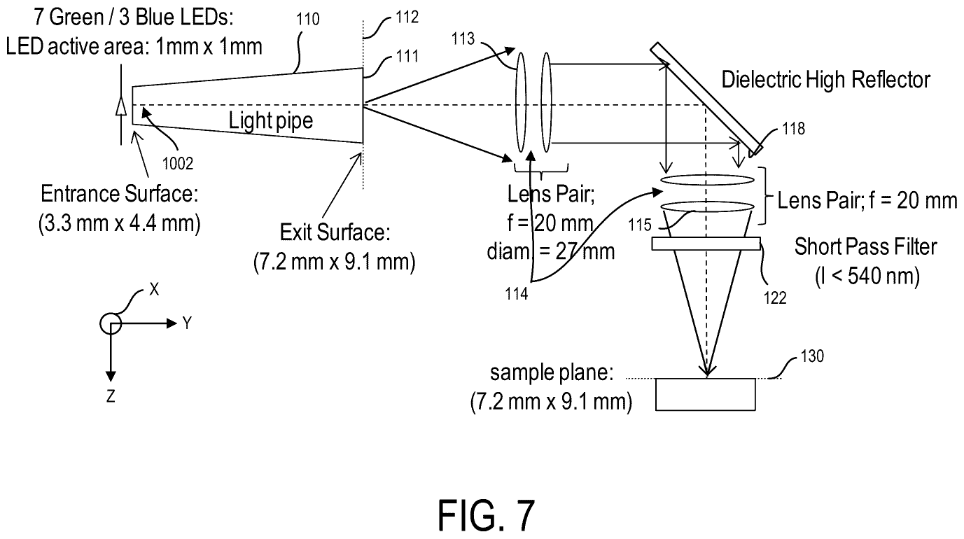

A specification for components of light energy exciter 10 according to one example are set forth FIG. 7 illustrating various optical parameter values for light energy exciter 10 according to one example. In the example illustrated in FIG. 7 lens 114 has a 1:1 magnification so that a size of the projected image at the image plane 130 is in common with the size of the object (the light exit surface 111) at the object plane 112. Light energy exciter 10 according to one example can produce green illumination intensity of about 5 W/cm\hat{ }2 at 2 A drive current per LED die and blue illumination intensity of about 7 W/cm\hat{ }2 at 2 A drive current per LED die. An illumination uniformity of about >75% can be achieved within the whole illumination area. Materials for use in light energy exciter 10 are set forth in Table B hereinbelow.

TABLE B

| Item | Description | Property |
|---|---|---|
| 1002 | Light | SemiLed ® Version 40 mil chips: |
| | source | Proto; Green: 7 dies; 0.6 W/die; 1 × 1 mm²; |
| | bank | 525 nm, (±5 nm) |
| | provided | Proto; Blue: 3 dies; 1.3 W/die; 1 × 1 mm²; |
| | by LEDs | 460 nm, (±5 nm) |
| | | (SemiLed is a trademark of SemiLEDs |
| | | Optoelectronics Co., Ltd.) |
| 110 | Light pipe | Material: N-BK7 ® (N-BK7 is a registered |
| | | trademark of SCHOTT Corporation) |
| | | Length = 35 mm |
| | | Entrance: 3.3 mm × 4.4 mm; Exit: 7.2 mm × |
| | | 9.1 mm |
| 114 | Lens | Material: Zeonor ® 330R |
| | provided | feff = 20 mm |
| | by a lens | (Zeonor is a registered trademark of Zeon |
| | pair | Corporation) |
| 122 | Filter | Semrock ® short pass filter; (Semrock is a |
| | | registered trademark of Semrock, Inc.) |
| | | Substrate Material: Fused Silica; short pass |
| | | filter λ < 540 nm |
| 126 | Window | Substrate Material: fused silica |
| | | Coating: Broadband Dielectric |
| | | Thickness; 1 mm |
| 118 | Reflector | Substrate Material: N-BK7 ® (N-BK7 is a |
| | provided | registered trademark of SCHOTT |
| | by a fold | Corporation) |
| | mirror | Coating: Broadband Dielectric |

In another example, light pipe 110 can be shaped so that a light exit surface 111 of light pipe 110 can have a shape other than a rectilinear shape, e.g. can have a circular cross section taken along 6-6 transverse to optical axis 106). Such an example can be advantageous where sample supporting detector surface 206 has a perimeter that is of a shape other than a rectilinear shape and corresponds to the shape of light exit surface 111.

A design for light energy exciter 10 can be readily modified for optimization with different detectors according to detector 200 having different detector surfaces 206 with different shapes. For example, a first detector according to detector 200 can have a rectangular shaped (from a top view along Z axis) detector surface 206, a second detector according to detector 200 can have a square shaped detector surface 206, and a third detector according to detector 200 can have a circle shaped detector surface 206. Because lens 114 is configured to image object plane 112 coinciding with light exit surface 111 onto detector surface 206, light energy exciter 10 can be optimized for use with any of the differently shaped detectors simply by changing light pipe 110 to be a different configuration. According to one example, as indicated by dashed line 132 of FIG. 2 which indicates a holder for holding an interchangeable module light energy exciter 10 can be of modular construction with a light pipe module 133 being removably exchangeable and light energy exciter 10 can be provided with multiple of such light pipe blocks or modules each with a differently configured one or more light pipe 110. Optimizing light energy exciter 10 for use with a differently shaped detector 200 having a differently shaped detector surface 206 can include simply switching out a first currently installed light pipe module 133 having a first light pipe 110 and first pipe light exit surface 111 of a first shape with a second light pipe module 133 having a second light pipe 110 and light pipe exit surface 111 of a second shape that matches the shape the differently shaped detector 200 having a differently shaped detector surface 206. Light energy exciter 10 can be configured so that when a different module is installed into a holder of housing 134 as indicated by dashed line 132, the light exit surface 111 of a light pipe 110 of the newly installed module 133 is located on the object plane 112 so that the light exit surface 111 of light pipe 110 can be imaged onto image plane located on detector surface 206.

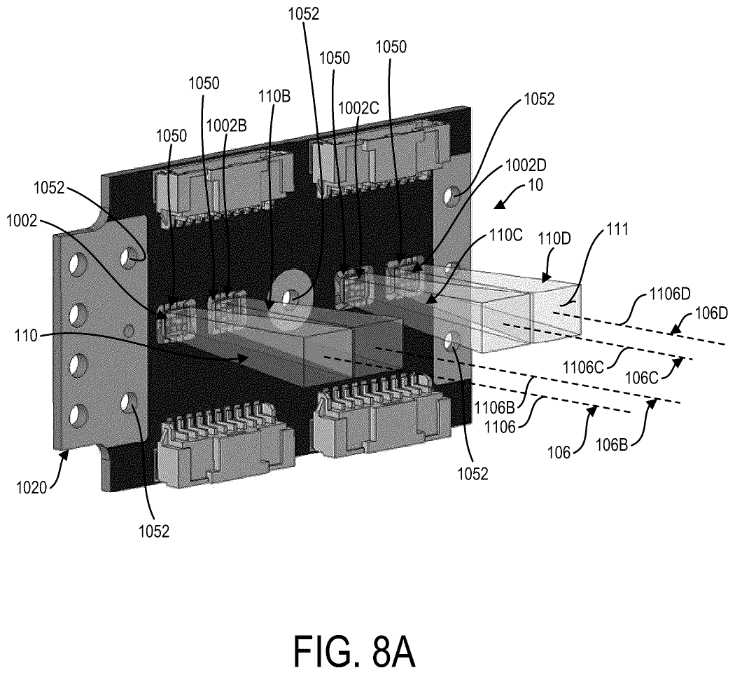

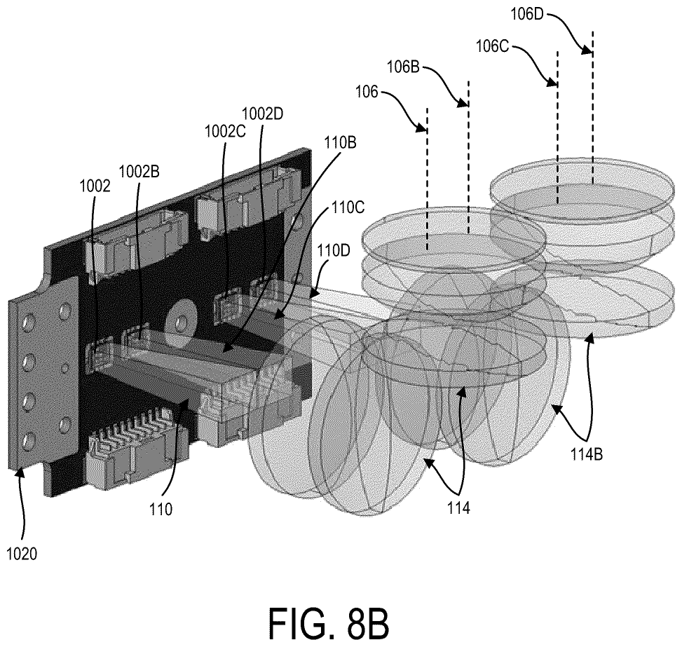

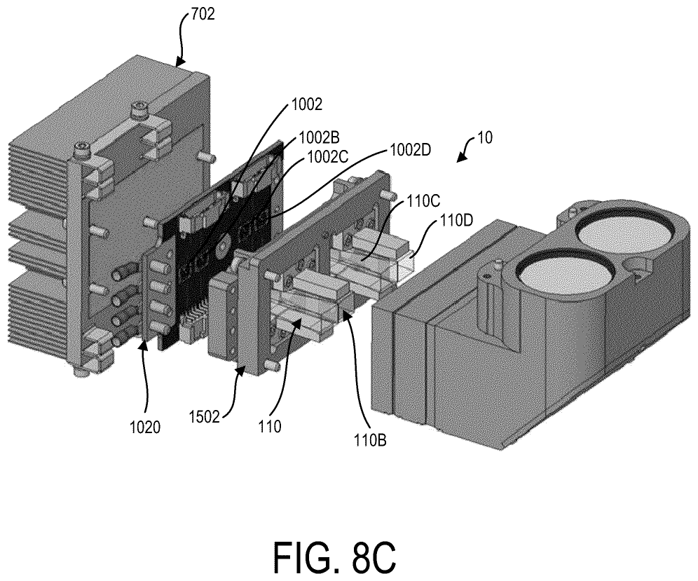

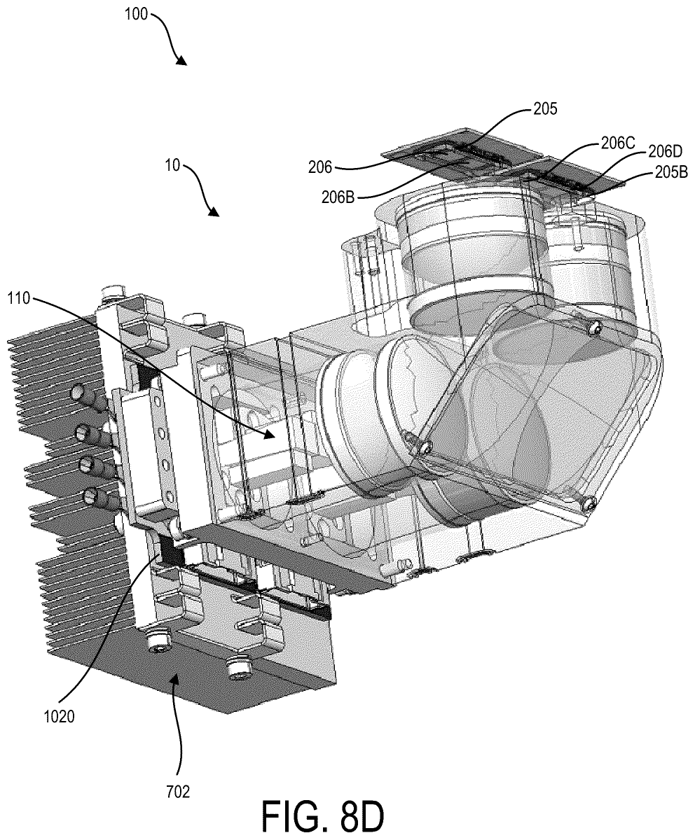

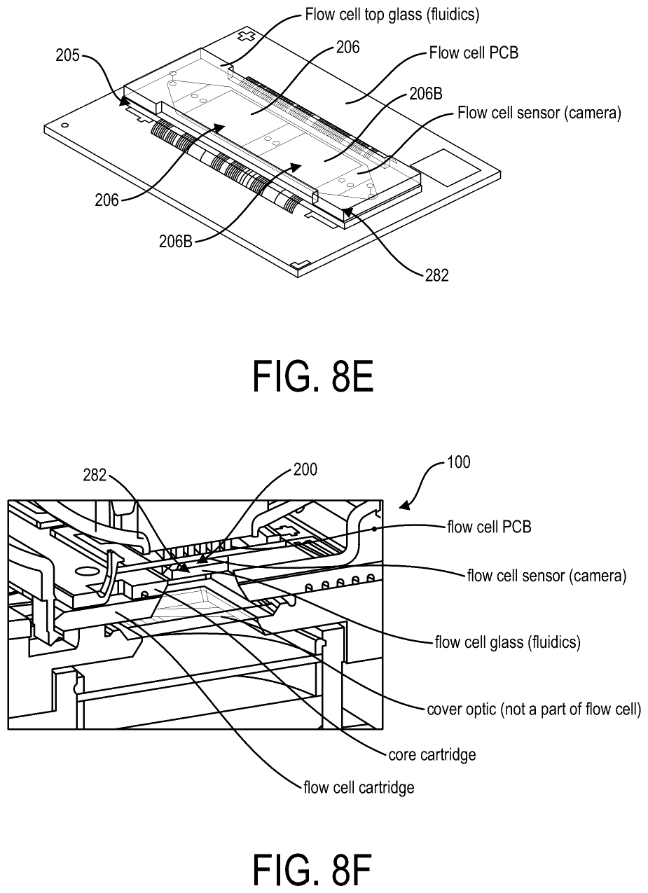

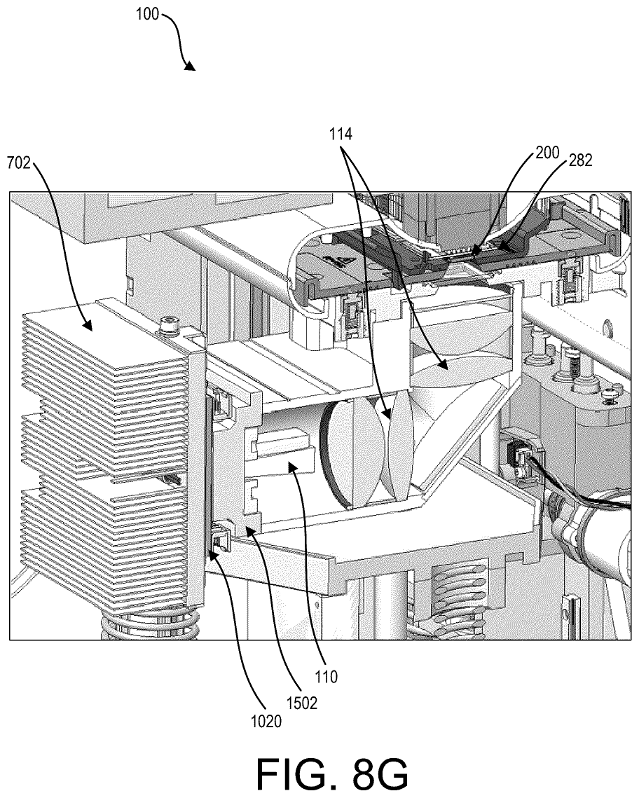

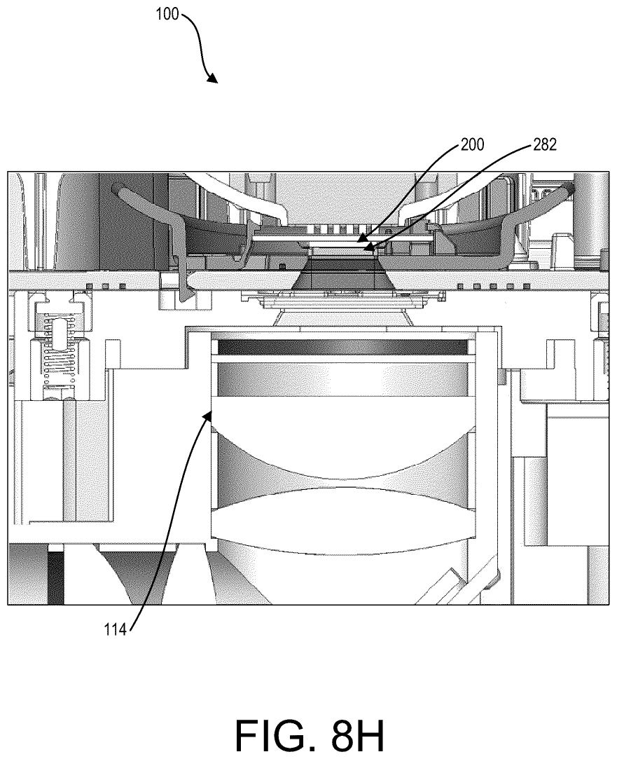

In one example, as shown in FIG. 8A, light energy exciter 10 can include multiple light source banks 1002, e.g., light source bank 1002, light source bank 1002B, light source bank 1002C and light source bank 1002D. The various light source banks 1002, 1002B, 1002C, 1002D can be spaced apart as shown and can be mounted at separate spaced apart light source bank carrying regions 1050 of printed circuit board 1020. Specifically light sources defining light source bank 1002 can be mounted on a first light source bank carrying region 1050, light sources defining second light source bank 1002B can be mounted on a second light source bank carrying region 1050 as shown, light sources defining third light source bank 1002C can be mounted on a third light source bank carrying region 1050 as shown, and light sources defining fourth light source bank 1002D can be mounted on a fourth light source bank carrying region 1050 as shown. The different light source bank carrying regions 1050, which can be spaced apart, can each be in thermal communication with heat sink 702. In one example, each of the spaced apart light source bank carrying regions 1050 of printed circuit board 1020 for carrying the respective light source banks 1002, 1002B, 1002C, 1002D can be directly connected to heat sink 702, or can be connected to heat sink 702 using a thermal interface material. Light source banks 1002, 1002B, 1002C, 1002D can be mounted to printed circuit board 1020 so that a thermal resistance between the respective light source banks 1002, 1002B, 1002C, 1002D and heat sink 702 is less than a thermal resistance between light source banks 1002, 1002B, 1002C, 1002D. The described configuration, wherein the thermal resistance between the respective light source banks 1002, 1002B, 1002C, 1002D and heat sink 702 is less than a thermal resistance between respective light source banks 1002, 1002B, 1002C, 1002D, can improve the removal of heat from each respective light source bank 1002, 1002B, 1002C, 1002D, and can reduce heat transfer between respective light source banks 1002, 1002B, 1002C, 1002D. In one example, printed circuit board 1020 can include a plurality of screw holes 1052 distributed throughout an area of printed circuit board. Screw holes 1052 can include a center screw. For connecting and attaching printed circuit board 1020 to heat sink 702, screws can be fitted through the described screw holes 1052 and threaded into mating threaded holes of heat sink 702 so that compression forces for improving thermal conductivity can be increased by tightening of the described screws.

The described light source bank carrying regions 1050 of printed circuit board 1020 can be defined by surface area regions of printed circuit board 1020. In one example, the described light source bank carrying regions 1050 can be defined by surface modified surface area regions of printed circuit board 1020. In one example, surface modified surface area regions of printed circuit board 1020 can be regions of printed circuit board 1020 characterized as shown in FIG. 5D having one or more layer of printed circuit board 1020 removed, such as insulator layer 1024 and conductive metal routing layer 1026, in order to facilitate the direct connection of light sources 102 to metal core layer 1022 as described in connection with FIG. 5D. In one example, light sources 102 as depicted in FIG. 5D can be connected in a parallel electrical connection configuration as depicted in FIG. 5B. Light source bank carrying regions 1050 are also depicted in FIGS. 5F and 5G. In one aspect, as shown throughout the various views, printed circuit board 1020 can include a plurality of spaced apart light source bank carrying regions 1050, wherein respective ones of the light source bank carrying regions 1050 of printed circuit board 1020 are characterized by having insulator layer 1024 and conductive metal routing layer 1026 removed therefrom, to facilitate direct mounting of light sources 102 to metal core layer 1022 as depicted in FIG. 5D.

The different light source banks 1002-1002D can have associated thereto different light pipes. In the example of FIG. 8A, light pipe 110 can collect and homogenize light from light source bank 1002, light pipe 110B can collect and homogenize light from light source bank 1002B, light pipe 110C can collect and homogenize light from light source bank 1002C, and light pipe 110D can collect and homogenize light from light source bank 1002D. Light pipe 110 and light pipe 110B can project excitation light into lens 114, whereas light pipe 110C and light pipe 110D can project excitation light into lens 114B. Thus, light pipe 110 and light pipe 110B can share a common lens 114, and light pipe 110C and light pipe 110D can share a common lens 114B.

System 100 in the example of FIG. 8D can include first, second, third and fourth detectors 200, 200B, 200C, 200D. Each of the respective detectors can include an array of light sensors 202 (light sensor array 201). Sample supporting structure 260 can include first detector surface 206, second detector surface 206B, third detector surface 206C, and fourth detector surface 206D.

In the example of light energy exciter 10 referred to in FIG. 8D, lens 114 can image the light exit surface of light pipe 110 and the light exit surface of light pipe 110B onto detector surface 206 and detector surface 206B respectively. Light energy exciter 10 by operation of lens 114 and lens 114B imaging an object plane image of light pipe exit surfaces of light pipes 110, 110B, 110C, 110D can project a first illumination pattern to match the size and shape of first detector surface 206, a second illumination pattern to match the size and shape of second detector surface 206B, a third illumination pattern to match the size and shape of third detector surface 206C, and a fourth illumination pattern to match the size and shape detector surface 206D.

Lens 114 can be configured to image object plane 112 defined at light exit surface 111 of light pipe 110 and second light pipe 110B onto image plane 130 which can be defined on detector surfaces 206, 206B, 206C, 206D. Lens 114 can be configured to image object plane 112 defined at light exit surface 111 of light pipe 110 and second light pipe 110B onto image plane 130 which can be defined on detector surface 206 and detector surface 206B. By imaging light exit surface 111 of light pipes 110, 110B, 110C, 110D, lenses 114 and 114B can project illumination patterns matching respective sizes and shapes of first detector surface 206, second detector surface 206B, third detector surface 206C, and fourth detector surface 206D.

Referring to FIG. 8C, light pipes 110, 110B, 110C and 110D can be respectively mounted with certain mounting arrangements such that central axes 1106, 1106B, 1106C and 1106D of the respective light pipes 110, 110B, 110C and 110D extend from the respective light source banks in a manner that the respective axes are arranged in parallel, and also arranged perpendicularly with respect to the light source circuit board of their respective light source banks. Referring to FIG. 8D, detector 200 can include first and second camera integrated circuit chips 205 and 205B. The first camera integrated circuit chip 205 can include detector 200 detector surface 206 and detector 200B detector surface 206B. Second camera integrated circuit chip 205B can include detector 200C having detector surface 206C and detector 200D having detector surface 206D. In between detector surfaces 206 and 206B of camera integrated circuit chip 205 there can be a gap, e.g., of about 500 um. In between detector surfaces 206C and 206D of camera integrated circuit chip 205B there can be a gap, e.g., of about 500 um. System 100 as shown in FIG. 8D can be constructed according to system 100 as shown in FIGS. 8C and 8D including camera integrated circuit chip 205 having first and second detectors and second integrated circuit chip 205B having first and second detectors.

Each respective detector surface 206, 206B, 206C, 206D can be aligned to an array of light sensors 202 (light sensor array 201). According to one aspect of a detector surface 206, 206B, 206C, 206D being aligned to an array of light sensors 202, longitudinal axes 268 vertically extending through centers of light sensors 202 defining the array of light sensors of each respective detector 200 (FIG. 1C) can extend through a respective detector surface 206A, 206B, 206C, 206D.

Detectors and detector surfaces are illustrated in FIGS. 1A-1D. As shown in FIGS. 1A and 1B, detector 200 can include array of light sensors 202 (light sensor array 201) and detector surface 206. Detector surface 206 of detector 200 can be associated to array of light sensors 202 by being aligned to array of light sensors 202 of detector 200. In one aspect of being aligned, detector surface 206 can define an area that is intersected by vertically extending longitudinal axes 268 extending through light sensors defining the array of light sensors 202 of detector.

Referring to FIG. 1B, FIG. 1B is a top-down version view of the detector 200 as shown in FIG. 1A taken along the elevation of light sensors 202 defining an array of sensors of detector 200. It is seen that the array of light sensors 202 (light sensor array 201) can define a two-dimensional array of light sensors laid out in a grid pattern wherein there are defined pixel positions A1-E4 as set forth in FIG. 1B. The pixel positions shown define pixel positions of detector 200 for detector structures above the elevation of the depicted array of light sensors 202. Light guides 214 aligned to respective light sensor 202 can share respective pixel positions A1-E4 with the light sensors 202 to which they are aligned. Reaction sites, e.g., provided by reaction recesses (nanowells) 210 aligned to respective light sensors 202 can share respective pixel positions A1-E4 with the light sensors 202 to which they are aligned. A light sensor 202, light guide 214, and reaction recess 210 can be aligned according to one example by sharing a common longitudinal axis 268. All detectors 200-200D herein can include detector structures having pixels positions as explained with reference to pixel positions A1-F4.

System 100 as shown in FIGS. 1C and 1D includes multiple detectors 200, 200B, 200C, 200D. In system 100 of FIGS. 1C and 1D, there are provided first, second, third and fourth detectors 200, 200B, 200C, 200D defined by respective arrays of light sensors 202 (light sensor arrays 201). As shown by FIGS. 1C and 1D, first and second detectors 200, 200B can be integrated on a first camera image sensor chip 205 and second and third detectors 200C, 200D defined by respective arrays of light sensors 202 (light sensor arrays 201) can be integrated on a second camera image sensor chip 205B. As best seen in FIGS. 1C and 1D, the first and second detectors 200, 200B of the first camera image sensor chip 205 and the second and third detectors 200C, 200D of the second camera image sensor chip 205B can be separated by a gap region 2185 that is absent of light sensors. Further, second and third detectors 200B and 200C can be separated by gap region 2186.

In a further aspect as best seen in FIG. 1D, sample supporting structure 260 can define first, second, third and fourth detector surfaces 206, 206B, 206C and 206D. The respective first, second, third and fourth detector surfaces 206, 206B, 206C and 206D can be associated to and aligned with respective arrays of light sensors 202 (light sensor arrays 201). In the described example of FIGS. 1C and 1D, the first, second, third and fourth detectors 200, 200B, 200C, 200D defined by respective arrays of light sensors 202 can be independently operated. Independent operation herein of different detectors having different arrays of light sensors 202 (light sensor arrays 201) can be characterized by the different detectors having independent exposure periods and/or independent readout periods. As shown by FIGS. 1B and 1D, an array of light sensors 202 can include a two dimensional M×N array of light sensors 202. An M×N array of light sensors can include 1M or more light sensors in one example. An M×N array of light sensors can include 10M or more light sensors in one example. An M×N array of light sensors can include 25M or more light sensors in one example. In one example according to FIGS. 1C and 1D there can be provided four light sensor arrays 201, each having 25M or more light sensors 202.

Light sensors 202 of the different respective detector arrays can be exposed separately in separately controlled exposure periods and image signals from the different respective detector arrays defined by arrays of light sensors 202 can be read out independently and separately. The different detector surfaces 206, 206B, 206C and 206D can be associated and aligned to the respective different detector arrays defined by arrays of light sensors 202 (light sensor arrays 201). According to one aspect of being aligned, respective detector surface 206, 206B, 206C and 206D can define a two-dimensional area indicated in dashed view (to indicate foreground) FIG. 1D that is intersected by vertically extending longitudinal axes 268 extending through centers of the respective arrays of light sensors defining the respective first, second, third and fourth light sensor arrays 201 indicated in FIG. 1D. As noted, system 100 as shown in FIG. 8A-8H can include multiple detector surfaces and be provided according to the example of FIG. 1C-1D.

In the example of FIG. 8A-8H, multiple light pipes can project excitation light rays onto shared lenses. For example, light pipe 110 and light pipe 110B can commonly project excitation light rays onto lens 114, which lens 114 can receive excitation light rays exiting respective light exit surfaces 111 of light pipe 110 and light pipe 110B and which can image an object plane defined at light exit surfaces 111 of light pipes 110 and 110B onto an image plane defined at sample supporting structure 260 so that an image of a light exit surface 111 of light pipe 110 is projected onto detector surface 206 of detector 200 and further so that an image of a light exit surface 111 of light pipe 110B is projected onto detector surface 206B of detector 200B (as best seen in FIG. 8D).

Examples herein recognize that where light energy exciter 10 includes multiple light pipes 110, 110B, 110C, and/or 110D, light energy exciter 10 can particularly benefit from precision alignment features. Precision alignment features herein facilitate precision alignment of first and second light pipes 110, 110B with respect to their respective light source banks 1002, 1002B, with respect to their commonly shared lens 114, and with respect to each other. Precision alignment features herein can facilitate separate and independent mounting of first and second light pipes 110, 110B in respect to their respective light source banks 1002, 1002B. Separate and independent mounting can facilitate alignment with improved accuracy.

Precision alignment features herein can feature removable mounting. Removable mounting, e.g., with removable mechanical screws, can facilitate re-mounting of a light pipe in the case it is observed that light energy exciter 10 would benefit from re-mounting. Precision alignment features herein according to one example can feature a gap distance, G (standoff distance) between a light pipe and a light source bank. Such arrangement can reduce the impact of manufacturing tolerances of light sources on alignment targets. While providing a standoff distance can be advantageous, surface mounting of a light pipe to light sources can be preferred in various applications. In another aspect, precision alignment features herein can provide for restricted mechanical contact, e.g., through contact on a single side and/or point of contact with the light pipe. In such manner, radiance flux produced at detector surface 206 of detector 200 can be improved.

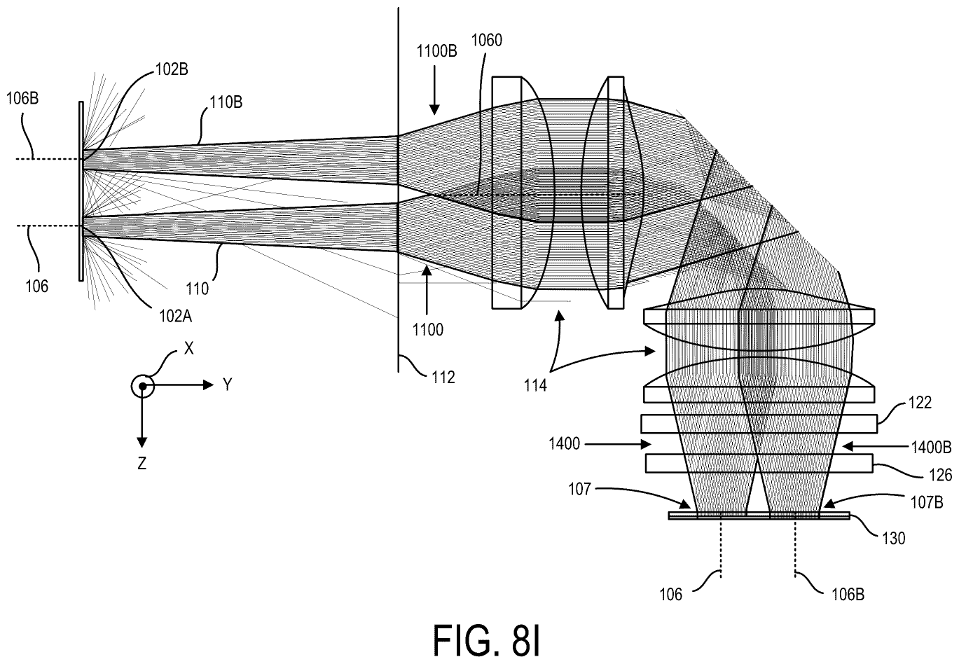

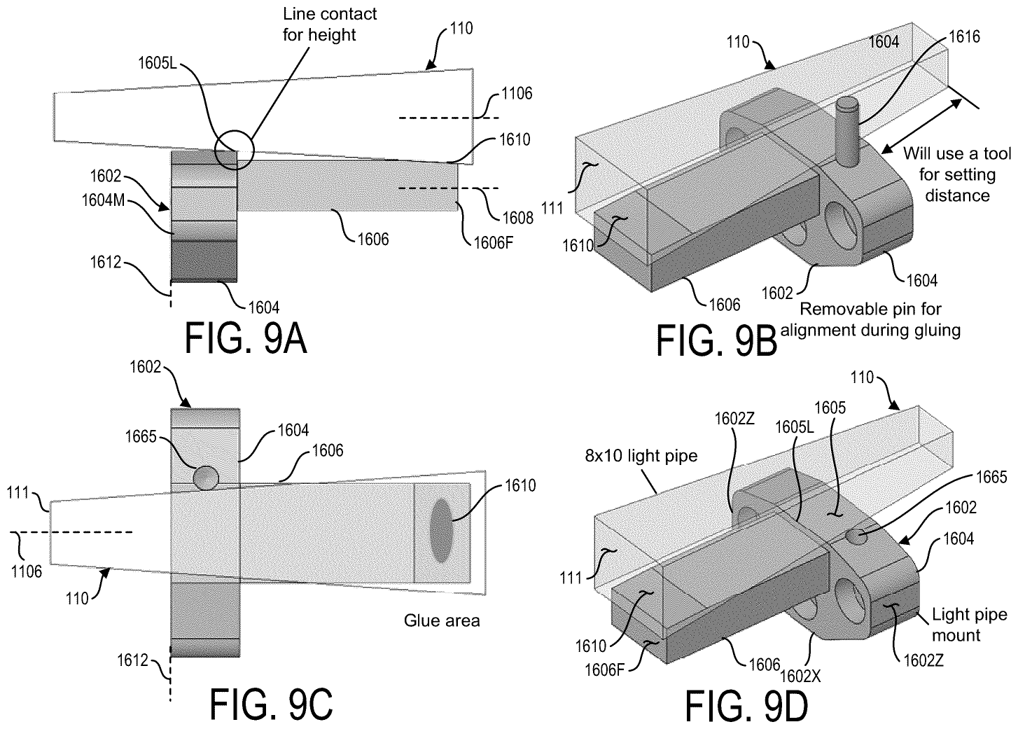

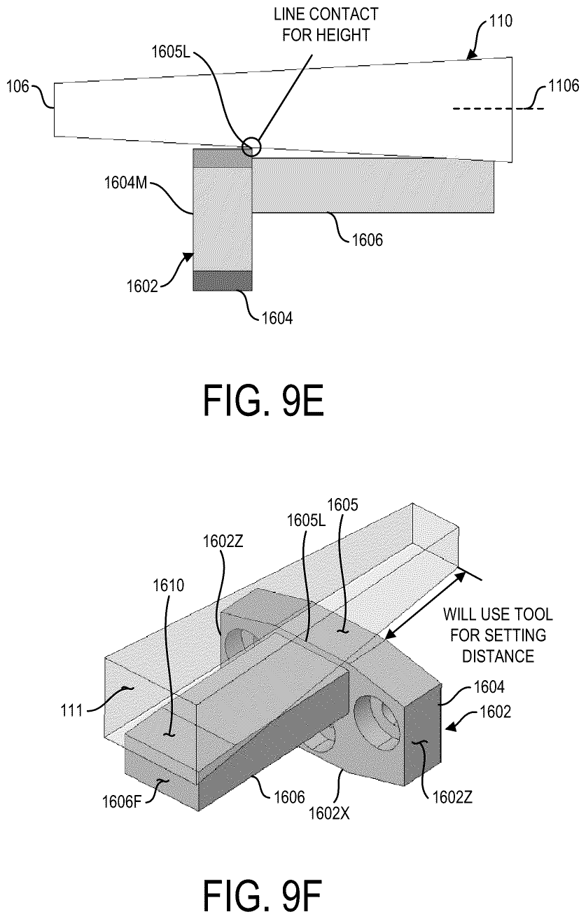

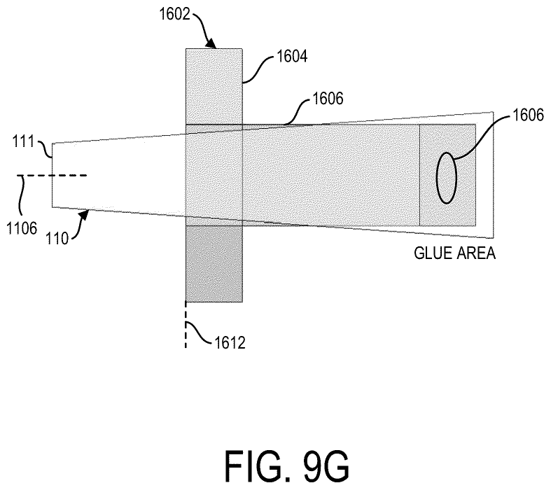

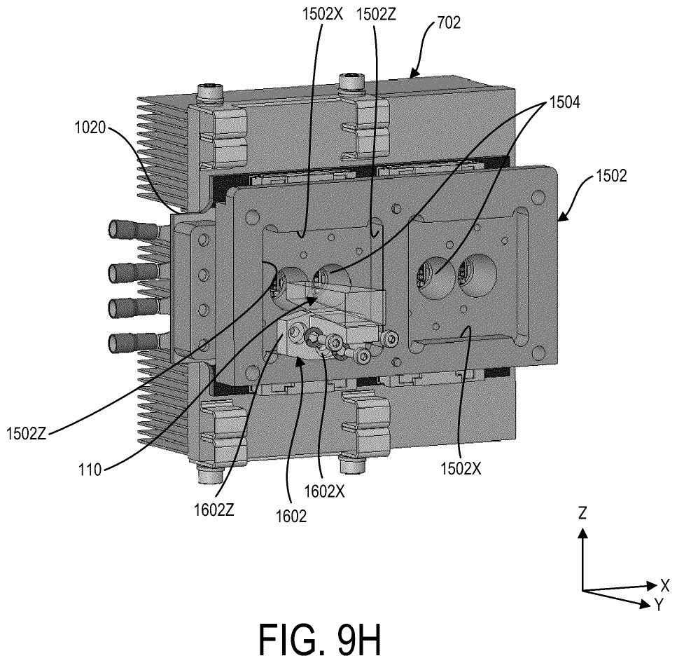

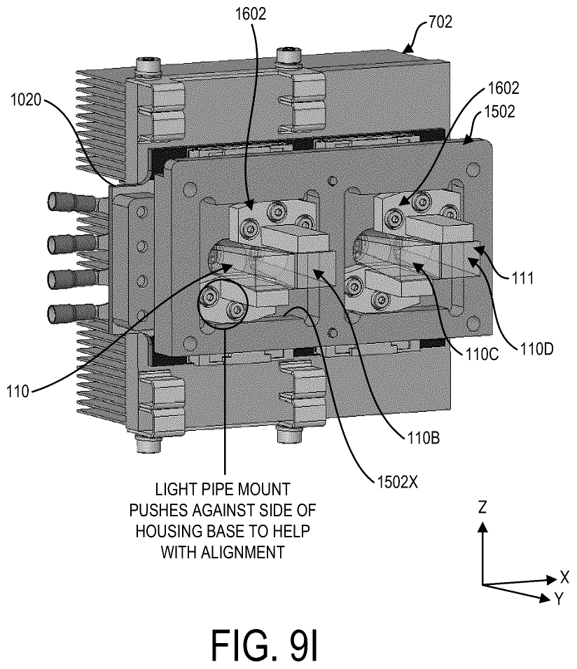

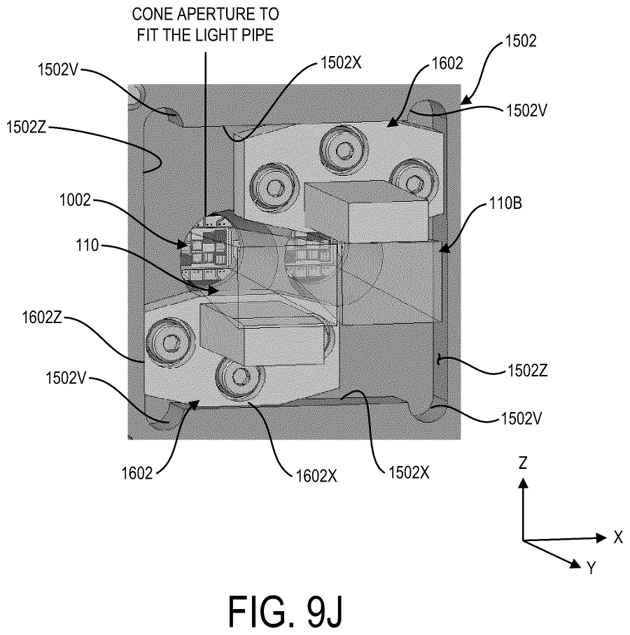

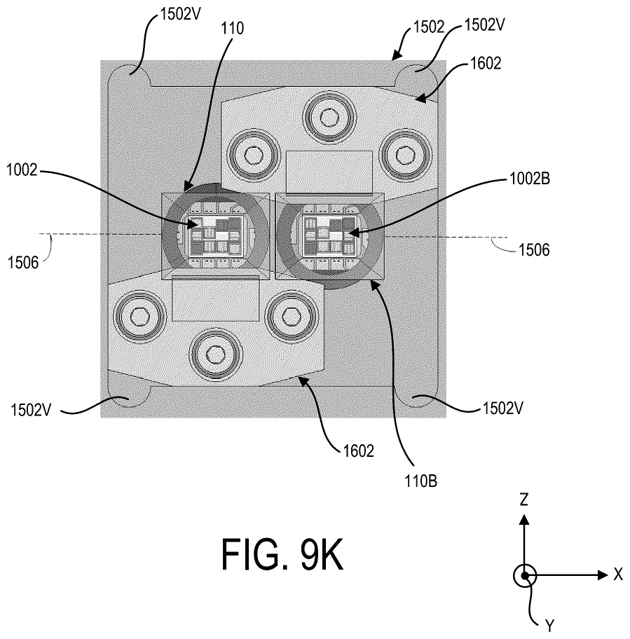

In FIG. 9A to 9K, there is depicted a mounting assembly for mounting first and second light pipes 110 and 110B in relation to respective first and second light source banks 1002 and 1002B. The depicted mounting assembly of FIG. 9A to 9K can include support structure 1502 and light pipe mount 1602 (shown in detailed view in FIG. 9A-9D). Support structure 1502 as best seen in FIG. 9H and 9I as well as FIGS. 8B and 8C can be mounted to have structural members fixed forwardly from (or otherwise in fixed position relative to) light source bank 1002 and light source bank 1002B. Support structure 1502, in one example, can be of unitary, i.e., single piece construction. Support structure 1502, in one example, can be of multiple-piece construction. In one example, as shown throughout the views, support structure 1502 can be mounted to printed circuit board 1020. In one example, support structure 1502 can be defined by printed circuit board 1020.

The depicted mounting assembly can facilitate alignment between a light pipe, e.g., light pipe 110 and a light source 102. In one example of a light pipe, e.g., light pipe 110 being aligned to a light source 102, a central axis X102 of a light source 102 perpendicularly extending through a front face of a light source 102, as depicted in FIG. 4 and FIG. 5G can extend through a light entry surface 109 of the light pipe 110. The depicted mounting assembly can facilitate alignment between a light pipe, e.g., light pipe 110 and a light source 102. The depicted mounting assembly can facilitate alignment between a light pipe, e.g., light pipe 110 and a light source bank, e.g., light source bank 1002. In one example of a light pipe, e.g., light pipe 110 being aligned to a light source bank 1002, a central axis 1106 of light pipe 110 can extend through a light source bank carrying region 1050 of printed circuit board 1020. The depicted mounting assembly can facilitate alignment between a light pipe, e.g., light pipe 110 and a light source bank, e.g., light source bank 1002. In one example of a light pipe, e.g., light pipe 110 being aligned to a light source bank 1002, a central axis 1106 of light pipe 110 can extend through a light source bank carrying region 1050 of printed circuit board 1020 and can perpendicularly extend though printed circuit board 1020. In one example of a light pipe, e.g., light pipe 110, being aligned to a light source bank 1002, horizontal forwardly extending planes 1054 that intersect outer edges of outermost horizontally arranged light sources 102 defining a light source bank 1002, and that perpendicularly intersect printed circuit board 1020, as depicted in FIG. 4 and FIG. 5D, can substantially intersect horizontally extending peripheral edges of light entry surface 109 of light pipe 110. In one example of a light pipe, e.g., light pipe 110, being aligned to a light source bank 1002, vertical forwardly extending planes 1056 that intersect outer edges of outermost vertically arranged light sources 102 defining a light source bank 1002, and that perpendicularly intersect printed circuit board 1020, as depicted in FIG. 4 and FIG. 5D, can substantially intersect vertically extending peripheral edges of light entry surface 109 of light pipe 110.

As shown in FIG. 8C, support structure 1502 can be mounted onto circuit board 1020 which can have mounted thereon various source banks 1002, 1002B, 1002C and 1002D at respective light source bank carrying regions 1050 of printed circuit board 1020. As shown in FIGS. 9H and 9I, support structure 1502 can include e.g., sidewall structural members and one or more front planar structural member as shown that defines cavities 1504. The one or more front planar structural member defining cavities 1504 can be planar and can extend in a plane that extends in parallel with the plane of printed circuit board 1020 for light source banks 1002, 1002B, 1002C, and 1002D.

In one aspect there is described in reference to FIG. 9F, the mounting assembly comprising support structure 1502 and light pipe mounts 1602 can facilitate independent mounting of light pipe 110 and light pipe 110B which commonly project excitation light rays from their respectively associated light source banks 1002, 1002B into a common lens 114 carried by light pipe mount 1602 on support structure 1502 and separately and independently mounting second light pipe 110B carried by light pipe mount 1602 on support structure 1502.

Mounting of a light pipe 110 to be aligned forwardly of light source bank 1002 can include attaching light pipe 110 to light pipe mount 1602 and then attaching light pipe mount 1602 with light pipe attached thereto to support structure 1502.

An example of an attachment of a light pipe 110 to a light pipe mount 1602 is set forth in reference to FIGS. 9A-9G, where FIGS. 9E-G depict an alternative example relative to the example of FIG. 9A-9D. Attaching a light pipe 110 to a light pipe mount 1602 can include (a) attaching a replaceable mirror (not shown) on a distal planar surface 1606F of light pipe mount 1602, (b) placing removable pin 1616 in the depicted pin hole 1665 of light pipe mount 1602, (c) placing light pipe 110 on the light pipe mount 1602, and benching light pipe against pin 1616, (d) turning on an autocollimator (not shown) that is aligned to central axis 1106 of light pipe 110, (e) moving the light pipe 110 while observing the output of the autocollimator, (f) adhering the light pipe 110 on the alignment mount with an appropriate adhesive when the output of the autocollimator indicates that alignment is achieved (the selected adhesive can have an index of refraction emulating air to match the default light pipe outer boundary index of refraction), (g) removing the removable mirror and the removable pin. Stages (a)-(g) can be repeated for each light pipe, e.g., light pipe 110, 110B, 110C, 110D.

Light pipe mount 1602 as shown in FIG. 9A-9G can include base 1604 and extended section 1606, which extended section 1606 can extend forwardly from base 1604. Base 1604 can include a mounting surface 1604M, as shown, that extends in plane 1612. In another aspect, central axis 1608 of extended section 1606 can extend at a right angle with respect to plane 1612. In another aspect, extended section 1606 can include light pipe mounting section surface 1610, which can be configured to receive light pipe 110 for mounting thereon. Surface 1610 can be a planar surface established at an angle matching an angle of light pipe 110 so that surface 1610 registers light pipe 110 in a manner that axis 106 of light pipe 110 extends perpendicularly relative to light source carrying circuit board 1020.

Base 1604 can include a top surface 1605 and extended section 1606 can include top surface 1610 defined as a planar surface. For mounting of light pipe 110 on light pipe mount 1602, light pipe 110 can be rested upon light pipe mount 1602. In particular, light pipe 110 can be rested upon light pipe mount 1602 by contacting a first section of light pipe 110 on base surface 1605 and a second section of light pipe 110 on planar surface 1610 of extended section 1606. The first section of light pipe 110 can be a certain external side surface of light pipe 110, approximately mid length of light pipe 110. The second section of light pipe 110 can be the certain external side surface of light pipe 110 proximate light exit surface 111 of light pipe 110. The first section of light pipe 110 can contact base 1604 along line 1605L defined by top surface 1605 of base 1604. In one aspect, extended section 1606 can include and be configured so that light pipe mounting surface 1610 of extended section 1606 is a planar surface is angled with respect to central axis 1608 at a specified angle that matches the angle of the depicted side surface of light pipe 110, with respect to central axis 1106 of light pipe 110. Thus, arranged as described, light pipe 110 when rested upon light pipe mount 1602, can be held at an angle such that central axis 1106 of light pipe 110 extends parallel with central axis 1608 of extended section 1606 of light pipe mount 1602 and further such that central axis 1106 of light pipe 110 extends perpendicularly relative to printed circuit board 1020 when the light pipe is mounted for alignment relative to light source bank 1002

For securing light pipe 110 on light pipe mount 1602 an appropriate adhesive can be applied to surface 1610 of extended section 1606 prior to resting of light pipe 110 on surface 1610, with adhesive applied as described. The selected adhesive can have an index of refraction emulating air to match the default light pipe outer boundary index of refraction. Light pipe 110 can be securely attached to light pipe mount 1602 when light pipe 110 is rested upon light pipe mount 1602 with an output of the described autocollimator indicating that the light pipe is aligned with respect to light pipe mount 1602. Arranged as described, there is restricted mechanical contact between light pipe mount 1602 and light pipe 110. In the described arrangement wherein light pipe 110 can include six planar sides, the described light pipe mount 1602 may contact the light pipe 110 on only one of the sides.

Restricting the points of contact to light pipe 110 by mounting features can improve irradiance at detector surface 206 resulting from energization of light energy exciter 10. In one aspect, restricting points of contact to light pipe 110 can reduce light scattering resulting from inconsistencies in the light pipe exterior boundary composition (default air in the described example) of the light pipe 110. In another aspect, restricting contact with light pipe 110 can reduce deformations to light pipe 110 resulting from mechanical forces.

In one aspect, cavities 1504 of support structure 1502 can have diameters larger than a diameter of a light pipe 110. In such manner, a light pipe 110 can be accommodated within cavity 1504 without contacting of light pipe 110 to a sidewall of support structure 1502 defining cavity 1504 so that points of contact with light pipe 110 are reduced. Cavities 1504 can define sidewall perimeters of 360 degrees as shown in the views. In some examples, cavities 1504 can have sidewall perimeters of less than 360 degrees.

Examples herein recognize that for maximizing irradiance resulting from operation of light energy exciter 10, central axis 1106 of light pipe 110 can be aligned perpendicularly with the plane of printed circuit board 1020 and can also be aligned in parallel with central axis 1060 of lens 114 as shown in FIG. 8I. For achieving the described alignment, light pipe mount 1602 can include angled planar surface 1610 so that central axis 1106 of light pipe 110 extends in parallel with a central axis 1608 of extended section 1606 when light pipe 110 is rested on planar surface 1610. Angled planar surface 1610 can be provided to match an angle of light pipe 110 so that when light pipe 110 is rested upon angled planar surface a central axis 1106 of light pipe 110 extends in parallel with a central axis 1608 of extended section 1606.

Mounting light pipe 110 to be aligned with light source bank 1002 can include (i) removably attaching the light pipe mount 1602 with light pipe 110 attached to support structure 1502. The removably attaching can be performed with use of the threaded screws as shown in FIGS. 9H-9K. For mounting, of the light pipe mount 1602 light pipe 110 can be fitted into cavity 1504 defined by support structure 1502 and surface 1604M of base 1604 can be benched onto a planar structural member of support structure 1502 defining cavity 1504. With the light pipe 110 fitted into cavity 1504 and with light pipe mount 1602 benched onto the planar surface of support structure 1502, the illustrated screws can be tightened. All of the light pipes 110, 110B, 110C, 110D can be mounted in a similar manner.

With light pipe mount 1602 attached to support structure 1502, a gap distance, G, as shown in FIG. 5J can be defined between top surface of light sources 102 and a light entry surface of light pipe 110. Index matching gel can be used to fill the gap of gap distance, G, between the light sources 102 and the light pipe light entry surface. Gap distance, G, can be from about 10 microns to about 1000 microns, and in one example, can be about 15 microns.

The gap between light sources 102 and light pipe 110 can be filled with material formation 1202 provided by index matching gel which can match an index of refraction of light pipe 110. Examples herein recognize that designing light pipes 110-110D to define gaps of gap distance, G, when mounted on support structure 1502 can provide alignment advantages as alignment can be less dependent on manufacturing tolerances involving a height of light sources. In some examples, surface coupling of light pipe 110 to light sources 102 can be advantageous.

With one or more of light pipes 110-110D attached to support structure 1502, mounting of light pipes can include (ii) completing attachment of additional elements of light energy exciter 10, including lens 114 and orienting the light energy exciter 10 to project illumination patterns matching respective ones of detector surfaces 206-206D (FIG. 8D). With additional elements of light energy exciter 10 attached, mounting of light pipes 110-110D can include (iii) reading out signals from arrays of light sensors 202 (light sensor arrays 201) having detector surfaces 206-206D to ascertain whether signals indicate that the various illumination patterns exhibit threshold satisfying irradiance, threshold satisfying uniformity and threshold satisfying consistency between the illumination patterns. If the signal check of (iii) indicates that the illumination patterns result in insufficient irradiance of detector surfaces 206-206D, or are not sufficiently uniform or consistent between one another, mounting of light pipes 110-110D can include (iv) disassembling and re-mounting one or more of the light pipes and performing again the stages (ii)-(iii). Disassembly of light pipes can be facilitated by light pipe mounts 1602 being removably attachable with support structure 1502, e.g., with use of mechanical screws as set forth herein.

Examples herein recognize that to facilitate precise alignment of light pipe 110 and light pipe 110B the described mounting assembly can provide for independent mounting of light pipe 110 and light pipe 110B. Providing for independent mounting of light pipe 110 and light pipe 110B can facilitate precision alignment of the respective light pipes 110, 110B to their respective light source banks 1002, 1002B, to lens 114 that light pipes 110, 110B share, and to each other.

Examples herein recognize that various manufacturing constraints and tolerances can present challenges to alignment of light pipes 110 and 110B. Examples herein recognize that wherein light pipes 110 and 110B are to be surface coupled herein with respect to light sources 102, manufacturing tolerances can present challenges. For example, due to manufacturing tolerances, the first light source bank 1002 can extend fractionally longer than light source bank 1002B and if each light source forming light source bank 1002 and light source bank 1002B is surface coupled to its respective light pipe 110, 110B, the different heights of the light sources between light source banks 1002, 1002B can produce inconsistencies between the mounting arrangements of the two light pipes. Accordingly, in one aspect, in the described mounting assembly by pipe 110 and 110B can each be mounted with a gap distance, G, between the light pipe entry surface and a light source bank as shown in FIG. 5J. Thus, alignment is not restricted by manufacturing tolerances resulting from one light source bank extending more forwardly than another light source bank for example. While providing a light pipe to be spaced apart from a light source bank can provide advantages it can be advantages in some application to surface couple light pipes 110-110D to light sources of their respective light source banks.

In one aspect, the mounting assembly shown in FIGS. 9A-9K can facilitate independent mounting of a first light pipe 110 and the second light pipe 110B. According to one example, the described mounting assembly of FIGS. 9A-9K mounts light pipe 110 so that the light pipe entrance surface 110 is spaced apart, by gap distance, G, from the light sources of light source bank 1002 and mounts second light pipe 110B so that the light entrance surface of the second light pipe 110B is spaced apart, by gap distance, G, from the light sources of second light source bank 1002B.

In one aspect of being independently mounted, first light pipe 110 as shown in FIGS. 9H and 9I attached to light pipe mount 1602 can be mounted onto support structure 1502 and then a second light pipe 110B attached onto light pipe mount 1602 can be mounted on support structure 1502 as shown in FIG. 9I.

Light pipe mounts 1602 carrying respective light pipes 110, 110B can be removably attached to support structure 1502. Namely, each light pipe mount 1602 carrying a light pipe 110, 110B can be attached in a manner as to be removable. Removeable attachment of light pipe mounts 1602 to support structure 1502 can be performed with use of the mechanical screws as shown in FIG. 9H and 9I. Thus, on the determination that light pipe 110 and/or 110B is misaligned, a light pipe mount 1602 can be easily removed for precision re-mounting of first light pipe 110 and/or second light pipe 110B be in relation to the respective light source banks 1002 and 1002B.

A mounting assembly for mounting a light pipe 110-110D in relation to respective light source banks can include support structure 1502 that can include at least one sectional member extending forwardly from a light source bank and light pipe mount 1602, which are shown a detailed view of FIGS. 9A-9G. In general, for mounting of first and second light pipes in relation to their respective light source banks, a first light pipe 110 attached to a light pipe mount 1602 can be mounted to support structure 1502 and then a second light pipe 110B attached to its light pipe mount 1602 can be independently mounted to support structure 1502. For mounting a light pipe 110, 110B to support structure 1502 the mounting can be performed without contacting of light pipe 110, 110B to support structure 1502. Rather, for mounting of a light pipe 110, 110B to support structure 1502, contact can be made between light pipe mounts 1602 carrying a light pipe 110, 110B, and support structure 1502 without there being contact between a light pipe 110, 110B and support structure 1502.

The independent mounting of first and second light pipes 110 and 110B to support structure 1502 can provide various advantages. For example, the arrangement facilitates the alignment of the respective first and second light pipes 110 and 110B to lens 114 and also facilitates precision alignment of the first light pipe 110 to the second light pipe 110B, the precision alignment facilitating adjusting of the precision alignment after an initial mount. For example, if after initial alignment and mounting, it is discovered that the first and second light pipes 110, 100B are misaligned to each either or to their respective light source bank 1002, 1002B, or to lens 114 (e.g., by observing signals read out from one or more of the detectors 200-200D), the mounting assembly described facilitates readjustment of the positioning of the light pipe. The readjusting can be facilitated by the independent mounting arrangement in which a first light pipe 110 is independently mounted relative to second light pipe 110B. Examples herein recognize that where light energy exciter 10 includes multiple light pipes 110, 110B performance of light energy exciter 10 can be negatively impacted by light pipes 110, 110B being misaligned to one another. For example, a slight misalignment between light pipes 110, 110B can cause inconsistencies in the irradiances between first and second detector surfaces 206, 206B resulting in misreads (the system 100 can fail to detect emissions from a detector surface where the irradiance of the detector surface is below a threshold).

Precision readjustment of the alignment of one or more light pipes 110-110D can also be facilitated by the mounting being provided to be removably mounted. In one aspect, light pipe mounts 1602 can be provisioned to be removably mounted to support structure 1502. Thus, in the case that misalignment is observed after initial mounting of a light pipe mount 1602 carrying a light pipe 110, mounting can be undone and then redone by describe removable replacement feature. Removable replacement of a light pipe mount 1602 can be accomplished in one example, with use of threaded mechanical screws which can be loosened to facilitate readjustment of a light pipe mount 1602 after an initial mounting of a light pipe mount 1602. Readjusting can include removing and reattaching a same light pipe to a same light pipe mount, reattaching a different instance of a light pipe to a light pipe mount, or providing a replacement mount 1602 having a different mount 1602 and different instance of a light pipe providing the readjusted light pipe, e.g., light pipe 110 and/or light pipe 110B.

The described mounting assembly of FIGS. 9A-9K can include various registration features for improved alignment of light pipes 110, 110B when light pipes 110, 110B carried by respective light pipe mounts 1602 are mounted on support structure 1502. As shown in FIGS. 9A-9K, support structure 1502 and light pipe mount 1602 can have complementary vertically extending sidewalls 1502Z and 1602Z that engage one another, and complementary horizontally extending sidewalls 1502X and 1602X that engage one another, when light pipe mount 1602 in mounted to support structure 1502. Vertically extending sidewalls 1502Z and 1602Z can extend in the depicted Z-Y plane, and horizontally extending sidewalls 1502X and 1602X can extend in the depicted X-Y plane. When light pipe mount 1602 is mounted onto support structure 1502, a vertically extending sidewall 1602Z engages a vertically extending sidewall 1502Z, and simultaneously, horizontally extending sidewall 1602X engages a horizontally extending sidewall 1502X of support structure 1502. The described sidewall engagement can restrict rotation of a mounted light pipe 110, 110B about its central axis 1106 after mounting of light pipe 110, 110B. In another aspect, as best seen in FIGS. 9J and 9K, at horizontally extending sidewalls 1502X can include voids 1502V at ends thereof joining vertically extending sidewalls 1502Z. Voids 1502V permit light pipe mounts 1602 to be grasped by precision instrumentation for mounting and/or removal.

In a further aspect, as best seen in FIGS. 9J and 9K, the light pipe mount 1602 (left side) can be mounted to support structure 1502 at a first location of support structure 1502 and the second light pipe mount 1602 can be mounted to support structure 1502 at a second location of support structure 1502. The first location can be on a first side (e.g., bottom side) of support structure 1502 relative to horizontal axis 1506 extending through light pipes 110, 100B at an elevation of support structure 1502. The second location can be on a second opposite side (e.g., top side) of support structure 1502 relative to horizontal axis 1506 extending through light pipes 110, 100B at an elevation of support structure 1502. In the described arrangement of FIGS. 9J and 9K, mount 1602 carrying light pipe 110 contacts light pipe 110 on a first side (bottom side) of light pipe 110, and mount 1602 carrying light pipe 110B carrying light pipe 110B contacts light pipe 110B on the second opposite side (top side) of light pipe 110B. The arrangement shown and described in FIG. 9J and FIG. 9K can improve positional stability and alignment of light pipe 110 and light pipe 110B at least for the reason that the arrangement permits increase of size in the width (X direction) of mount 1602 for light pipe 110 and mount 1602 for light pipe 110B as depicted in FIG. 9K relative to the case where mounts 1602 are mounted on a common side of support structure 1502 relative to horizontal axis 1506. The arrangement shown and described in FIG. 9J and FIG. 9K can also improve the accessibility of mounts 1602, to facilitate easier mounting of light pipe mounts 1602, and removal of the same where removal and re-mounting would be beneficial as set forth herein. The arrangement shown and described in FIG. 9J and FIG. 9K can also facilitate more even distribution of holding forces for holding of a light pipe 110, 110B (e.g., even distribution of holding forces between a left side of a light pipe and a right side).

In the example of FIG. 8I light energy exciter 10 can include light pipe 110 as set forth herein and second light pipe 110B. Light pipe 110 can be surface coupled to a first light source 102A, e.g., provided by an LED and light pipe 110B can be surface coupled to a second light source 102B, e.g., provided by second LED. Light source 102A and light source 102B can be configured to emit light in the same wavelength band or different wavelength bands. Lens 114 can be configured to image object plane 112 defined at light exit surface 111 of light pipe 110 and second light pipe 110B onto image plane 130 which can be defined on detector surface 206. Thus, light energy exciter 10 can project first and second separate illumination patterns 107 and 107B onto detector surface 206, which can be advantageous in the case a biological or chemical test designer wishes to separate a detector surface 206 into separate test areas. According to one example, a test designer can specify that a test is to be performed using a first detector according to detector 200 and a second detector according to detector 200 and system 100 can be configured so that light energy exciter 10 projects the illumination areas 107 and 107B (patterns) onto separate detector surfaces 206 respectively of the first and second different detectors 200.

There is set forth herein a light energy exciter 10, having a light source 102A and a second light source 102B, wherein the light pipe 110 receives excitation light from the light source 102A, and wherein the exciter comprises a second light pipe 110B housed in a common housing 134 with the light pipe 110, wherein the second light pipe 110B receive the excitation light from the second light source 102B, wherein the light pipe 110 and the second light pipe 110B propagate the excitation light emitted from the first light source 102A and the second light source 102B, respectively, and wherein the light energy exciter 10 shapes the excitation light propagating, respectively, through the light pipe 110 and the second light pipe 110B to define first and second separate illumination areas 107 and 107B (patterns).

The configuration as shown in FIG. 8I can define an optical axis 106 and a second optical axis 106B. In the single channel system as set forth in FIGS. 2-7, optical axis 106 can be co-located with a central axis 1060 of lens 114. In the example of FIG. 8I each of optical axis 106 and optical axis 106B can be offset and parallel to central axis 1060 of lens 114. Each of light pipe 110 and light pipe 110B can define a diverging cone of light 1100 and 1100B respectively having the divergence angle characteristics of diverging cone of light 1100 described with reference to the ray trace diagram (single channel system) described with reference to FIG. 3.

Lens 114 can define respective converging cones of light 1400 and 1400B having the convergence angle characteristics of converging cone of light 1400 described with reference to the ray trace diagram (single channel system) described with reference to FIG. 3. In the examples of FIGS. 8A-8H (see FIG. 8A-8B), optical axes 106, 106B, 106C, 106D can be defined respectively, by light pipes 110, 110B, 110C, 110D, aligned to respective light source banks 1002, 1002B, 1002C, 1002D. Central axes 1106, 1106B, 1106C, 1106D of light pipes 110, 110B, 110C, 110D can define respective optical axes 106, 106B, 106C, 106D and can be co-located with respective optical axes 106, 106B, 106C, 106D.

In the example of FIG. 8A-8H light energy exciter 10 can include light pipe 110 as set forth herein and second light pipe 110B. Light pipe 110 can be coupled to a first light source bank 1002, light pipe 110B can be coupled to a second light source bank 1002B, light pipe 110C can be coupled to third light source bank 1002C, and light pipe 110D can be coupled to fourth light source bank 1002D. Lens 114 can be configured to image an object plane defined at a light exit surface 111 of light pipe 110 and light exit surface 111 second light pipe 110B onto image plane 130 which can be defined on detector surface 206, and detector surface 206B respectively. Lens 114B can be configured to image an object plane 112 defined at a light exit surface 111 of light pipe 110C and light exit surface 111 light pipe 110D onto an image plane which can be defined on detector surface 206C, and detector surface 206D respectively. Thus, light energy exciter 10 can project first, second, third, and fourth separate illumination patterns configured as shown by illumination pattern 107 and illumination pattern 107B (FIG. 8I) onto detector surface 206, detector surface 206B, detector surface 206C, and detector surface 206D respectively. In one example according to FIG. 8A-8I light energy exciter 10, the optical system defined by light pipes 110 and 110B in combination with lens 114 can feature ray traces according to the optical system of FIG. 81, and the optical system defined by light pipes 110C and 110D in combination with lens 114B can feature ray traces according to the optical system of FIG. 8I.

According to one example, light pipe 110 and light pipe 110B for defining first and second illumination channels can be included in a set of interchangeable modules 133 as set forth herein that can be interchangeably installed into a defined holder of housing 134 of light energy exciter 10 indicated by dashed line 132 described in connection with FIG. 2. As shown throughout several of the views, light energy exciter 10 can be mounted on a heat sink 702 for drawing heat away from light energy exciter 10 to improve the performance of light energy exciter 10. Heat sink 702 can comprise an appropriate metal, e.g., copper or aluminum, and can include fins as shown throughout the views. System 100 can include a fan (not shown) to blow air on the illustrated fins for heat removal.

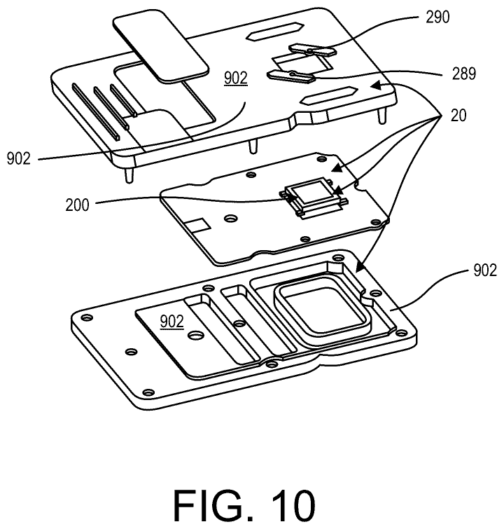

Flow channel 282 can be defined by flow cell frame 902, as shown in FIG. 10, illustrating a perspective assembly physical form view of flow cell frame 902 defining flow channel 282. Flow cell frame 902 for example can include sidewalls 284 and flow cover 288 as depicted in the schematic view of FIG. 1A.

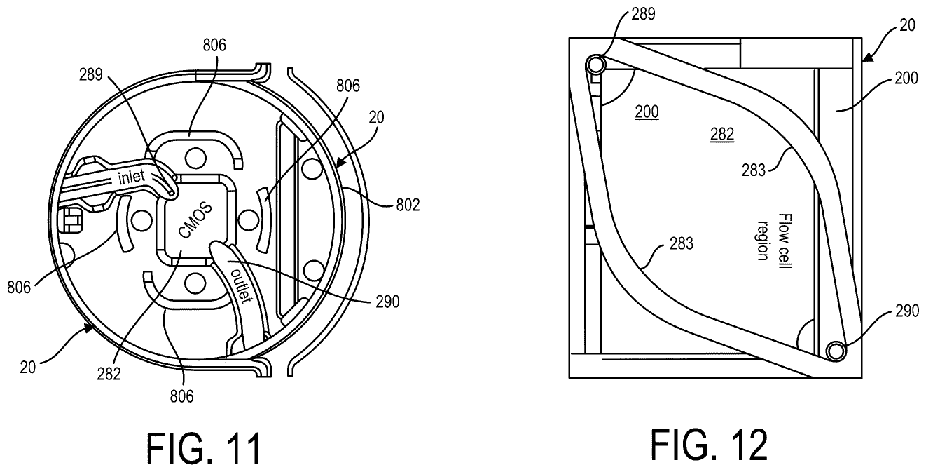

FIG. 11 illustrates construction detail illustrating internal components of cartridge 802 of detector assembly 20. Cartridge 802 as shown in FIG. 11 can be configured to include physical registration features 806 which aid in the alignment of light energy exciter 10 to detector 200. As shown in FIGS. 10 and 11, detector 200 is shown as being located in a location that is established by flow cell frame 902 having detector 200 and flow channel 282. Physical registration features 806 can be provided to catch corresponding features of light energy exciter 10 that are defined by a distal end portion of housing 134 of light energy exciter 10. For coupling light energy exciter 10 to detector assembly 20 and detector 200, a distal end portion of housing 134 (FIG. 2) of light energy exciter 10 can be inserted into a receptacle of cartridge 802 of detector assembly 20 and arranged so that at a distal end of housing 134 of light energy exciter 10 is registered with corresponding registration features 806 as shown in FIG. 11 so that light energy exciter 10 is properly aligned with flow channel 282 and detector 200 as shown in FIG. 1A.

FIG. 12 illustrates a top view of a flow channel 282 disposed over detector 200.

According to one example as shown in FIG. 12 flow channel 282 can include sidewalls 283 that shape flow channel 282 so that biological or chemical reactions to be detected occur over less than all light sensors 202. Detector 200 according to one example can include an array of 14M of light sensors which can be regarded as pixels and flow channel 282 can be configured by flow cell sidewalls 283 so that about 8M of light sensors 202 are used during a biological or chemical test.

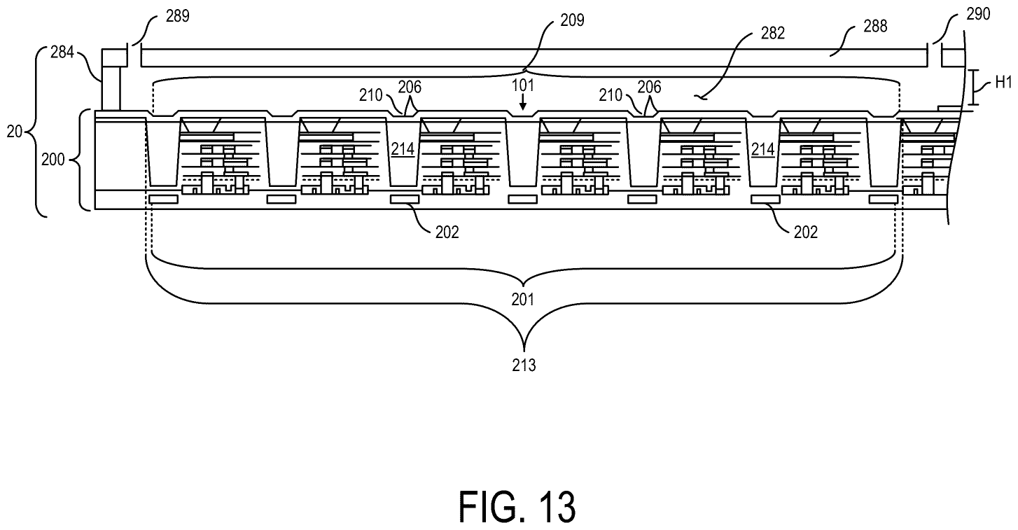

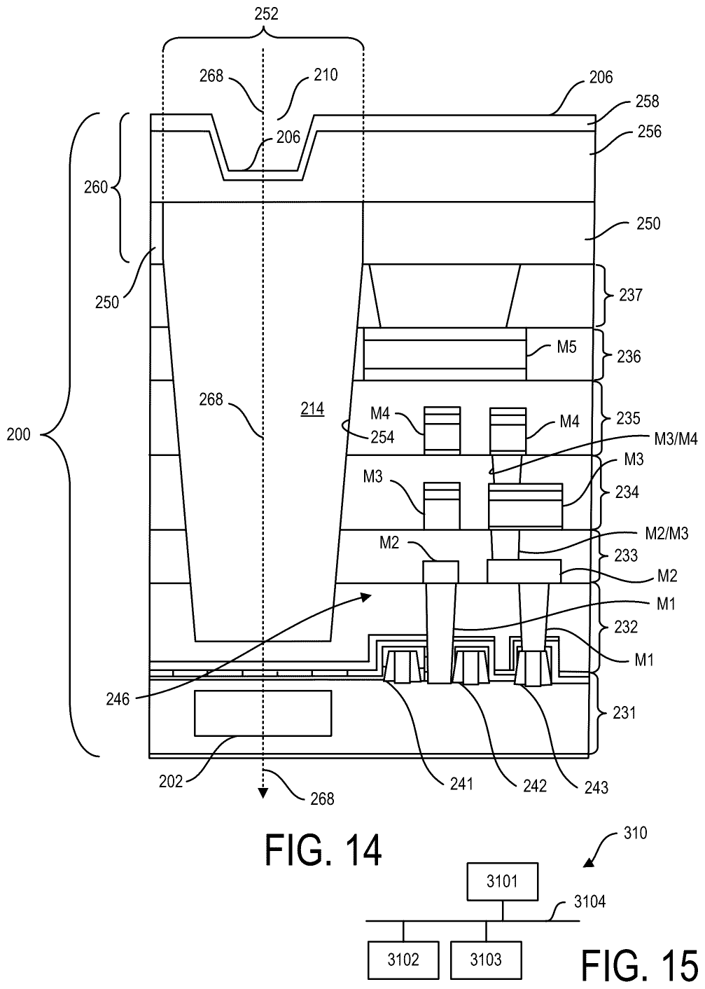

FIGS. 13 and 14 illustrate further details of detector assembly 20 and detector 200 according to one example that can be used with light energy exciter 10.

In the illustrated example shown in FIG. 13, flow channel 282 is defined by detector surface 206 sidewall 284 and a flow cover 288 that is supported by the sidewall 284 and other sidewalls (not shown). The sidewalls can be coupled to the detector surface 206 and can extend between the flow cover 288 and the detector surface 206. In some examples, the sidewalls are formed from a curable adhesive layer that bonds the flow cover 288 to detector 200.

The flow channel 282 can include a height H1. By way of example only, the height H1 can be between about 50 μm to about 400 μm or, more particularly, about 80 μm to about 200 μm. The flow cover 288 can include a material that is light transmissive to excitation light 101 propagating from an exterior of the detector assembly 20 into the flow channel 282.

Also shown, the flow cover 288 can define inlet portal 289 and outlet portal 290 that are configured to fluidically engage other ports (not shown). For example, the other portals can be from a cartridge (not shown) or a workstation (not shown).

Detector 200 can include a light sensor array 201 of light sensors 202, a guide array 213 of light guides 214, and a reaction array 209 of reaction recesses 210. Aligned structural components of detector 200 can share common pixel positions as explained in reference to FIG. 1B. In certain examples, the components are arranged such that each light sensor 202 aligns with a single light guide 214 and a single reaction recess 210. However, in other examples, a single light sensor 202 can receive photons through more than one light guide 214. In some examples there can be provided more than one light guide and/or reaction recess for each light sensor of a light sensor array.

In some examples there can be provided more than one light guide and/or light sensors aligned to a reaction recess of a reaction recess array. The term “array” does not necessarily include each and every item of a certain type that the detector 200 can have. For example, the light sensor array 201 of light sensors 202 may not include each and every light sensor of detector 200. As another example, the guide array 213 may not include each and every light guide 214 of detector 200. As another example, the reaction array 209 may not include each and every reaction recess 210 of detector 200. As such, unless explicitly recited otherwise, the term “array” may or may not include all such items of detector 200.

Detector 200 has a detector surface 206 that can be functionalized (e.g., chemically or physically modified in a suitable manner for conducting designated reactions). For example, the detector surface 206 can be functionalized and can include a plurality of reaction sites having one or more biomolecules immobilized thereto. The detector surface 206 can have a reaction array 209 of reaction recesses 210. Each of the reaction recesses 210 can include one or more of the reaction sites. The reaction recesses 210 can be defined by, for example, an indent or change in depth along the detector surface 206. In other examples, the detector surface 206 can be substantially planar.

FIG. 14 is an enlarged cross-section of detector 200 showing various features in greater detail. More specifically, FIG. 14 shows a single light sensor 202, a single light guide 214 for directing emissions signal light 501 toward the light sensor 202, and associated circuitry 246 for transmitting signals based on emissions signal light 501 (e.g., photons) detected by the light sensor 202. It is understood that the other light sensors 202 of the light sensor array 201 (FIG. 13) and associated components can be configured in an identical or similar manner. It is also understood, however, the detector 200 is not required to be manufactured identically or uniformly throughout. Instead, one or more light sensors 202 and/or associated components can be manufactured differently or have different relationships with respect to one another.

The circuitry 246 can include interconnected conductive elements (e.g., conductors, traces, vias, interconnects, etc.) that are capable of conducting electrical current, such as the transmission of data signals that are based on detected photons. Detector 200 comprises an integrated circuit having a planar light sensor array of the light sensors 202. The circuitry 246 formed within detector 200 can be configured for at least one of read out signals from light sensors 202 exposed during an exposure period (integration period) in which charge accumulates on light sensors 202 in dependence on emission signal light 501 received by light sensors 202, signal amplification, digitization, storage, and processing. The circuitry 246 can collect and analyze the detected emissions signal light 501 and generate data signals for communicating detection data to a bioassay system. The circuitry 246 can also perform additional analog and/or digital signal processing in detector 200. Light sensors 202 can be electrically coupled to circuitry 246 through gates 241-243.

Detector 200 according to one example can be provided by a solid-state integrated circuit detector such as a CMOS integrated circuit detector or a CCD integrated circuit detector. Detector 200 according to one example can be an integrated circuit chip manufactured using integrated circuit manufacturing processes such as complementary metal oxide semiconductor (CMOS) fabrication processes.

The resolution of the light sensor array 201 defined by light sensors 202 can be greater than about 0.5 megapixels (Mpixels). In more specific examples, the resolution can be greater than about 5 Mpixels and, more particularly, greater than about 14 Mpixels.

Detector 200 can include a plurality of stacked layers 231-237 including a sensor layer 231 which sensor layer 231 can be a silicon layer. The stacked layers can include a plurality of dielectric layers 232-237. In the illustrated example, each of the dielectric layers 232-237 includes metallic elements (e.g., W (tungsten), Cu (copper), or A1 (aluminum)) and dielectric material, e.g. SiO₂. Various metallic elements and dielectric material can be used, such as those suitable for integrated circuit manufacturing. However, in other examples, one or more of the dielectric layers 232-237 can include only dielectric material, such as one or more layers of SiO₂.

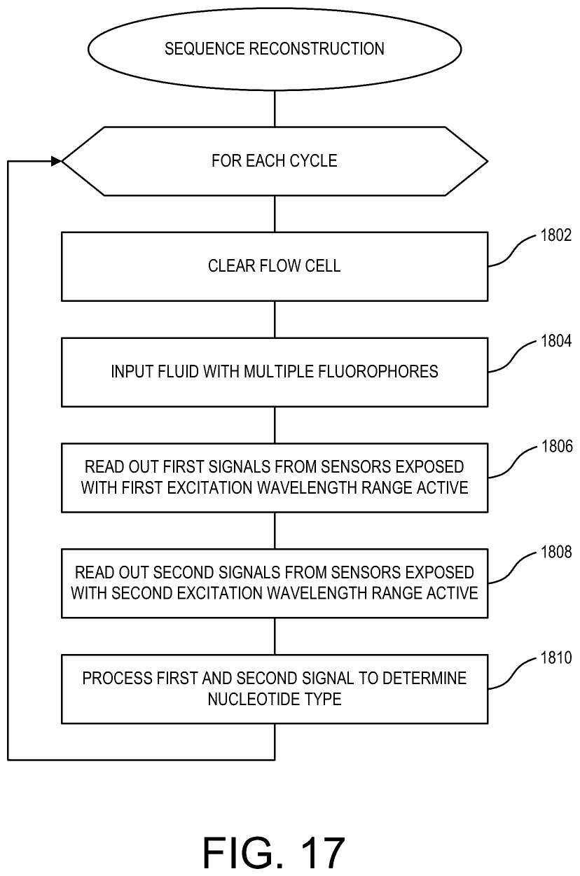

With respect to the specific example of FIG. 17, the dielectric layers 232-237 can include metallization layers that are labeled as layers M1-M5 in FIG. 17. As shown, the metallization layers, M1-M5, can be configured to form at least a portion of the circuitry 246.

In some examples, detector 200 can include a shield structure 250 having one or more layers that extends throughout an area above metallization layer M5. In the illustrated example, the shield structure 250 can include a material that is configured to block the light signals that are propagating from the flow channel 282. The light signals can be the excitation light 101 and/or emissions signal light 501. By way of example only, the shield structure 250 can comprise tungsten (W). By way of specific example only, the excitation light may have a peak wavelength of about 523 nm (green light) or 456 nm (blue light) and emissions signal light 501 can include wavelengths of about 570 nm and longer (FIG. 4).

As shown in FIG. 14, shield structure 250 can include an aperture 252 therethrough. The shield structure 250 can include an array of such apertures 252. Aperture 252 can be dimensioned to allow signal emission light to propagate to light guide 214. Detector 200 can also include a passivation layer 256 that extends along the shield structure 250 and across the apertures 252. Detector 200 can also include a passivation layer 258 comprising detector surface 206 that extends along passivation layer 256 and across the apertures 252. Shield structure 250 can extend over the apertures 252 thereby directly or indirectly covering the apertures 252. Passivation layer 256 and passivation layer 258 can be configured to protect lower elevation layers and the shield structure 250 from the fluidic environment of the flow channel 282. According to one example, passivation layer 256 is formed of or comprises SiN or similar. According to one example, passivation layer 258 is formed of or comprises tantalum pentoxide (Ta₂O₅) or similar. Sample supporting structure 260 having passivation layer 256 and passivation layer 258 can define detector surface 206 having reaction recesses 210. Sample supporting structure 260 defining detector surface 206 can have any number of layers such as one to N layer.

Sample supporting structure 260 can define a solid surface (i.e., the detector surface 206) that permits biomolecules or other analytes-of-interest to be immobilized thereon. For example, each of the reaction sites of a reaction recess 210 can include a cluster of biomolecules that are immobilized to the detector surface 206 of the passivation layer 258. Thus, the passivation layer 258 can be formed from a material that permits the reaction sites of reaction recesses 210 to be immobilized thereto. The passivation layer 258 can also comprise a material that is at least transparent to a desired fluorescent light. Passivation layer 258 can be physically or chemically modified to facilitate immobilizing the biomolecules and/or to facilitate detection of the emissions signal light 501.

In the illustrated example, a portion of the passivation layer 256 extends along the shield structure 250 and a portion of the passivation layer 256 extends directly along filter material defining light guide 214. The reaction recess 210 can be aligned with and formed directly over light guide 214. According to one example each of reaction recess 210 and light guide 214 can have cross sectional geometric centers centered on longitudinal axis 268. Filter material can be deposited in a cavity defined by sidewalls 254 formed in a dielectric stack having stacked layers 232-237.

The light guide 214 can be configured relative to surrounding material of the dielectric stack defined by dielectric layers 231-237 to form a light-guiding structure. For example, the light guide 214 can have a refractive index of at least about 1.6 according to one example so that light energy propagating through light guide 214 is substantially reflected at an interface at sidewalls 254 between light guide 214 and the surrounding dielectric stack defined by dielectric layers 231-237. In certain examples, the light guide 214 can be configured such that the optical density (OD) or absorbance of the excitation light is at least about 4 OD. More specifically, the filter material can be selected and the light guide 214 can be dimensioned to achieve at least 4 OD. In more particular examples, the light guide 214 can be configured to achieve at least about 5 OD or at least about 6 OD. In more particular examples, the light guide 214 can be configured to achieve at least about 7 OD or at least about 8 OD. Other features of the detector 200 can be configured to reduce electrical and optical crosstalk.

In reference to FIG. 15, further details of process control system 310 are described. Process control system 310 can include according to one example one or more processors 3101, memory 3102, and one or more input/output interface 3103. One or more processors 3101, memory 3102 and one or more input/output interface can be connected via system bus 3104. According to one example process control system 310 can be provided by a computer system as set forth in FIG. 15. Memory 3102 can include a combination of system memory and storage memory. Memory 3102 according to one example can store one or more programs for facilitating processes that are set forth herein. One or more processors 3101 can run one or more programs stored in memory 3102 to facilitate processes as is set forth herein. Memory 3102 can define a computer readable medium.

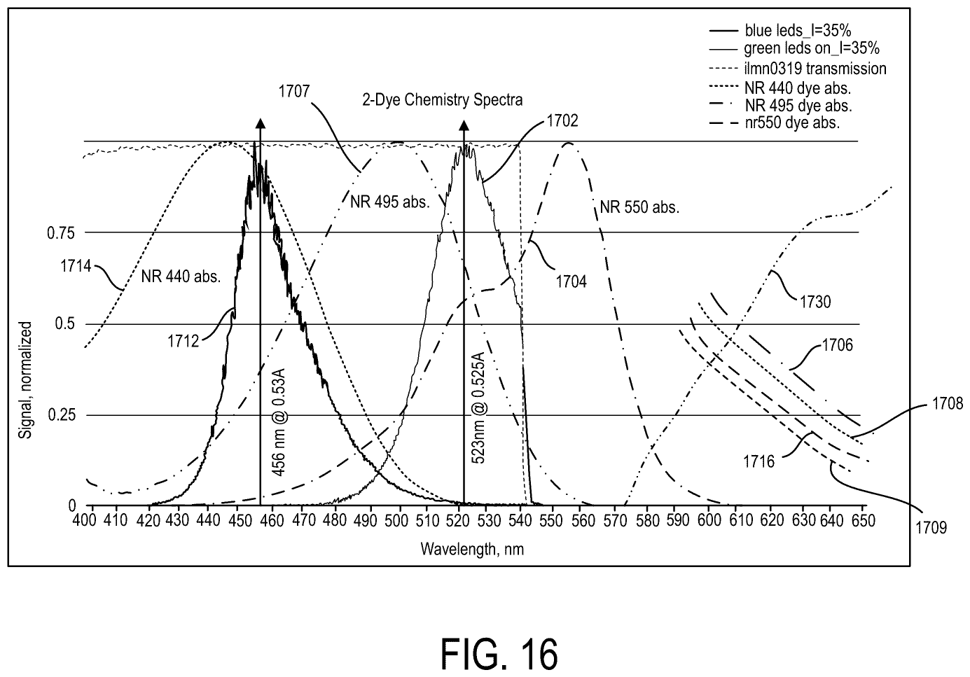

A DNA sequencing process facilitated by light energy exciter 10 is described with reference to FIGS. 16 and 17. Referring to FIG. 16, there is shown a spectral profile coordination diagram illustrating aspects of the operation of system 100. According to one example light source bank 1002 can include light sources that emit light at first and second different wavelengths. Providing light source bank 1002 to include light sources that emit excitation light at first and second different wavelength ranges facilitates dye chemistry DNA sequence reconstruction processes in which first and second dyes can be disposed in fluid within flow channel 282.

Spectral profile 1702 shown in FIG. 16 illustrates an excitation wavelength emission band of a green emitting light source of light energy exciter 10, e.g., such as light source 102A as shown in FIG. 4. Spectral profile 1712 is the wavelength emission band of a blue emitting light source of light energy exciter 10 such as light source 102H as shown in FIG. 4. Spectral profile 1704 is the absorption band spectral profile of a first fluorophore sensitive to green light that can be disposed with fluid into flow channel 282. Spectral profile 1714 is the absorption band spectral profile of a second fluorophore sensitive to blue light that can be disposed with fluid into flow channel 282. Spectral profile 1707 is the absorption band spectral profile of a third fluorophore sensitive to green light and blue light that can be disposed with fluid into flow channel 282.

Spectral profile 1706 is the partial spectral profile of emissions signal light 501 attributable to the first fluorophore fluorescing when excited by green light having spectral profile 1702. Spectral profile 1716 is the partial spectral profile of emissions signal light 501 attributable to the second fluorophore fluorescing when excited by blue light having spectral profile 1712. Spectral profile 1708 is the partial spectral profile of emissions signal light 501 attributable to the third fluorophore fluorescing when excited by green light having spectral profile 1702. Spectral profile 1709 is the partial spectral profile of emissions signal light 501 attributable to the third fluorophore fluorescing when excited by blue light having spectral profile 1712.

Spectral profile 1730 is the transmission spectral profile of light sensors 202 defining light sensor array 201 indicating the detection band of light sensor array 201.

Examples herein recognize in reference to the spectral profile coordination diagram of FIG. 16 that process control system 310 can be configured to (a) determine that the first fluorophore is attached to a sample 502 based on fluorescence being sensed by a light sensor 202 under excitation restricted to excitation by one or more green emitting light sources and fluorescence not being sensed by the light sensor 202 under excitation restricted to excitation by one or more blue emitting light source; (b) determine that the second fluorophore is attached to a sample 502 based on fluorescence being sensed by a light sensor 202 under excitation restricted to excitation by one or more blue emitting light sources and fluorescence not being sensed by the light sensor 202 under excitation restricted to excitation by one or more green emitting light sources; and (c) determine that the third fluorophore is attached to a sample 502 based on fluorescence being sensed by a light sensor 202 under excitation restricted to excitation by one or more green emitting light sources and fluorescence also being sensed by the light sensor 202 under excitation restricted to excitation by one or more blue emitting light sources. Process control system 310 can discriminate which fluorophores have attached to samples, and can determine nucleotide types, e.g. A, C, T, and G that are present in a fragment of a DNA strand providing a sample 502 e.g., using a decision logic data structure indicated by the decision logic table of Table C mapping fluorophore presence to nucleotide type, where discriminated nucleotides Nucleotide-Nucleotide4 are nucleotides of the nucleotide types A, C, T and G (the particular mapping based on the test setup parameters).

TABLE C

| Detected | Detected | | |
|---|---|---|---|
| fluorescence under | fluorescence under | | |
| excitation restricted | excitation restricted | | |
| to excitation by one | to excitation by one | | |
| or more green | or more blue emitting | Fluorophore presence | |
| emitting light sources | light sources | indicated | Nucleotide indicated |
| YES | NO | first Fluorophore | Nucleotide1 |
| NO | YES | second Fluorophore | Nucleotide2 |
| YES | YES | third Fluorophore | Nucleotide3 |
| NO | NO | — | Nucleotide4 |

Process control system 310 can run a process in support of DNA sequence reconstruction in a plurality of cycles. In each cycle, a different portion of a DNA fragment can be subject to sequencing processing to determine a nucleotide type, e.g. A, C, T, or G, associated to the fragment, e.g., using a decision data structure such as a decision data structure as set forth in Table C. Aspects of a process which can be run by process control system 310 for use in performing DNA sequence reconstruction using light energy exciter 10 is described in the flowchart of FIG. 17.

At block 1802 process control system 310 can clear flow channel 282, meaning process control system 310 can remove fluid from flow channel 282 used during a prior cycle. At block 1804, process control system 310 can input into flow channel 282 fluid having multiple fluorophores, e.g., first and second fluorophores, or first, second, and third fluorophores. The first and second fluorophores can include, e.g., the absorption characteristics described with reference to absorption band spectral profile 1704 and absorption band spectral profile 1714 respectively as described in reference to the spectral profile diagram of FIG. 16. First, second, and third fluorophores can include, e.g., the absorption characteristics described with reference to absorption band spectral profile 1704 and absorption band spectral profile 1714 and absorption band spectral profile 1707 respectively as described in reference to the spectral profile diagram of FIG. 16.

At block 1806, process control system 310 can read out signals from light sensors 202 exposed with a first wavelength range excitation active. At block 1806, process control system 310 can control light energy exciter 10 so that during an exposure period of light sensors 202 light energy exciter 10 emits excitation light restricted excitation by one or more green light sources. At block 1806, process control system 310 can during an exposure period of light sensors 202 energize each one or more green emitting light sources of light source bank 1002, e.g., light sources 102A-102G as set forth in FIG. 4, while maintaining in a deenergized state each one or more blue emitting light sources of light bank, e.g. light sources 102H-102J as set forth in FIG. 4. With the light source bank 1002 being controlled as described so that green light sources are on and blue light sources are off during an exposure period of light sensors 202, process control system 310 at block 1806 can read out first signals from light sensors 202 exposed with excitation restricted to excitation by one or more green light sources as set forth herein.

At block 1808, process control system 310 can read out signals from light sensors 202 exposed with a second wavelength range excitation active. At block 1808, process control system 310 can control light energy exciter 10 so that during an exposure period of light sensors 202 light energy exciter 10 emits excitation light restricted to excitation by one or more blue light sources of light energy exciter 10. At block 1808, process control system 310 can during an exposure period of light sensors 202 energize each of one or more blue emitting light sources of light source bank 1002, e.g., light sources 102H-102J as set forth in FIG. 4, while maintaining in a deenergized state each one or more green emitting light sources of light bank, e.g. light sources 102A-102G as set forth in FIG. 4. With the light source bank 1002 being controlled as described so that blue light sources are on and green light sources are off during an exposure period of light sensors 202, process control system 310 at block 1808 can read out second signals from light sensors 202 exposed with excitation restricted to excitation by one or more blue light sources as set forth herein.

At block 1810 process control system 310 for the current cycle can process the first signals read out at block 1806 and the second signals read out at block 1808 to determine a nucleotide type of the DNA fragment being subject to testing during the current cycle, e.g. using a decision data structure as set forth in Table C according to one example. Process control system 310 can perform the described nucleotide identification process described with reference to the flowchart of FIG. 17 for each cycle of the DNA sequencing process until nucleotide identification is performed for each scheduled cycle.

Process control system 310 can be configured to perform a wide range of tests for testing operation of the system 100. Process control system 310 can perform a calibration test in which operation of light energy exciter 10 and detector 200 is tested. In such an example process control system 310 can be configured to selectively energize different lights sources during exposure periods of light sensor array 201 and can examine signals read out of light sensor array 201 during the exposure periods. A method can include selectively energizing a first light source (e.g. green emitting) during a first exposure period of the light sensors with second (blue emitting) and third (e.g. red emitting) light sources maintained in a deenergized state, selectively energizing the second light source during a second exposure period of the light sensors with the first and third light sources maintained in a deenergized state, and selectively energizing the third light source during a third exposure period of the light sensors with the first and second light sources maintained in a deenergized state.

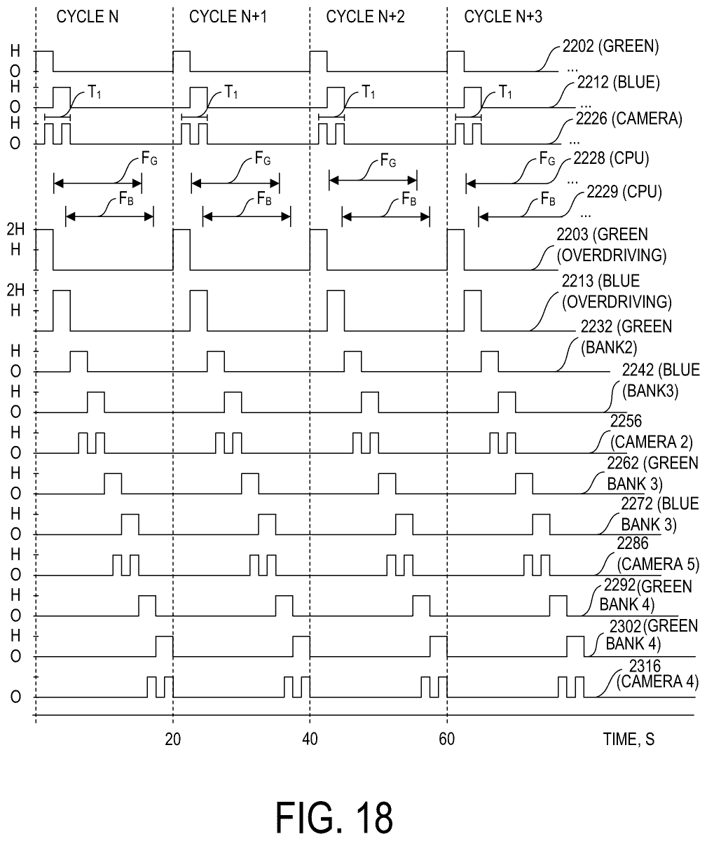

A timing diagram illustrating control of LEDs defining light source bank 1002 is set forth in reference to FIG. 18. The timing diagram of FIG. 18 illustrates coordination between illumination control and camera detector control during successive cycles for performance of sequence reconstruction. Referring to the timing diagram of FIG. 18, control signal 2202 is a control signal illustrating control of green LEDs of light source bank 1002. Referring to control signal 2202, power supply 1210 (FIG. 5B and FIG. 5C) can be controlled to vary current level for driving green LEDs between zero current level and a high current level H.

Green LEDs can be on when the current level is at H and off when the current level is at zero. Control signal 2212 illustrates control of current across blue LEDs of light source bank 1002 over time with control voltage levels varying between zero and the high current level H. The indicated time T1 illustrates on times for LEDs of light source bank 1002 within successive cycles. In some examples, chemistry processes can be performed at time periods intermediate the depicted cycles. In some examples, chemistry processes can be performed at time periods within the depicted cycles.

In the timing diagram of FIG. 18 there are indicated cycles N, N+1, N+2 and, N+3. Control signal 2226 of the timing diagram of FIG. 18 illustrates camera detector control timing. Detector 200 defining one or more light sensor array 201 (camera) defined by an array of light sensors 202 can be controlled with use of exposure control signals and read out control signals.

Referring to control signals 2202, 2212, 2226 as indicated by the timing diagram of FIG. 18, each cycle can comprise about 20 seconds. The illumination on time T1 can comprise about 20% of each cycle. Each cycle can include an illumination on time period T1 followed by a processing period characterized by processing of frames image data read out from detector 200 defining a camera.

Control signal 2226 is a control signal for detector 200 having detector surface 206 (referred to as camera 1). In one example, detector 200 can be configured so that the leading edge of control signal 2226 initiates exposure period of camera 1 and the falling edge of pulses defining control signal 2226 initiates readout of signals from camera 1. Referring to control signals 2202, 2212 and 2226, detector 200 can be controlled to have first and second exposure and readout times for each cycle as is indicated by block 1806 and 1808 of the flow diagram of FIG. 18. Referring to the exposure and readout control depicted by control signal 2226, the first exposure period for each signal can be an exposure period or exposing a first frame in which the emission light 501 results from excitation by green light LEDs in the second exposure period for each cycle can be an exposure period for exposing light sensors of detector 200 with the emission light 501 resulting from excitation by blue light LEDs. Accordingly, the first pulse of each cycle can define a first exposure period of a cycle and the second pulse of each cycle can define a second exposure period of each cycle. Referring to timeline 2228, timeline 2228 depicts processing periods FG for processing a read-out frame of data in which emission signal light 501 resulting from excitation by green light LEDs and processing periods FB depicted by timeline 2229 are processing periods for processing frames of image data read-out from detector 200. Upon being exposed to emission light 501 resulting from excitation by blue light LEDs of light source bank 1002 control signal 2203 depicts alternative control of green light LEDs of light source bank 1002 and control signal 2213 depicts alternative control energization of blue light LEDs of light source bank 1002. According to one example, LEDs defining light source bank 1002 can be overdriven beyond their maximum current rating.

Examples herein recognize that LEDs defining light source bank 1002 can advantageously be driven beyond their factory rated maximum current rating. Control signal 2203 illustrates overdriving of green LEDs and control signal 2213 depicts overdriving blue LEDs. According to control signal 2203 and control signal 2213 overdriving can comprise overdriving of the set of LEDs by application of current of twice a rated maximum current load of an LED. However, overdriving can comprise any current value resulting in LEDs being overdriven, e.g., 3M, 4M wherein M is the maximum rated current. Examples herein recognize that LEDs defining light source bank 1002 can advantageously be overdriven to produce increased irradiance of a detector surface 206-206D provided that the LEDs are controlled to be cooled to safely avoid a maximum LED temperature. Control signal 2203 and control signal 2213 depict LED control, wherein sets of LEDs have on times as well as off times. Examples herein recognize that the presence of off times can facilitate cooling of LEDs.

Control signals 2232, 2242 and 2256 illustrate control of green LEDs of light source bank 1002B, blue LEDs of light source bank 1002B and the detector 200B (camera 2) having detector surface 206B associated to light source bank 1002B.

Control signals 2262, 2272 and 2286 illustrate, respectively, control of green LEDs of light source bank 1002C, blue LEDs of light source bank 1002C, and the light sensor array 201 (camera 3) of detector 200C having detector surface 206C.

Control signals 2292, 2302 and 2316 illustrate, respectively, control of green LEDs of light source bank at D, blue LEDs of light source Bank at D, and detector 200D (camera 4) having detector surface 206D.

The timing diagram of FIG. 18 illustrates that the LEDs of the different light source banks 1002, 1002B, 1002C, 1002D (bank, bank 2, bank 3, bank 4 in FIG. 18) can comprise coordinated timing so that overlapping illumination on times can be avoided, e.g., in one example the LEDs of common wavelength bands between different light source banks can be energized asynchronously. While providing asynchronous timing as shown in FIG. 18 can be advantageous for thermal management, other examples can feature illumination coordination so that illumination on times between light source banks 1002, 1002B, 1002C, 1002D do overlap and in some instances are synchronized to entirely overlap. In one example, all green LEDs from all light source banks 1002, 1002B, 1002C 1002D can be controlled to be on simultaneously during the described cycles, and all blue LEDs from all light source banks 1002, 1002B, 1002C 1002D can be controlled to be on simultaneously during the described cycles. In one example, all green LEDs selectively from light source banks 1002, 1002B can be controlled to be on simultaneously during the described cycles, and all blue LEDs selectively from light source banks 1002, 1002B, can be controlled to be on simultaneously during the described cycles. In one example, all green LEDs selectively from light source banks 1002C, 1002D can be controlled to be on simultaneously during the described cycles, and all blue LEDs selectively from light source banks 1002C, 1002D can be controlled to be on simultaneously during the described cycles.

Referring again to FIG. 8A, the different light source banks 1002, 1002B, 1002C, 1002D can be respectively mounted on different, spaced apart light source bank carrying regions 1050 of printed circuit board 1020. In one example, printed circuit board 1020 can carry a power supply 1210 (LED driver) according to FIG. 5B and/or FIG. 5C for each of the different light source banks 1002, 1002B, 1002C, 1002D. Printed circuit board 1020 can have mounted thereon a first power supply 1210 (LED driver) for driving light source bank 1002, a second power supply 1210 (LED driver) for driving light source bank 1002B, a third power supply 1210 (LED driver) for driving light source bank 1002C, and a fourth power supply 1210 (LED driver) for driving light source bank 1002D. Light energy exciter 10 can employ multiplexing circuitry on printed circuit board 1020 which can reduce the number of LED drivers. In one example, light energy exciter 10 can include fewer power supplies 1210 (LED drivers) than the number of light source banks 1002-1002D and multiplexing can be employed so that the same driver can drive LEDs of different printed circuit boards of spaced apart printed circuit boards 1020 at different times. In one example according to FIG. 18, light energy exciter 10 can include a single power supply 1210 (LED driver). At a first portion of each depicted cycle, the driver can be multiplexed for energization of LEDs of light source bank 1002. At a second portion of each depicted cycle, the driver can be multiplexed for energization of LEDs of light source bank 1002B. At a third portion of each depicted cycle, the driver can be multiplexed for energization of LEDs of light source bank 1002C. At a fourth portion of each depicted cycle, the driver can be multiplexed for energization of LEDs of light source bank 1002D.

In one example, all green LEDs selectively from light source banks 1002, 1002B can be controlled to be on simultaneously during the described cycles, and all blue LEDs selectively from light source banks 1002, 1002B, can be controlled to be on simultaneously during the described cycles, and further in such, all green LEDs selectively from light source banks 1002C, 1002D can be controlled to be on simultaneously during the described cycles, and all blue LEDs selectively from light source banks 1002C, 1002D can be controlled to be on simultaneously during the described cycles. In the described example, light energy exciter 10 can include first and second power supplies (LED drivers). In a first portion of each cycle the first and second drivers can be multiplexed to control all green LEDs of light source bank 1002 and light source bank 100B to be on simultaneously. In a second portion of each cycle the first and second drivers can be multiplexed to control all blue LEDs of light source bank 1002 and light source bank 100B to be on simultaneously. In a third portion of each cycle the first and second drivers can be multiplexed to control all green LEDs of light source bank 1002C and light source bank 100D to be on simultaneously. In a fourth portion of each cycle the first and second drivers can be multiplexed to control all blue LEDs of light source bank 1002C and light source bank 100D to be on simultaneously.

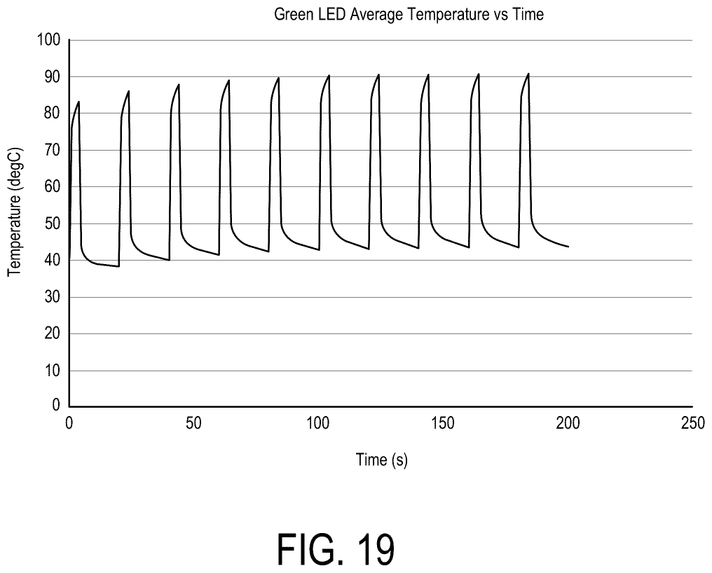

FIG. 19 illustrates cooling of light source bank 1002. FIG. 19 illustrates that an overall cycle can consume about 20 seconds with an illumination on time corresponding to T1 depicted as time T1 of FIG. 18 can comprise about 20% of the time of each cycle. FIG. 18 illustrates that between illumination on times of the light source bank 1002, LEDs can be permitted to cool from a maximum temperature. FIG. 19 illustrates that for the first few cycles maximum temperature of the set of LEDs can be relatively lower and then after a few cycles, the maximum LED temperature can rise to new maximum, e.g., as shown in FIG. 19 an initial maximum LED temperature can be about 83 degrees Celsius whereas after cycle 4 a maximum LED temperature can rise to about 90 degrees Celsius but then after cycle 4 as shown in FIG. 19, the maximum LED temperature can be relatively consistent for each successive cycle with LED temperature falling significantly intermediate of illumination on times.

Referring to the timing diagram of FIG. 18, control signals 2202, 2212 it is seen that an off time for a set of LEDs of light source bank 1002 of a first narrow band wavelength (green light in FIG. 18) can commence at a time when an on time for a set of LEDs of light source bank 1002 of a second narrow band wavelength (blue light in FIG. 18) commences. In one example, control signals 2202, and 2212 can be configured for establishing an ordering of the on times between LEDs of the first and second narrow band wavelengths in a manner depending which LEDs (the LEDs of the first, or alternatively the second) will generate lower total heat as a result of being energized. In one example, a method can include identifying which of a first or second set of narrow band LEDs (e.g., green or blue) of a light source bank 1002 will produce the lowest total heat as a result of being energized for the time period specified in FIG. 18, selecting the determined lowest total heat generating set of narrow band LEDs as the LEDs for initial energization, and controlling the ordering of the energization between the first and second set of narrow band LEDs so that the set of narrow LEDs producing the determined lower total heat are energized prior to the remaining set of the first or second set of narrow band LEDs. The control of LEDs can be performed so that an off time of the selected initially energized set of narrow band LEDs (e.g., blue or green) commences at the commencement of the on time of the secondarily energized set of narrow band LEDs. Examples herein recognize the energizing the set of narrow band LEDs producing the lower total heat first in an ordering between sets of LEDs can improve overall heat removal from a printed circuit board 1020 carrying light source bank 1002. With improved heat removal, LEDs of light source bank 1002 can be driven at higher current for improved irradiance of a detector surface. The determining which of the first or second set of narrow band LEDs produce lower total heat can include examining data output from one or more temperature sensor disposed on a printed circuit board according to printed circuit board 1020 when the first set of narrow band LEDs (e.g., green or blue) is independently driven, and examining data output of temperature sensor disposed on the test printed circuit board according to printed circuit board 1020 when the remaining second set of narrow band LEDs (e.g., green or blue) is independently driven. The printed circuit board according to printed circuit board 1020 on which the one or more temperature sensor can be disposed can be provided by, e.g., a physical lab room board designed according to printed circuit board 1020, a simulated circuit board, or the actual printed circuit board 1020.

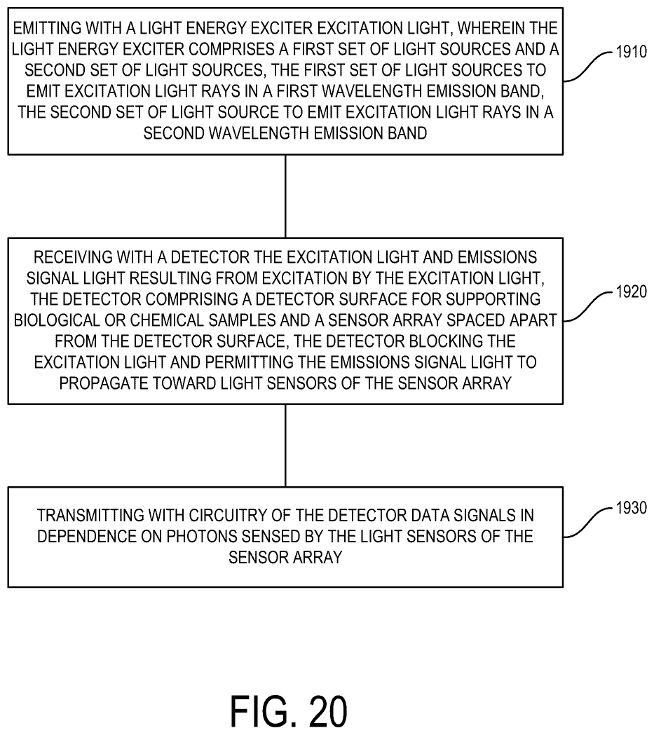

There is set forth herein, with reference to FIG. 20, a method comprising, at block 1910, emitting with a light energy exciter 10 excitation light 101 (e.g., FIG. 1A), wherein the light energy exciter comprises a first set of light sources and a second set of light sources (e.g., FIG. 4), the first set of light sources to emit excitation light rays in a first wavelength emission band, the second set of light source to emit excitation light rays in a second wavelength emission band; at block 1920, receiving with a detector 200 the excitation light 101 and emissions signal light 501 resulting from excitation by the excitation light 10, the detector 200 comprising a detector surface 206 for supporting biological or chemical samples 502 and a sensor array 201 spaced apart from the detector surface 206, the detector 200 blocking the excitation light 101 and permitting the emissions signal light 501 to propagate toward light sensors 202 of the sensor array 201; and, at block 1930, transmitting with circuitry (e.g., FIG. 14) of the detector data signals in dependence on photons sensed by the light sensors 202 of the sensor array 201. There can also be performed the method, wherein the method includes determining which of the first set of light sources or second set of light sources produce less total heat on being energized, and selecting an ordering of energization of the first set of light sources and the second set of light sources in dependence on the determining. There can also be performed the method, wherein the first set of light sources and the second set of light sources are carried by a printed circuit board, wherein the method includes examining thermal data of the printed circuit board, and selecting an ordering of energization of the first set of light sources and the second set of light sources in dependence on the examining. Examining thermal data of the printed circuit board, can include examining thermal attributes of printed circuit board 1020, or of a printed circuit board according to printed circuit board 1020 as set forth herein. There can also be performed the method, wherein the method includes energizing the first set of light sources and the second set of light sources according to an ordering so that the set of light sources producing the lesser amount of total heat on being energized is energized first in the ordering.

A small sample of combinations expressed herein include the following: A1. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source; a detector comprising a detector surface for supporting biological or chemical samples and a sensor array comprising light sensors spaced apart from the detector surface, wherein the detector receives excitation light from the light energy exciter and emissions signal light; a mounting assembly for mounting the light pipe and the second light pipe, wherein the mounting assembly aligns the light pipe to the light source, and aligns the second light pipe to the second light source. A2. The system of A1, wherein the mounting assembly includes a support structure having a member defining a cavity, and a light pipe mount having attached thereto the light pipe, the light pipe mount attached to the support structure so that the light pipe extends through the cavity. A3. The system of A1, wherein the mounting assembly includes a support structure having a member defining a cavity, and a light pipe mount having attached thereto the light pipe, the light pipe mount attached to the support structure so that the light pipe extends through the cavity without contacting the support structure. A4. The system of A1 through A3, wherein the mounting assembly mounts the light pipe so that the light entrance surface of the light pipe is spaced apart from the light source, wherein the mounting assembly mounts the second light pipe so that the light entrance surface of the second light pipe is spaced apart from second the light source. A5. The system of any of A1 through A4, wherein the mounting assembly mounts the light pipe so that an outer boundary of the light pipe is provided by air, and wherein the mounting assembly is attached to the light pipe with an adhesive having an index of refraction matching an index of refraction of air. A6. The system of any of A1 through A5, wherein the mounting assembly mounts the light pipe so that an outer boundary of the light pipe is provided by air. A7. The system of any of A1 through A6, wherein the mounting assembly contacts the light pipe on a single side of the light pipe. A8. The system of any of A1 through A6, wherein the mounting assembly contacts the light pipe at a single location of contact of the light pipe. A9. The system of any of A1 through A3, wherein the mounting assembly contacts the light pipe at a single location of contact of the light pipe, wherein the single location of contact includes an adhesive matching an index of refraction of air. A10. The system of any of A1 through A9, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure. All. The system of any of A1 through A10, wherein the detector comprises circuitry to transmit data signals in dependence on photons detected by light sensors of the sensor array, wherein the detector blocks the excitation light and permits the emissions signal light to propagate toward the light sensors. A12. The system of any of A1 through A11, wherein the light energy exciter comprises a lens focusing an object plane defined by a light exit surface of the light pipe onto an image plane defined by the detector surface. A13. The system of any of A1 through A12, wherein the plurality of light sources comprise a light emitting diode that is surface coupled to the light entrance surface of the light pipe, wherein the light pipe comprises glass, wherein the light pipe is of tapered construction and comprises an increasing diameter, in a direction from the light entry surface of the light pipe to a light exit surface of the light pipe, throughout a length of the light pipe, the light pipe reflecting excitation light so that light pipe exit light rays exiting the light exit surface of the light pipe define a diverging cone of light that diverges with respect to an optical axis of the light energy exciter, wherein the light energy exciter comprises a lens that receives the excitation light from the light pipe and shapes light rays of the excitation light so that light exit light rays exiting the lens define a converging cone of light that converges with respect to an optical axis of the light energy exciter, wherein the light energy exciter comprises one or more filters to filter light at wavelengths longer than a cumulative emission band of wavelengths of the plurality of light sources. B1. A light energy exciter comprising: a light source bank to emit excitation light rays; and a light pipe homogenizing the excitation light rays and directing the excitation light rays toward a distal end of the light energy exciter, the light pipe comprising a light entrance surface and a light exit surface, the light pipe receiving the excitation light rays from the light source bank. B2. The light energy exciter of B1, wherein the light source bank comprises parallel connected light sources. B3. The light energy exciter of B1, wherein the light source bank comprises series connected light sources. B4. The light energy exciter of B1, wherein the light source bank comprises parallel connected light sources provided by vertical LEDs. B5. The light energy exciter of B1, wherein the light source bank comprises series connected light sources provided by flip chip LEDs. B6. The light energy exciter of B1, wherein the light source bank comprises parallel connected light sources, wherein anodes of light sources defining the light source bank are commonly connected to a metal core layer of a printed circuit board. B7. The light energy exciter of B1, wherein the light source bank comprises parallel connected vertical LEDs, wherein anodes of the vertical LEDs defining the light source bank are commonly connected to a metal core layer of a printed circuit board. B8. The light energy exciter of any of B1 through B2, wherein light sources defining the light source bank are commonly connected to a metal core layer of a printed circuit board. B9. The light energy exciter of B1, wherein the light source bank comprises parallel connected light sources, wherein the parallel connected light sources are provided by flip chip LEDs. B10. The light energy exciter of B1, wherein the light source bank comprises series connected light sources, wherein the series connected light sources are provided by vertical LEDs. B11. The light energy exciter of any of B1 through B3, wherein the light source bank comprises vertical LEDs. B12. The light energy exciter of any of B1 through B3, wherein the light source bank comprises flip chip LEDs. B13. The light energy exciter of any of B1 through B3, wherein the light source bank comprises flip chip LEDs arranged in an array having evenly spaced rows and columns of flip chip LEDs. B14. The light energy exciter of B1, wherein the light source bank comprises series connected LEDs, wherein the series connected LEDs are mounted to a printed circuit board, the printed circuit board having a ceramic insulator. B15. The light energy exciter of B1, wherein the light source bank comprises series connected LEDs, wherein the series connected LEDs are mounted to a printed circuit board, the printed circuit board having a ceramic insulator provided by LEDs. B16. The light energy exciter of any of B1 through B15, wherein the light energy exciter comprises a lens that images an object plane defined by the light exit surface onto an image plane defined by a detector surface of a detector when the distal end of the light energy exciter is coupled to a detector assembly. C1. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source, a third light pipe to homogenize excitation light rays from a third light source of the plurality of light sources and to direct the excitation light rays from the second light source, the third light pipe comprising a light entrance surface to receive the excitation light rays from the third light source, a fourth light pipe to homogenize excitation light rays from a fourth light source of the plurality of light sources and to direct the excitation light rays from the fourth light source, the fourth light pipe comprising a light entrance surface to receive the excitation light rays from the fourth light source; a lens receiving excitation light rays from the light pipe and the second light pipe and imaging a light exit surface of the light pipe and the second light pipe, respectively, onto a detector surface of a detector and a second detector surface of a second detector; and a lens receiving excitation light rays from the third light pipe and the fourth light pipe and imaging a light exit surface of the third light pipe and the fourth light pipe, respectively, onto a third detector surface of a third detector and a fourth detector surface of a fourth detector. C2. The system of C1, wherein the light source is disposed in a light source bank, the second light source is disposed in a second light source bank, the third light source is disposed in a third light source bank, and wherein the fourth light source is disposed in a fourth light source bank. D1. A method comprising: emitting with a light energy exciter excitation light, wherein the light energy exciter comprises a set of light sources and a second set of light sources, the set of light sources to emit excitation light rays in a first wavelength emission band, the second set of light source to emit excitation light rays in a second wavelength emission band; receiving with a detector the excitation light and emissions signal light resulting from excitation by the excitation light, the detector comprising a detector surface for supporting biological or chemical samples and a sensor array spaced apart from the detector surface, the detector blocking the excitation light and permitting the emissions signal light to propagate toward light sensors of the sensor array; and transmitting with circuitry of the detector data signals in dependence on photons sensed by the light sensors of the sensor array. D2, The method of D1, wherein the method includes determining which of the set of light sources or second set of light sources produce less total heat on being energized, and selecting an ordering of energization of the set of light sources and the second set of light sources in dependence on the determining. D3. The method of any of D1 through D2, wherein the set of light sources and the second set of light sources are carried by a printed circuit board, wherein the method includes examining thermal data of the printed circuit board, and selecting an ordering of energization of the set of light sources and the second set of light sources in dependence on the examining. D4. The method of any of D1 through D3, wherein the method includes energizing the set of light sources and the second set of light sources according to an ordering so that the set of light sources producing the lesser amount of total heat on being energized is energized first in the ordering. E1. A system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank; and a detector comprising a detector surface for supporting biological or chemical samples and a sensor array comprising light sensors spaced apart from the detector surface, wherein the detector receives excitation light from the light energy exciter and emissions signal light. E2. The system of E1, wherein the light source bank is mounted at a region of a printed circuit board, and wherein the second light source bank is mounted on a second region of the printed circuit board, the second region spaced apart from the region. E3. The system of E1, wherein the light source bank is mounted at a region of a printed circuit board, and wherein the second light source bank is mounted at a second region of the printed circuit board, the second region spaced apart from the region, wherein thermal resistance between respective ones of the light source bank and the second light source bank and a heat sink is less than a thermal resistance between the light source bank and the second light source bank. E4. The system of E1, wherein the light source bank is mounted at a region of a printed circuit board, and wherein the second light source bank is mounted at a second region of the printed circuit board, the second region spaced apart from the region, wherein the second region and the region are surface modified regions of the printed circuit board having surface modifications characterized by a an insulator layer, and a metal routing layer being removed. E5. The system of any of E1 through E4, wherein exit light rays of the light pipe and the second light pipe are commonly received by a lens that shapes the exit light rays to project a light pattern and a second light pattern onto a camera integrated circuit having a detector and a second detector, wherein the light pattern is projected by the lens onto a detector surface of the detector, and wherein the second light pattern is projected by the lens onto a second detector surface of the second detector. F1. A system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank, wherein the light source bank is mounted on a region of a printed circuit board, and wherein the second light source bank is mounted on a second region of the printed circuit board, the second region spaced apart from the region, wherein the second region and the region are surface modified regions of the printed circuit board having surface modifications characterized by one or more layer of the printed circuit board being removed; and a detector comprising a detector surface for supporting biological or chemical samples and a sensor array comprising light sensors spaced apart from the detector surface, wherein the detector receives excitation light from the light energy exciter and emissions signal light, wherein exit light rays of the light pipe and the second light pipe are commonly received by a lens that shapes the exit light rays to project a light pattern and a second light pattern onto a camera integrated circuit having a detector and a second detector, wherein the light pattern is projected by the lens onto a detector surface of the detector, and wherein the second light pattern is projected by the lens onto a second detector surface of the second detector. G1. A mounting assembly comprising: a light pipe mount for mounting a light pipe with respect to a light source; and a second light pipe mount for mounting a second light pipe with respect to a second light source. G2. The mounting assembly of G1, wherein the mounting assembly is configured to facilitate mounting of the second light pipe independent of mounting of the light pipe. G3. The mounting assembly of any of G1 through G2, wherein the mounting assembly contacts the light pipe on a single side of the light pipe. G4. The mounting assembly of any of G1 through G2, wherein the mounting assembly contacts the light pipe at a single point of contact of the light pipe. G5. The mounting assembly of any of G1 through G4, wherein the mounting assembly includes a support structure, wherein the light pipe mount is mounted to the support structure, and wherein the second light pipe mount is mounted to the support structure. G6. The mounting assembly of any of G1 through G4, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe. G7. The mounting assembly any of G1 through G4, wherein the mounting assembly includes a support structure, wherein the light pipe mount contacts the light pipe on a first side of the light pipe and wherein the second light pipe mount contacts the second light pipe on a second side of the second light pipe opposite the first side. G8. The mounting assembly of any of G1 through G4, wherein the mounting assembly includes a support structure, wherein the light pipe mount is removably mounted to the support structure, and wherein the second light pipe mount is removably mounted to support structure. G9. The mounting assembly of any of G1 through G4, wherein the mounting assembly includes a support structure, wherein the light pipe mount is removably screw mounted to the support structure, and wherein the second light pipe mount is removably screw mounted to support structure. G10. The mounting assembly of any of G1 through G4, wherein the mounting assembly includes a support structure, wherein the light pipe mount is mounted to the support structure having a cavity, and wherein the second light pipe mount is mounted to a support structure, wherein the mounting assembly is configured so that when the light pipe mount is mounted to the support structure the light pipe extends through the cavity. G11. The mounting assembly of any of G1 through G4, wherein the mounting assembly includes a support structure, wherein the light pipe mount is mounted to the support structure having a cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity. G12. The mounting assembly of any of G1 through G11, wherein the light source is disposed in a light source bank, and wherein the second light source is disposed in a second light source bank spaced apart from the light source bank. G13. The mounting assembly of any of G1 through G11, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source. G14. The mounting assembly of any of G1 through G13, wherein the light source is mounted at a region of a printed circuit board, and wherein the second light source is mounted at a second region of the printed circuit board, the second region being spaced apart from the region. G15. The mounting assembly of any of G1 through G13, wherein the light source is mounted at a region of a printed circuit board, and wherein the second light source is mounted at a second region of the printed circuit board, the second region being spaced apart from the region, wherein the second region and the region are surface modified regions of the printed circuit board having surface modifications characterized by one or more layer of the printed circuit board being removed. G16. The mounting assembly of any of G1 through G13, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed. H1. A mounting assembly comprising: a structural member carrying a light pipe; and a second structural member carrying a second light pipe. H2. The mounting assembly of H1, wherein the structural member and the second structural member are separate non-continuous pieces of material. H3. The mounting assembly of any of H1 through H2, wherein the mounting assembly is configured to facilitate mounting of the second light pipe independent of mounting of the light pipe. H4. The mounting assembly of any of H1 through H3, wherein the mounting assembly contacts the light pipe on a single side of the light pipe. H5. The mounting assembly of any of H1 through H3, wherein the mounting assembly contacts the light pipe at a single point of contact of the light pipe. H6. The mounting assembly of any of H1 through H5, wherein the mounting assembly is configured so that when the light pipe mount is mounted with respect to a light source, there is a standoff distance between the light pipe and the light source, and further so that when the second light pipe mount is mounted with respect to a second light source, there is a defined standoff distance between the second light pipe and the second light source. H7. The mounting assembly of any of H1 through H6, wherein the light pipe is aligned to a light source and wherein the second light pipe is aligned to a second light source. H8. The mounting assembly of any of H1 through H6, wherein the light pipe is aligned to a light source of a light source bank and wherein the second light pipe is aligned to a second light source of a second light source bank. H9. The mounting assembly of any of H1 through H8, wherein the light pipe is aligned to a light source mounted at a region of a printed circuit board, and wherein the second light pipe is aligned to a second light source mounted at a second region of the printed circuit board, the second region being spaced apart from the region, wherein the second region and the region are surface modified regions of the printed circuit board having surface modifications characterized by one or more layer of the printed circuit board being removed. I1. A mounting assembly comprising: a light pipe mount for mounting a light pipe with respect to a light source; and a second light pipe mount for mounting a second light pipe with respect to a second light source. I2. The mounting assembly of I1, wherein the mounting assembly is configured to facilitate mounting of the second light pipe independent of mounting of the light pipe. I3. The mounting assembly of any of I1 through I2, wherein the mounting assembly contacts the light pipe on a single side of the light pipe. I4. The mounting assembly of any of I1 through I2, wherein the mounting assembly contacts the light pipe at a single point of contact of the light pipe. I5. The mounting assembly of any of I1 through I2, wherein the mounting assembly includes a support structure, wherein the light pipe mount is mounted to the support structure, and wherein the second light pipe mount is mounted to the support structure. I6. The mounting assembly of I1, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure. I7. The mounting assembly of any of I1 through I4, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe. I8. The mounting assembly of I1, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe. I9. The mounting assembly any of I1 through I8, wherein the light pipe mount contacts the light pipe on a first side of the light pipe and wherein the second light pipe mount contacts the second light pipe on a second side of the second light pipe opposite its first side. I10. The mounting assembly of any of I5 through I8, wherein the light pipe mount is removably mounted to the support structure, and wherein the second light pipe mount is removably mounted to the support structure. I11 The mounting assembly of I10, wherein the light pipe mount is removably screw mounted to the support structure, and wherein the second light pipe mount is removably screw mounted to support structure. I12. The mounting assembly of I11, wherein the mounting assembly contacts the light pipe at a single point of contact of the light pipe, wherein the mounting assembly includes a support structure, wherein the light pipe mount is removably screw mounted to the support structure, and wherein the second light pipe mount is removably screw mounted to the support structure, wherein the mounting assembly includes a support structure, wherein the light pipe mount is removably screw mounted to the support structure below a horizontal axis extending through the light pipe and the second light pipe, and wherein the second light pipe mount is removably screw mounted to the support structure above the horizontal axis extending through the light pipe and the second light pipe. I13. The mounting assembly of any of I1 through I12, wherein the mounting assembly includes a support structure having a cavity, wherein the light pipe mount is mounted to the support structure having the cavity, and wherein the second light pipe mount is mounted to a support structure, wherein the mounting assembly is configured so that when the light pipe mount is mounted to the support structure the light pipe extends through the cavity. I14. The mounting assembly of I13, wherein the cavity having a diameter larger than a diameter of the light pipe so that when the light pipe extends through the cavity the light pipe does not contact a sidewall defining the cavity. I15. The mounting assembly of I1, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity. I16. The mounting assembly of any of I1 through I15, wherein the light source is disposed in a light source bank, and wherein the second light source is disposed in a second light source bank spaced apart from the light source bank. I17. The mounting assembly of I1, wherein the light source is disposed in a light source bank, and wherein the second light source is disposed in a second light source bank spaced apart from the light source bank, wherein the light source bank is characterized by one or more of the following selected from the group consisting of the light source bank comprises parallel connected light sources, the light source bank comprises series connected light sources, light sources defining the light source bank are commonly connected to a metal core layer of a printed circuit board, the light source bank comprises vertical LEDs, the light source bank comprises flip chip LEDs. I18. The mounting assembly of any of I1 through I17, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source. I19. The mounting assembly of I1, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source. I20. The mounting assembly of any of I1 through I19, wherein the light source is mounted at a region of a printed circuit board, and wherein the second light source is mounted at a second region of the printed circuit board, the second region being spaced apart from the region. I21. The mounting assembly of I21, wherein the second region and the region are surface modified regions of the printed circuit board having surface modifications characterized by one or more layer of the printed circuit board being removed. I22. The mounting assembly of any of I1 through I21, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed. I23. The mounting assembly of I1, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed, wherein the light source bank is characterized by one or more of the following selected from the group consisting of the light source bank comprises parallel connected light sources, the light source bank comprises series connected light sources, light sources defining the light source bank are commonly connected to a metal core layer of a printed circuit board, the light source bank comprises vertical LEDs, the light source bank comprises flip chip LEDs. I24. The mounting assembly of I1, wherein the mounting assembly contacts the light pipe at a single location of contact of the light pipe, wherein the single location of contact includes an adhesive matching an index of refraction of air. J1. A mounting assembly comprising: a light pipe mount for mounting a light pipe with respect to a light source; and a second light pipe mount for mounting a second light pipe with respect to a second light source, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity. K1. A mounting assembly comprising: a light pipe mount for mounting a light pipe with respect to a light source; and a second light pipe mount for mounting a second light pipe with respect to a second light source, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source. K2. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source; a detector comprising a detector surface for supporting biological or chemical samples and a sensor array comprising light sensors spaced apart from the detector surface, wherein the detector receives excitation light from the light energy exciter and emissions signal light; a mounting assembly for mounting the light pipe and the second light pipe according to K1, wherein the mounting assembly aligns the light pipe to the light source, and aligns the second light pipe to the second light source. L1. A mounting assembly comprising: a light pipe mount for mounting a light pipe with respect to a light source; and a second light pipe mount for mounting a second light pipe with respect to a second light source, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed, wherein the mounting assembly contacts the light pipe at a single location of contact of the light pipe, wherein the single location of contact includes an adhesive matching an index of refraction of air. M1. A mounting assembly comprising: a structural member carrying a light pipe; and a second structural member carrying a second light pipe. M2. The mounting assembly of M1, wherein the structural member and the second structural member are separate non-continuous pieces of material. M3. The mounting assembly of any of M1 through M2, wherein the mounting assembly is configured to facilitate mounting of the second light pipe independent of mounting of the light pipe. M4. The mounting assembly of any of M1 through M3, wherein the mounting assembly contacts the light pipe on a single side of the light pipe. M5. The mounting assembly of any of M1 through M4, wherein the mounting assembly contacts the light pipe at a single point of contact of the light pipe. M6. The mounting assembly of M1, wherein the structural member and the second structural member are separate non-continuous pieces of material, wherein the mounting assembly is configured to facilitate mounting of the second light pipe independent of mounting of the light pipe, wherein the mounting assembly contacts the light pipe at a single point of contact of the light pipe. M7.

The mounting assembly of any of M1 through M6, wherein the mounting assembly is configured so that when the light pipe mount is mounted with respect to a light source, there is a standoff distance between the light pipe and the light source, and further so that when the second light pipe mount is mounted with respect to a second light source, there is a defined standoff distance between the second light pipe and the second light source. M8. The mounting assembly of any of M1 through M7, wherein the light pipe is aligned to a light source and wherein the second light pipe is aligned to a second light source. M9. The mounting assembly of any of M1 through M8, wherein the light pipe is aligned to a light source of a light source bank and wherein the second light pipe is aligned to a second light source of a second light source bank. M10. The mounting assembly of any of M1 through M9, wherein the light pipe is aligned to a light source mounted at a region of a printed circuit board, and wherein the second light pipe is aligned to a second light source mounted at a second region of the printed circuit board, the second region being spaced apart from the region, wherein the second region and the region are surface modified regions of the printed circuit board having surface modifications characterized by one or more layer of the printed circuit board being removed. M11. The mounting assembly of M1, wherein the structural member and the second structural member are separate non-continuous pieces of material, wherein the mounting assembly is configured to facilitate mounting of the second light pipe independent of mounting of the light pipe, wherein the mounting assembly contacts the light pipe at a single point of contact of the light pipe, wherein the mounting assembly is configured so that when the light pipe mount is mounted with respect to a light source, there is a standoff distance between the light pipe and the light source, and further so that when the second light pipe mount is mounted with respect to a second light source, there is a defined standoff distance between the second light pipe and the second light source, wherein the light pipe is aligned to a light source mounted at a region of a printed circuit board, and wherein the second light pipe is aligned to a second light source mounted at a second region of the printed circuit board, the second region being spaced apart from the region, wherein the second region and the region are surface modified regions of the printed circuit board having surface modifications characterized by one or more layer of the printed circuit board being removed. M12. The mounting assembly of M1, wherein the mounting assembly contacts the light pipe at a single location of contact of the light pipe, wherein the single location of contact includes an adhesive matching an index of refraction of air. N1. A mounting assembly comprising: a structural member carrying a light pipe; and a second structural member carrying a second light pipe, wherein the structural member and the second structural member are separate non-continuous pieces of material, wherein the mounting assembly is configured to facilitate mounting of the second light pipe independent of mounting of the light pipe, wherein the mounting assembly contacts the light pipe at a single point of contact of the light pipe, wherein the mounting assembly is configured so that when the light pipe mount is mounted with respect to a light source, there is a standoff distance between the light pipe and the light source, and further so that when the second light pipe mount is mounted with respect to a second light source, there is a defined standoff distance between the second light pipe and the second light source, wherein the light pipe is aligned to a light source mounted at a region of a printed circuit board, and wherein the second light pipe is aligned to a second light source mounted at a second region of the printed circuit board, the second region being spaced apart from the region, wherein the second region and the region are surface modified regions of the printed circuit board having surface modifications characterized by one or more layer of the printed circuit board being removed. O1. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source; a detector comprising a detector surface for supporting biological or chemical samples and a sensor array comprising light sensors spaced apart from the detector surface, wherein the detector receives excitation light from the light energy exciter and emissions signal light; a mounting assembly for mounting the light pipe and the second light pipe, wherein the mounting assembly aligns the light pipe to the light source, and aligns the second light pipe to the second light source. O2. The system of O1, wherein the mounting assembly includes a support structure having a member defining a cavity, and a light pipe mount having attached thereto the light pipe, the light pipe mount attached to the support structure so that the light pipe extends through the cavity. O3. The system of O1, wherein the mounting assembly includes a support structure having a member defining a cavity, and a light pipe mount having attached thereto the light pipe, the light pipe mount attached to the support structure so that the light pipe extends through the cavity without contacting the support structure. O4. The system of any of O1 through O3, wherein the mounting assembly mounts the light pipe so that the light entrance surface of the light pipe is spaced apart from the light source, wherein the mounting assembly mounts the second light pipe so that the light entrance surface of the second light pipe is spaced apart from second the light source. O5. The system of any of O1 through O4, wherein the mounting assembly mounts the light pipe so that an outer boundary of the light pipe is provided by air, and wherein the mounting assembly is attached to the light pipe with an adhesive having an index of refraction matching an index of refraction of air. O6. The system of O1, wherein the mounting assembly mounts the light pipe so that an outer boundary of the light pipe is provided by air, and wherein the mounting assembly is attached to the light pipe with an adhesive having an index of refraction matching an index of refraction of air. O7. The system of any of O1 through O6, wherein the mounting assembly mounts the light pipe so that an outer boundary of the light pipe is provided by air. O8. The system of any of O1 through O7, wherein the mounting assembly contacts the light pipe on a single side of the light pipe. O9. The system of any of O1 through O8, wherein the mounting assembly contacts the light pipe at a single location of contact of the light pipe. O10. The system of any of O1 through O9, wherein the mounting assembly contacts the light pipe at a single location of contact of the light pipe, wherein the single location of contact includes an adhesive matching an index of refraction of air. O11. The system of any of O1 through O10, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure. O12. The system of O1, wherein the mounting assembly includes a support structure having a member defining a cavity, and a light pipe mount having attached thereto the light pipe, the light pipe mount attached to the support structure so that the light pipe extends through the cavity without contacting the support structure, wherein the mounting assembly mounts the light pipe so that an outer boundary of the light pipe is provided by air, and wherein the mounting assembly is attached to the light pipe with an adhesive having an index of refraction matching an index of refraction of air, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure, wherein the mounting assembly mounts the light pipe so that the light entrance surface of the light pipe is spaced apart from the light source, wherein the mounting assembly mounts the second light pipe so that the light entrance surface of the second light pipe is spaced apart from second the light source, wherein the system is operative for determining which of a set of light sources or second set of light sources produce less total heat on being energized, and selecting an ordering of energization of the set of light sources and the second set of light sources in dependence on the determining. O13. The system of any of O1 through O12, wherein the detector comprises circuitry to transmit data signals in dependence on photons detected by light sensors of the sensor array, wherein the detector blocks the excitation light and permits the emissions signal light to propagate toward the light sensors. O14. The system of any of O1 through O13, wherein the light energy exciter comprises a lens focusing an object plane defined by a light exit surface of the light pipe onto an image plane defined by the detector surface. O15. The system of any of O1 through O14, wherein the plurality of light sources comprise a light emitting diode that is surface coupled to the light entrance surface of the light pipe, wherein the light pipe comprises glass, wherein the light pipe is of tapered construction and comprises an increasing diameter, in a direction from the light entry surface of the light pipe to a light exit surface of the light pipe, throughout a length of the light pipe, the light pipe reflecting excitation light so that light pipe exit light rays exiting the light exit surface of the light pipe define a diverging cone of light that diverges with respect to an optical axis of the light energy exciter, wherein the light energy exciter comprises a lens that receives the excitation light from the light pipe and shapes light rays of the excitation light so that light exit light rays exiting the lens define a converging cone of light that converges with respect to an optical axis of the light energy exciter, wherein the light energy exciter comprises one or more filters to filter light at wavelengths longer than a cumulative emission band of wavelengths of the plurality of light sources. O16. The system of O1, wherein the system is operative for determining which of a set of light sources or second set of light sources produce less total heat on being energized, and selecting an ordering of energization of the set of light sources and the second set of light sources in dependence on the determining. P1. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source; a detector comprising a detector surface for supporting biological or chemical samples and a sensor array comprising light sensors spaced apart from the detector surface, wherein the detector receives excitation light from the light energy exciter and emissions signal light; a mounting assembly for mounting the light pipe and the second light pipe, wherein the mounting assembly aligns the light pipe to the light source, and aligns the second light pipe to the second light source, wherein the mounting assembly includes a support structure having a member defining a cavity, and a light pipe mount having attached thereto the light pipe, the light pipe mount attached to the support structure so that the light pipe extends through the cavity without contacting the support structure, wherein the mounting assembly mounts the light pipe so that an outer boundary of the light pipe is provided by air, and wherein the mounting assembly is attached to the light pipe with an adhesive having an index of refraction matching an index of refraction of air, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure, wherein the mounting assembly mounts the light pipe so that the light entrance surface of the light pipe is spaced apart from the light source, wherein the mounting assembly mounts the second light pipe so that the light entrance surface of the second light pipe is spaced apart from second the light source, wherein the light energy exciter comprises a lens focusing an object plane defined by a light exit surface of the light pipe onto an image plane defined by the detector surface. Q1. A light energy exciter comprising: a light source bank to emit excitation light rays; and a light pipe homogenizing the excitation light rays and directing the excitation light rays toward a distal end of the light energy exciter, the light pipe comprising a light entrance surface and a light exit surface, the light pipe receiving the excitation light rays from the light source bank. Q2. The light energy exciter of Q1, wherein the light source bank comprises parallel connected light sources. Q3. The light energy exciter of Q1, wherein the light source bank comprises series connected light sources. Q4. The light energy exciter of Q1, wherein the light source bank comprises parallel connected light sources provided by vertical LEDs. Q5. The light energy exciter of Q1, wherein the light source bank comprises series connected light sources provided by flip chip LEDs. Q6. The light energy exciter of Q1, wherein the light source bank comprises parallel connected light sources, wherein anodes of light sources defining the light source bank are commonly connected to a metal core layer of a printed circuit board. Q7. The light energy exciter of Q1, wherein the light source bank comprises parallel connected vertical LEDs, wherein anodes of the vertical LEDs defining the light source bank are commonly connected to a metal core layer of a printed circuit board. Q8. The light energy exciter of any of Q1 through Q2, wherein light sources defining the light source bank are commonly connected to a metal core layer of a printed circuit board. Q9. The light energy exciter of Q1, wherein the light source bank comprises parallel connected light sources, wherein the parallel connected light sources are provided by flip chip LEDs. Q10. The light energy exciter of Q1, wherein the light source bank comprises series connected light sources, wherein the series connected light sources are provided by vertical LEDs. Q11. The light energy exciter of any of Q1 through Q3, wherein the light source bank comprises vertical LEDs. Q12. The light energy exciter of any of Q1 through Q3, wherein the light source bank comprises flip chip LEDs. Q13. The light energy exciter of any of Q1 through Q3, wherein the light source bank comprises flip chip LEDs arranged in an array having evenly spaced rows and columns of flip chip LEDs. Q14. The light energy exciter of Q1, wherein the light source bank comprises series connected LEDs, wherein the series connected LEDs are mounted to a printed circuit board, the printed circuit board having a ceramic insulator. Q15. The light energy exciter of Q1, wherein the light source bank comprises series connected LEDs, wherein the series connected LEDs are mounted to a printed circuit board, the printed circuit board having a ceramic insulator provided by LED. Q16. The light energy exciter of any of Q1 through Q15, wherein the light energy exciter comprises a lens that images an object plane defined by the light exit surface onto an image plane defined by a detector surface of a detector when the distal end of the light energy exciter is coupled to a detector assembly. R1. A system comprising: a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source, a third light pipe to homogenize excitation light rays from a third light source of the plurality of light sources and to direct the excitation light rays from the second light source, the third light pipe comprising a light entrance surface to receive the excitation light rays from the third light source, a fourth light pipe to homogenize excitation light rays from a fourth light source of the plurality of light sources and to direct the excitation light rays from the fourth light source, the fourth light pipe comprising a light entrance surface to receive the excitation light rays from the fourth light source; a lens receiving excitation light rays from the light pipe and the second light pipe and imaging a light exit surface of the light pipe and the second light pipe, respectively, onto a detector surface of a detector and a second detector surface of a second detector; and a lens receiving excitation light rays from the third light pipe and the fourth light pipe and imaging a light exit surface of the third light pipe and the fourth light pipe, respectively, onto a third detector surface of a third detector and a fourth detector surface of a fourth detector. R2. The system of R1, wherein the light source is disposed in a light source bank, the second light source is disposed in a second light source bank, the third light source is disposed in a third light source bank, and wherein the fourth light source is disposed in a fourth light source bank. S1. A method comprising: emitting with a light energy exciter excitation light, wherein the light energy exciter comprises a set of light sources and a second set of light sources, the set of light sources to emit excitation light rays in a first wavelength emission band, the second set of light source to emit excitation light rays in a second wavelength emission band; receiving with a detector the excitation light and emissions signal light resulting from excitation by the excitation light, the detector comprising a detector surface for supporting biological or chemical samples and a sensor array spaced apart from the detector surface, the detector blocking the excitation light and permitting the emissions signal light to propagate toward light sensors of the sensor array; and transmitting with circuitry of the detector data signals in dependence on photons sensed by the light sensors of the sensor array. S2. The method of S1, wherein the method includes determining which of the set of light sources or second set of light sources produce less total heat on being energized, and selecting an ordering of energization of the set of light sources and the second set of light sources in dependence on the determining. S3. The method of any of S1 through S2, wherein the set of light sources and the second set of light sources are carried by a printed circuit board, wherein the method includes examining thermal data of the printed circuit board, and selecting an ordering of energization of the set of light sources and the second set of light sources in dependence on the examining. S4. The method of any of S1 through S3, wherein the method includes energizing the set of light sources and the second set of light sources according to an ordering so that the set of light sources producing the lesser amount of total heat on being energized is energized first in the ordering. T1. A system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank; and a detector comprising a detector surface for supporting biological or chemical samples and a sensor array comprising light sensors spaced apart from the detector surface, wherein the detector receives excitation light from the light energy exciter and emissions signal light. T2. The system of T1, wherein the light source bank is mounted at a region of a printed circuit board, and wherein the second light source bank is mounted on a second region of the printed circuit board, the second region spaced apart from the region. T3. The system of T1, wherein the light source bank is mounted at a region of a printed circuit board, and wherein the second light source bank is mounted at a second region of the printed circuit board, the second region spaced apart from the region, wherein thermal resistance between respective ones of the light source bank and the second light source bank and a heat sink is less than a thermal resistance between the light source bank and the second light source bank. T4. The system of T1, wherein the light source bank is mounted at a region of a printed circuit board, and wherein the second light source bank is mounted at a second region of the printed circuit board, the second region spaced apart from the region, wherein the second region and the region are surface modified regions of the printed circuit board having surface modifications characterized by an insulator layer, and a metal routing layer being removed. T5. The system of any of T1 through T4, wherein exit light rays of the light pipe and the second light pipe are commonly received by a lens that shapes the exit light rays to project a light pattern and a second light pattern onto a camera integrated circuit having a detector and a second detector, wherein the light pattern is projected by the lens onto a detector surface of the detector, and wherein the second light pattern is projected by the lens onto a second detector surface of the second detector. U1. A system comprising: a light energy exciter comprising a light pipe to homogenize excitation light rays from a light source bank and to direct the excitation light rays from the light source bank, the light pipe comprising a light entrance surface to receive the excitation light rays from the light source bank, a second light pipe to homogenize excitation light rays from a second light source bank and to direct the excitation light rays from the second light source bank, the second light pipe comprising a light entrance surface to receive the excitation light rays from the second light source bank, wherein the light source bank is mounted on a region of a printed circuit board, and wherein the second light source bank is mounted on a second region of the printed circuit board, the second region spaced apart from the region, wherein the second region and the region are surface modified regions of the printed circuit board having surface modifications characterized by one or more layer of the printed circuit board being removed; and a detector comprising a detector surface for supporting biological or chemical samples and a sensor array comprising light sensors spaced apart from the detector surface, wherein the detector receives excitation light from the light energy exciter and emissions signal light, wherein exit light rays of the light pipe and the second light pipe are commonly received by a lens that shapes the exit light rays to project a light pattern and a second light pattern onto a camera integrated circuit having a detector and a second detector, wherein the light pattern is projected by the lens onto a detector surface of the detector, and wherein the second light pattern is projected by the lens onto a second detector surface of the second detector.

It should be appreciated that all combinations of the foregoing concepts and additional concepts discussed in greater detail below (provided such concepts are not mutually inconsistent) are contemplated as being part of the subject matter disclosed herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely exemplary. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112 (f) unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to +10%, such as less than or equal to #5%, such as less than or equal to +2%, such as less than or equal to +1%, such as less than or equal to +0.5%, such as less than or equal to #0.2%, such as less than or equal to #0.1%, such as less than or equal to +0.05%. If used herein, the terms “substantially”, “approximately”, “about”, “relatively,” or other such similar terms may also refer to no fluctuations, that is, +0%. It is contemplated that numerical values, as well as other values that are recited herein can be modified by the term “about”, whether expressly stated or inherently derived by the discussion of the present disclosure. Further, any description of a range herein can encompass all subranges.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description, but is only limited by the scope of the appended claims.

1. A mounting assembly comprising:
a light pipe mount for mounting a light pipe with respect to a light source; and
a second light pipe mount for mounting a second light pipe with respect to a second light source.

2. The mounting assembly of claim 1, wherein the mounting assembly is configured to facilitate mounting of the second light pipe independent of mounting of the light pipe.

3. (canceled)

4. The mounting assembly of claim 1, wherein the mounting assembly contacts the light pipe at a single point of contact of the light pipe.

5. The mounting assembly of claim 1, wherein the mounting assembly includes a support structure, wherein the light pipe mount is mounted to the support structure, and wherein the second light pipe mount is mounted to the support structure.

6. (canceled)

7. The mounting assembly of claim 1, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe.

8. The mounting assembly of claim 1, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe.

9. The mounting assembly claim 1, wherein the light pipe mount contacts the light pipe on a first side of the light pipe and wherein the second light pipe mount contacts the second light pipe on a second side of the second light pipe opposite its first side.

10. (canceled)

11. (canceled)

12. (canceled)

13. (canceled)

14. (canceled)

15. The mounting assembly of claim 1, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity.

16. (canceled)

17. (canceled)

18. (canceled)

19. The mounting assembly of claim 1, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source.

20. (canceled)

21. (canceled)

22. (canceled)

23. The mounting assembly of claim 1, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed, wherein the light source bank is characterized by one or more of the following selected from the group consisting of the light source bank comprises parallel connected light sources, the light source bank comprises series connected light sources, light sources defining the light source bank are commonly connected to a metal core layer of a printed circuit board, the light source bank comprises vertical LEDs, the light source bank comprises flip chip LEDs.

24. The mounting assembly of claim 1, wherein the mounting assembly contacts the light pipe at a single location of contact of the light pipe, wherein the single location of contact includes an adhesive matching an index of refraction of air.

25. (canceled)

26. (canceled)

27. (canceled)

28. A mounting assembly comprising:
a light pipe mount for mounting a light pipe with respect to a light source; and
a second light pipe mount for mounting a second light pipe with respect to a second light source, wherein the mounting assembly is configured to facilitate mounting of the second light pipe independent of mounting of the light pipe, wherein the mounting assembly contacts the light pipe at a single point of contact of the light pipe, wherein the mounting assembly includes a support structure, wherein the light pipe mount is mounted to the support structure, and wherein the second light pipe mount is mounted to the support structure, wherein the mounting assembly includes a support structure, wherein the light pipe mount is mounted to the support structure below a horizontal axis extending through the light pipe and the second light pipe, and wherein the second light pipe mount is mounted to the support structure above the horizontal axis extending through the light pipe and the second light pipe, wherein the mounting assembly includes a support structure, wherein the light pipe mount is removably screw mounted to the support structure, and wherein the second light pipe mount is removably screw mounted to support structure, wherein the mounting assembly includes a support structure having a cavity, wherein the light pipe mount is mounted to the support structure having the cavity, and wherein the second light pipe mount is mounted to support structure, wherein the mounting assembly is configured so that when the light pipe mount is mounted to the support structure the light pipe extends through the cavity, the cavity having a diameter larger than a diameter of the light pipe so that when the light pipe extends through the cavity the light pipe does not contact a sidewall defining the cavity, wherein the mounting assembly is configured so that when the light pipe mount is mounted with respect to the light source, there is a standoff distance between the light pipe and the light source, and further so that when the second light pipe mount is mounted with respect to the second light source, there is a defined standoff distance between the second light pipe and the second light source, wherein the light source is included in a light source bank mounted at a region of a printed circuit board, and wherein the second light source is included in a second light source bank mounted at a second region of the printed circuit board, the second region being spaced apart from the region, wherein the second region and the region are surface modified regions of the printed circuit board having surface modifications characterized by an insulator layer and a conductive metal routing layer being removed, wherein the mounting assembly contacts the light pipe at a single location of contact of the light pipe, wherein the single location of contact includes an adhesive matching an index of refraction of air.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A system comprising:
a light energy exciter comprising a plurality of light sources, a light pipe to homogenize excitation light rays from a light source of the plurality of light sources and to direct the excitation light rays from the light source, the light pipe comprising a light entrance surface to receive the excitation light rays from the light source, a second light pipe to homogenize excitation light rays from a second light source of the plurality of light sources and to direct the excitation light rays from the second light source, the second light pipe comprising a light entrance surface to receive the excitation light rays from the second light source;
a detector comprising a detector surface for supporting biological or chemical samples and a sensor array comprising light sensors spaced apart from the detector surface, wherein the detector receives excitation light from the light energy exciter and emissions signal light;
a mounting assembly for mounting the light pipe and the second light pipe, wherein the mounting assembly aligns the light pipe to the light source, and aligns the second light pipe to the second light source.

43. (canceled)

44. The system of claim 42, wherein the mounting assembly includes a support structure having a member defining a cavity, and a light pipe mount having attached thereto the light pipe, the light pipe mount attached to the support structure so that the light pipe extends through the cavity without contacting the support structure.

45. The system of claim 42, wherein the mounting assembly mounts the light pipe so that the light entrance surface of the light pipe is spaced apart from the light source, wherein the mounting assembly mounts the second light pipe so that the light entrance surface of the second light pipe is spaced apart from second the second light source.

46. (canceled)

47. The system of claim 42, wherein the mounting assembly mounts the light pipe so that an outer boundary of the light pipe is provided by air, and wherein the mounting assembly is attached to the light pipe with an adhesive having an index of refraction matching an index of refraction of air.

48. (canceled)

49. (canceled)

50. (canceled)

51. The system of claim 42, wherein the mounting assembly contacts the light pipe at a single location of contact of the light pipe, wherein the single location of contact includes an adhesive matching an index of refraction of air.

52. The system of claim 42, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure.

53. The system of claim 42, wherein the mounting assembly includes a support structure having a member defining a cavity, and a light pipe mount having attached thereto the light pipe, the light pipe mount attached to the support structure so that the light pipe extends through the cavity without contacting the support structure, wherein the mounting assembly mounts the light pipe so that an outer boundary of the light pipe is provided by air, and wherein the mounting assembly is attached to the light pipe with an adhesive having an index of refraction matching an index of refraction of air, wherein the mounting assembly includes a support structure extending forwardly from the light source and the second light source, a light pipe mount carrying the light pipe, the light pipe mount removably attached to the support structure, a second light pipe mount carrying the second light pipe, the second light pipe mount removably attached to the support structure, wherein the mounting assembly mounts the light pipe so that the light entrance surface of the light pipe is spaced apart from the light source, wherein the mounting assembly mounts the second light pipe so that the light entrance surface of the second light pipe is spaced apart from second the light source, wherein the system is operative for determining which of a set of light sources or second set of light sources produce less total heat on being energized, and selecting an ordering of energization of the set of light sources and the second set of light sources in dependence on the determining.

54. (canceled)

55. (canceled)

56. (canceled)

57. The system of claim 42, wherein the system is operative for determining which of a set of light sources or second set of light sources produce less total heat on being energized, and selecting an ordering of energization of the set of light sources and the second set of light sources in dependence on the determining.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)
